(19) United States
(12) Patent Application Publication
(10) Pub. No.: US 2026/0279313 A1
(43) Pub. Date: Sep. 17, 2026

(54) STRINGED MUSICAL INSTRUMENT WITH FRETTING SADDLING MEMBER WITH SADDLING INTERFACES FOR MULTIPLE STRINGS

(71) Applicant: Polyphonic Chromaticism, Inc., Sandstone, MN (US)

(72) Inventor: Benjamin M. RANSON, Sandstone, MN (US)

(21) Appl. No.: 19/571,245

(22) Filed: Mar. 18, 2026

Related U.S. Application Data
(63) Continuation of application No. PCT/US26/19169, filed on Mar. 13, 2026.
(60) Provisional application No. 63/856,170, filed on Aug. 1, 2025.
(60) Provisional application No. 63/771,375, filed on Mar. 13, 2025.

(51) Int. Cl. G10D 3/18; G10D 3/06

(52) U.S. Cl. CPC G10D 3/18; G10D 3/06

(57) ABSTRACT

A fretting saddling member with saddling interfaces for two consecutive strings is coupled to a body of a stringed musical instrument. A saddling interface contacts a string and directs the string above a sequence of string contactable fretting crown segments on the fretting saddling member, between the saddling interface and a neck of the instrument. The vertical position and the longitudinal position of the fretting saddling member are adjustable for playability. A player uses the wrist of the picking hand to depress the string between the saddling interface and a fretting crown segment until the string contacts the fretting crown segment. A length of the string extending from the fretting crown segment to a nut on the neck may then be plucked with the thumb of the picking hand.

### CROSS-REFERENCE TO RELATED APPLICATIONS

The entire contents of the following application are incorporated by reference herein: U.S. Provisional Patent Application No. 63/771,375; filed Mar. 13, 2025; and entitled COUNTER-FRETTING DEVICES AND METHODS.

The entire contents of the following application are incorporated by reference herein: U.S. Provisional Patent Application No. 63/856,170; filed Aug. 1, 2025; and entitled WRIST FRETTING ASSEMBLIES AND STRINGED MUSICAL INSTRUMENTS.

The entire contents of the following application are incorporated by reference herein: PCT Application No.: PCT/US2026/019196; filed Mar. 13, 2026; and entitled STRINGED MUSICAL INSTRUMENT WITH FRETTING SADDLING MEMBER WITH SADDLING INTERFACES FOR MULTIPLE STRINGS.

### BACKGROUND

### Technical Field

The present disclosure relates to a stringed musical instrument.

### Description of Related Art

A guitar includes a neck, a body, and strings. Frets are located on a fingerboard connected to the neck. The pitch of a string may be changed by depressing the string against a fingerboard fret with the fretting hand. This action is called fretting.

A player uses the fretting hand to fret along the neck, and uses the picking hand to pluck a string near the body. Fretting shortens the sounding length of the string in one direction; the end of the sounding length at the bridge stays the same, while the location of the end of the sounding length opposite the bridge is changed. As the fretting hand moves toward the body, the pitches of fretted fingerboard notes get higher.

A player may fret multiple fretted fingerboard notes with the fretting hand. Note combinations and articulation are constrained by the physical challenge of fretting multiple strings and by the limited number of open notes.

The most common forms of the guitar are unchanged since the 1960s. As a consequence of the unchanged form of the instrument, the techniques of the guitar and bass guitar have advanced little since the 1970s.

The styles of guitar performance developed in the mid twentieth century rely on open strings. However, open notes available on open strings are of little use in some keys, and retuning strings to alter open notes is impractical while playing. Thus, fretting hand position forms a longstanding technical barrier which prevents the use of some combinations of notes, restricts the range of chords, and limits expression during polyphonic play.

### SUMMARY

Included in the present disclosure is an assembly for a stringed musical instrument. In some embodiments, the assembly includes a block having a laterally proximal saddling interface, a laterally distal saddling interface, and a first laterally proximal fretting crown segment. According to some embodiments, the first laterally proximal fretting crown segment is spaced longitudinally forward of the laterally proximal saddling interface. The block may be adjustably positionable on a body of the stringed musical instrument such that the stringed musical instrument is configurable with a proto string of the stringed musical instrument extending from a proto string longitudinally rearward critical contact point on the laterally proximal saddling interface, at a wrist fretable vertical distance above the first laterally proximal fretting crown segment, above a neck of the stringed musical instrument connected to the body of the stringed musical instrument, to a proto string longitudinally forward critical contact point on a nut of the stringed musical instrument disposed on the neck of the stringed musical instrument.

In some embodiments, the block is adjustably positionable on a body of the stringed musical instrument such that the stringed musical instrument is configurable with a deutero string of the stringed musical instrument extending from a deutero string longitudinally rearward critical contact point on the laterally distal saddling interface, above the neck of the stringed musical instrument, to a deutero string longitudinally forward critical contact point on the nut of the stringed musical instrument. The deutero string of the stringed musical instrument may be laterally spaced from the proto string of the stringed musical instrument.

The block may include a laterally proximal string guide indentation configured to position the proto string of the stringed musical instrument on the laterally proximal saddling interface. In some embodiments, the block includes a laterally distal string guide indentation configured to position the deutero string of the stringed musical instrument on the laterally distal saddling interface.

According to some embodiments, a lateral width of the block is equal to or less than 60 millimeters (mm).

The block may include a second laterally proximal fretting crown segment spaced longitudinally forward of the first laterally proximal fretting crown segment. The block may include a third laterally proximal fretting crown segment spaced longitudinally forward of the second laterally proximal fretting crown segment. The block may include a fourth laterally proximal fretting crown segment spaced longitudinally forward of the third laterally proximal fretting crown segment.

The block may include a first laterally distal fretting crown segment spaced longitudinally forward of the laterally distal saddling interface. The block may include a second laterally distal fretting crown segment spaced longitudinally forward of the first laterally distal fretting crown segment. The block may include a third laterally distal fretting crown segment spaced longitudinally forward of the second laterally distal fretting crown segment. The block may further include a fourth laterally distal fretting crown segment spaced longitudinally forward of the third laterally distal fretting crown segment.

In some embodiments, a distance from the laterally proximal saddling interface to the second laterally proximal fretting crown segment is inclusively from 180% to 194.39% of a distance from the laterally proximal saddling interface to the first laterally proximal fretting crown segment. In some embodiments, a distance from the laterally proximal saddling interface to the second laterally proximal fretting crown segment is inclusively from 194.39% to 220% of a distance from the laterally proximal saddling interface to the first laterally proximal fretting crown segment. In some embodiments, a distance from the laterally proximal saddling interface to the second laterally proximal fretting crown segment is inclusively from 194.72% to 220% of a distance from the laterally proximal saddling interface to the first laterally proximal fretting crown segment. In some embodiments, a distance from the laterally proximal saddling interface to the second laterally proximal fretting crown segment is inclusively from 195.04% to 220% of a distance from the laterally proximal saddling interface to the first laterally proximal fretting crown segment. In some embodiments, a distance from the laterally proximal saddling interface to the second laterally proximal fretting crown segment is inclusively from 195.37% to 220% of a distance from the laterally proximal saddling interface to the first laterally proximal fretting crown segment.

In some embodiments, a distance from the laterally proximal saddling interface to the second laterally proximal fretting crown segment is inclusively from 138% to 152% of a distance from the laterally proximal saddling interface to the first laterally proximal fretting crown segment. In some embodiments, a distance from the laterally proximal saddling interface to the third laterally proximal fretting crown segment is inclusively from 255% to 283.48% of a distance from the laterally proximal saddling interface to the first laterally proximal fretting crown segment. In some embodiments, a distance from the laterally proximal saddling interface to the third laterally proximal fretting crown segment is inclusively from 283.48% to 325% of a distance from the laterally proximal saddling interface to the first laterally proximal fretting crown segment. In some embodiments, a distance from the laterally proximal saddling interface to the third laterally proximal fretting crown segment is inclusively from 284.12% to 325% of a distance from the laterally proximal saddling interface to the first laterally proximal fretting crown segment.

In some embodiments, a distance from the laterally proximal saddling interface to a longitudinally forward extent of the block is equal to or less than 525% of the distance from the laterally proximal saddling interface to the first laterally proximal fretting crown segment. In some embodiments, a distance from the laterally proximal saddling interface to a longitudinally forward extent of the block is equal to or less than 450% of the distance from the laterally proximal saddling interface to the first laterally proximal fretting crown segment.

A vertical position of the block may be adjustable relative to the body of the stringed musical instrument. In some embodiments, a vertical position of the laterally proximal saddling interface and a vertical position of the laterally distal saddling interface are adjustable relative to one another. In some embodiments, the assembly further includes a height screw configured to adjust a vertical position of a longitudinally forward end of the block relative to the body of the stringed musical instrument. The assembly may include a height screw configured to adjust a vertical position of a longitudinally rearward end of the block relative to the body of the stringed musical instrument.

In some embodiments, the block includes a longitudinally forward end and a longitudinally rearward end opposite the longitudinally forward end. The assembly may include a first height screw and a second height screw. The first height screw may be configured to adjust a vertical position of the longitudinally forward end of the block relative to the body of the stringed musical instrument. The second height screw may be configured to adjust a vertical position of the longitudinally rearward end of the block relative to the body of the stringed musical instrument.

According to some embodiments, the block further includes a longitudinally forward end and a longitudinally rearward end opposite the longitudinally forward end. The assembly may further include three height screws spaced apart in a triangular arrangement. The three height screws may be configured to adjust i) a vertical position of the longitudinally forward end of the block relative to the body of the stringed musical instrument, ii) a vertical position of the longitudinally rearward end of the block relative to the body of the stringed musical instrument, and iii) a vertical position of the laterally proximal saddling interface relative to a vertical position of the laterally distal saddling interface.

In some embodiments, a longitudinal position of the block is adjustable relative to the body of the stringed musical instrument. The block may include a slot configured to receive an insert of the stringed musical instrument connected to the body of the stringed musical instrument. When the insert of the stringed musical instrument is inserted into the slot, a longitudinal position of the block may be adjustable by manipulating the block, via the slot, along the insert of the stringed musical instrument.

In some embodiments, the assembly includes a fastener configured to couple the block to the body of the stringed musical instrument. In some embodiments, the assembly includes a fastener configured to lock the longitudinal position of the block. In some embodiments, the assembly includes a fastener configured to lock the vertical position of the longitudinally forward end of the block. In some embodiments, the assembly includes a fastener configured to lock the vertical position of the longitudinally rearward end of the block. The block may include an opening configured to receive the fastener.

In some embodiments, adjusting the vertical position of the longitudinally forward end of the block relative to the body of the stringed musical instrument adjusts i) the vertical position of the laterally proximal saddling interface, ii) the vertical position of the laterally distal saddling interface, iii) the vertical position of the first laterally proximal fretting crown segment, or iv) any combination of the three, relative to the body of the stringed musical instrument. Adjusting the vertical position of the longitudinally rearward end of the block relative to the body of the stringed musical instrument may adjust i) the vertical position of the laterally proximal saddling interface, ii) the vertical position of the laterally distal saddling interface, iii) the vertical position of the first laterally proximal fretting crown segment, or any combination of the three, relative to the body of the stringed musical instrument.

A longitudinal position of the laterally proximal saddling interface may be inclusively from .25 mm farther longitudinally rearward to 5 mm farther longitudinally forward than a longitudinal position of the laterally distal saddling interface. A longitudinal position of the laterally proximal saddling interface may be inclusively from .25 mm to 50 mm farther longitudinally rearward than a longitudinal position of the laterally distal saddling interface. A longitudinal position of the laterally proximal saddling interface may be inclusively from .5 mm to 50 mm farther longitudinally rearward than a longitudinal position of the laterally distal saddling interface.

The block may be disposed on the body of the stringed musical instrument with the first laterally proximal fretting crown segment located longitudinally between the laterally proximal saddling interface and the neck.

Also included in the present disclosure is an assembly for a stringed musical instrument. In some embodiments, the assembly includes a support coupleable to a body of the stringed musical instrument. The assembly may include a block having a laterally proximal saddling interface, a laterally distal saddling interface, and a first laterally proximal fretting crown segment. The laterally proximal fretting crown segment may be spaced longitudinally forward of the laterally proximal saddling interface. The block may be adjustably positionable on the support such that the stringed musical instrument is configurable with a proto string of the stringed musical instrument extending from a proto string longitudinally rearward critical contact point on the laterally proximal saddling interface, at a wrist fretable vertical distance above the first laterally proximal fretting crown segment, above a neck of the stringed musical instrument connected to the body of the stringed musical instrument, to a proto string longitudinally forward critical contact point on a nut of the stringed musical instrument disposed on the neck of the stringed musical instrument.

In some embodiments, the block is adjustably positionable on the support such that the stringed musical instrument is configurable with a deutero string of the stringed musical instrument extending from a deutero string longitudinally rearward critical contact point on the laterally distal saddling interface, above the neck of the stringed musical instrument, to a deutero string longitudinally forward critical contact point on the nut of the stringed musical instrument. The deutero string of the stringed musical instrument may be laterally spaced from the proto string of the stringed musical instrument.

In some embodiments, the block includes a laterally proximal string guide indentation configured to position the proto string of the stringed musical instrument on the laterally proximal saddling interface. The block may include a laterally distal string guide indentation configured to position the deutero string of the stringed musical instrument on the laterally distal saddling interface. A lateral width of the block may be equal to or less than 60 millimeters (mm).

In some embodiments, the block includes a second laterally proximal fretting crown segment spaced longitudinally forward of the first laterally proximal fretting crown segment. The block may include a third laterally proximal fretting crown segment spaced longitudinally forward of the second laterally proximal fretting crown segment. The block may include a fourth laterally proximal fretting crown segment spaced longitudinally forward of the third laterally proximal fretting crown segment.

In some embodiments, the block includes a first laterally distal fretting crown segment spaced longitudinally forward of the laterally distal saddling interface. The block may include a second laterally distal fretting crown segment spaced longitudinally forward of the first laterally distal fretting crown segment. The block may include a third laterally distal fretting crown segment spaced longitudinally forward of the second laterally distal fretting crown segment. The block may include a fourth laterally distal fretting crown segment spaced longitudinally forward of the third laterally distal fretting crown segment.

In some embodiments, a distance from the laterally proximal saddling interface to the second laterally proximal fretting crown segment is inclusively from 180% to 194.39% of a distance from the laterally proximal saddling interface to the first laterally proximal fretting crown segment. In some embodiments, a distance from the laterally proximal saddling interface to the second laterally proximal fretting crown segment is inclusively from 194.39% to 220% of a distance from the laterally proximal saddling interface to the first laterally proximal fretting crown segment. In some embodiments, a distance from the laterally proximal saddling interface to the second laterally proximal fretting crown segment is inclusively from 194.72% to 220% of a distance from the laterally proximal saddling interface to the first laterally proximal fretting crown segment. In some embodiments, a distance from the laterally proximal saddling interface to the second laterally proximal fretting crown segment is inclusively from 195.04% to 220% of a distance from the laterally proximal saddling interface to the first laterally proximal fretting crown segment. In some embodiments, a distance from the laterally proximal saddling interface to the second laterally proximal fretting crown segment is inclusively from 195.37% to 220% of a distance from the laterally proximal saddling interface to the first laterally proximal fretting crown segment. In some embodiments, a distance from the laterally proximal saddling interface to the second laterally proximal fretting crown segment is inclusively from 138% to 152% of a distance from the laterally proximal saddling interface to the first laterally proximal fretting crown segment. In some embodiments, a distance from the laterally proximal saddling interface to the third laterally proximal fretting crown segment is inclusively from 255% to 283.48% of the distance from the laterally proximal saddling interface to the first laterally proximal fretting crown segment. In some embodiments, a distance from the laterally proximal saddling interface to the third laterally proximal fretting crown segment is inclusively from 283.48% to 325% of the distance from the laterally proximal saddling interface to the first laterally proximal fretting crown segment. In some embodiments, a distance from the laterally proximal saddling interface to the third laterally proximal fretting crown segment is inclusively from 284.12% to 325% of the distance from the laterally proximal saddling interface to the first laterally proximal fretting crown segment.

In some embodiments, a distance from the laterally proximal saddling interface to a longitudinally forward extent of the block is equal to or less than 525% of a distance from the laterally proximal saddling interface to the first laterally proximal fretting crown segment. In some embodiments, a distance from the laterally proximal saddling interface to a longitudinally forward extent of the block is equal to or less than 450% of a distance from the laterally proximal saddling interface to the first laterally proximal fretting crown segment.

In some embodiments, a vertical position of the block is adjustable relative to the support. The assembly may include a height screw configured to adjust the vertical position of the block relative to the support.

A longitudinal position of the block may be adjustable relative to the support. The support may include a substantially longitudinal slot. The longitudinal position of the block may be adjustable by manipulating it along the longitudinal slot.

The assembly may include a fastener configured to couple the block to the support. The block may include an opening configured to receive the fastener. The support may include an opening configured to receive the fastener.

The assembly may include a fastener configured to lock the longitudinal position of the block. The assembly may include a fastener configured to lock the vertical position of the block.

A vertical position of at least one laterally proximal fretting crown segment may be adjustable relative to the proto string of the stringed musical instrument by adjusting the vertical position of at least one longitudinal end of the block. A vertical position of the laterally proximal saddling interface may be adjustable relative to the body of the stringed musical instrument by adjusting the vertical position of at least one longitudinal end of the block. The block may be disposed on the body of the stringed musical instrument with the first laterally proximal fretting crown segment located longitudinally between the laterally proximal saddling interface and the neck.

Also included in the present disclosure is an assembly for a stringed musical instrument. In some embodiments, the assembly includes a block having a first saddling interface and a fretting crown longitudinally forward of the first saddling interface. The assembly may include a laterally proximal height screw. The assembly may include a laterally distal height screw. The fretting crown may include a distal lateral end and a proximal lateral end. The block may be adjustably positionable on a body of the stringed musical instrument such that the stringed musical instrument is configurable with a proto string of the stringed musical instrument extending i) from a proto string longitudinally rearward critical contact point on the first saddling interface, ii) at a wrist fretable vertical distance above the fretting crown, iii) above a neck of the stringed musical instrument connected to the body of the stringed musical instrument, iv) to a proto string longitudinally forward critical contact point on a nut of the stringed musical instrument disposed on the neck of the stringed musical instrument. The laterally proximal height screw may be configured to adjust a vertical position of the proximal lateral end of the fretting crown relative to the body of the stringed musical instrument. The laterally distal height screw may be configured to adjust a vertical position of the distal lateral end of the fretting crown relative to the body of the stringed musical instrument.

According to some embodiments, the laterally proximal height screw and the laterally distal height screw are configured to adjust i) a vertical position of a longitudinally forward end of the block relative to the body of the stringed musical instrument, ii) a vertical position of a longitudinally rearward end of the block relative to the body of the stringed musical instrument, or iii) both.

The assembly may include a second saddling interface. The second saddling interface may be laterally spaced from the first saddling interface. The block may be further adjustably positionable on the body of the stringed musical instrument such that the stringed musical instrument is configurable with a deutero string of the stringed musical instrument extending i) from a deutero string longitudinally rearward critical contact point on the second saddling interface, ii) above the neck of the stringed musical instrument, iii) to a deutero string longitudinally forward critical contact point on the nut of the stringed musical instrument. The deutero string of the stringed musical instrument may be laterally spaced from the proto string of the stringed musical instrument. The laterally proximal height screw and the laterally distal height screw may be further configured to adjust the vertical position of the first saddling interface and a vertical position of the second saddling interface relative to one another.

In some embodiments, the block includes a first string guide indentation configured to position the proto string of the stringed musical instrument on the first saddling interface. In some embodiments, the block includes a second string guide indentation configured to position the deutero string of the stringed musical instrument on the second saddling interface.

According to some embodiments, a longitudinal position of the block is adjustable relative to the body of the stringed musical instrument. The assembly may include a fastener configured to couple the block to the body of the stringed musical instrument. In some embodiments, the assembly includes a fastener configured to lock the longitudinal position of the block.

According to some embodiments, the vertical position of the fretting crown is adjustable relative to the proto string of the stringed musical instrument by adjusting the vertical position of at least one longitudinal end of the block.

The vertical position of the first saddling interface may be adjustable relative to the body of the stringed musical instrument by adjusting the vertical position of at least one longitudinal end of the block.

In some embodiments, the block is disposed on the body of the stringed musical instrument with the fretting crown located longitudinally between the first saddling interface and the neck.

Also included in the present disclosure is a stringed musical instrument. In some embodiments, the stringed musical instrument includes a body. The stringed musical instrument may include a neck having a longitudinally rearward end connected to the body and a longitudinally forward end located away from the body. The stringed musical instrument may include a fingerboard connected to the neck. The stringed musical instrument may include a nut disposed on the longitudinally forward end of the neck. The stringed musical instrument may include a block having a laterally proximal saddling interface, a laterally distal saddling interface, and a first laterally proximal fretting crown segment. The first laterally proximal fretting crown segment may be spaced longitudinally forward of the laterally proximal saddling interface. The block may be adjustably positionable on the body such that the stringed musical instrument is configurable with a proto string extending from a proto string longitudinally rearward critical contact point on the laterally proximal saddling interface, at a wrist fretable vertical distance above the first laterally proximal fretting crown segment, above the fingerboard, to a proto string longitudinally forward critical contact point on the nut.

The block may be adjustably positionable on the body such that the stringed musical instrument is configurable with a deutero string extending from a deutero string longitudinally rearward critical contact point on the laterally distal saddling interface, above the fingerboard, to a deutero string longitudinally forward critical contact point on the nut. The deutero string may be laterally spaced from the proto string.

In some embodiments, the block includes a laterally proximal string guide indentation configured to position the proto string on the laterally proximal saddling interface. In some embodiments, the block includes a laterally distal string guide indentation configured to position the deutero string on the laterally distal saddling interface.

The stringed musical instrument may include a sequence of fingerboard frets on the fingerboard. The sequence of fingerboard frets may include a first fingerboard fret. A distance from the laterally proximal saddling interface to the first laterally proximal fretting crown segment may be inclusively from 100% to 120% of a distance from the first fingerboard fret to the nut.

The stringed musical instrument may include a sequence of fingerboard frets on the neck. The sequence of fingerboard frets may include a first fingerboard fret. A distance from the laterally proximal saddling interface to the first laterally proximal fretting crown segment may be inclusively from 80% to 100% of a distance from the first fingerboard fret to the nut.

The stringed musical instrument may include a sequence of fingerboard frets on the neck. The sequence of fingerboard frets may include a first fingerboard fret. A distance from the laterally proximal saddling interface to the first laterally proximal fretting crown segment may be inclusively from 80% to 99.5% of a distance from the first fingerboard fret to the nut.

The stringed musical instrument may include a sequence of fingerboard frets on the neck. The sequence of fingerboard frets may include a first fingerboard fret. A distance from the laterally proximal saddling interface to the first laterally proximal fretting crown segment may be inclusively from 80% to 99% of a distance from the first fingerboard fret to the nut.

A lateral width of the block may be equal to or less than 60 millimeters (mm).

In some embodiments, a distance from the laterally proximal saddling interface to a longitudinally forward extent of the block is equal to or less than 525% of the distance from the laterally proximal saddling interface to the first laterally proximal fretting crown segment.

According to some embodiments, the block includes a second laterally proximal fretting crown segment spaced longitudinally forward of the first laterally proximal fretting crown segment. The block may include a third laterally proximal fretting crown segment spaced longitudinally forward of the second laterally proximal fretting crown segment. The block may include a fourth laterally proximal fretting crown segment spaced longitudinally forward of the third laterally proximal fretting crown segment.

According to some embodiments, the block includes a first laterally distal fretting crown segment spaced longitudinally forward of the laterally distal saddling interface. The block may include a second laterally distal fretting crown segment spaced longitudinally forward of the first laterally distal fretting crown segment. The block may include a third laterally distal fretting crown segment spaced longitudinally forward of the second laterally distal fretting crown segment. The block may include a fourth laterally distal fretting crown segment spaced longitudinally forward of the third laterally distal fretting crown segment.

A longitudinal position of the laterally proximal saddling interface may be inclusively from .25 mm farther longitudinally rearward to 5 mm farther longitudinally forward than a longitudinal position of the laterally distal saddling interface. A longitudinal position of the laterally proximal saddling interface may be inclusively from .25 mm to 50 mm farther longitudinally rearward than a longitudinal position of the laterally distal saddling interface. A longitudinal position of the laterally proximal saddling interface may be inclusively from .5 mm to 50 mm farther longitudinally rearward than a longitudinal position of the laterally distal saddling interface.

A vertical position of a longitudinally forward end of the block may be adjustable relative to the body. A vertical position of a longitudinally rearward end of the block may be adjustable relative to the body. A vertical position of the laterally proximal saddling interface may be adjustable relative to a vertical position of the laterally distal saddling interface.

The stringed musical instrument may include a forward height screw configured to adjust a vertical position of a longitudinally forward end of the block relative to the body. The stringed musical instrument may include a rearward height screw configured to adjust a vertical position of a longitudinally rearward end of the block relative to the body.

According to some embodiments, the stringed musical instrument includes three height screws. The first height screw, the second height screw, and the third height screw may be spaced apart in a triangular arrangement. The three height screws may be configured to adjust a vertical position of a longitudinally forward end of the block relative to the body, to adjust a vertical position of a longitudinally rearward end of the block relative to the body, and to adjust a vertical position of the laterally proximal saddling interface relative to a vertical position of the laterally distal saddling interface.

According to some embodiments, a longitudinal position of the block is adjustable relative to the body.

The stringed musical instrument may include a support. The support may be coupled to the body. The support may include a substantially longitudinal slot. A longitudinal position of the block may be adjustable by manipulating the block along the slot.

The stringed musical instrument may include a support and an insert connected to the support. The support may be coupled to the body. The block may include a slot configured to receive the insert. With the insert inserted into the slot, a longitudinal position of the block may be adjustable by manipulating the block, via the slot, along the insert.

In some embodiments, the slot (whether in the block or in the support) is laterally between the proto string and the deutero string.

According to some embodiments, the stringed musical instrument further includes a support. The support may be coupled to the body. The support may include a height adjustment hole disposed under the block. A height screw may be configured to insert into the height adjustment hole and to adjust a vertical position of the block by pushing against a downward surface of the block.

The stringed musical instrument may further include a support. The support may be coupled to the body. The block may include a height adjustment hole disposed above the support. A height screw may be configured to insert into the height adjustment hole and adjust a vertical position of the block by pushing against the support.

In some embodiments, the stringed musical instrument includes a fastener configured to couple the block to the body. In some embodiments, the stringed musical instrument includes a fastener configured to couple the block to the support.

A longitudinal position of the block may be adjustable relative to the body.

In some embodiments, the stringed musical instrument includes a fastener configured to lock the longitudinal position of the block. In some embodiments, the stringed musical instrument includes a fastener configured to lock the vertical position of the longitudinally forward end of the block. In some embodiments, the stringed musical instrument includes a fastener configured to lock the vertical position of the longitudinally rearward end of the block. In some embodiments, the stringed musical instrument includes a fastener configured to lock the vertical position of the block.

According to some embodiments, adjusting the vertical position of the longitudinally forward end of the block relative to the body adjusts i) the vertical position of the laterally proximal saddling interface, ii) the vertical position of the laterally distal saddling interface, iii) the vertical position of the first laterally proximal fretting crown segment, or iv) any combination of the three, relative to the body. Adjusting the vertical position of the longitudinally rearward end of the block relative to the body may adjust i) the vertical position of the laterally proximal saddling interface, ii) the vertical position of the laterally distal saddling interface, iii) the vertical position of the first laterally proximal fretting crown segment, or iv) any combination of the three, relative to the body.

In some embodiments, the block is disposed on the body with the first laterally proximal fretting crown segment located longitudinally between the laterally proximal saddling interface and the neck.

According to some embodiments, the body is hollow and includes a soundboard. The block may be disposed on the soundboard.

Also included in the present disclosure is an assembly for a stringed musical instrument. In some embodiments, the assembly includes a block having a first saddling interface and a fretting crown spaced longitudinally forward of the first saddling interface. The assembly may include two height screws. The block may be adjustably positionable on a body of the stringed musical instrument such that a proto string of the stringed musical instrument extends i) from a proto string longitudinally rearward critical contact point on the first saddling interface, ii) at a wrist fretable vertical distance above the fretting crown, iii) above a neck of the stringed musical instrument connected to the body of the stringed musical instrument, iv) to a proto string longitudinally forward critical contact point on a nut of the stringed musical instrument disposed on the neck of the stringed musical instrument. The block may include a longitudinally forward end and a longitudinally rearward end opposite the longitudinally forward end. A first height screw of the two height screws may be configured to adjust a vertical position of the longitudinally forward end of the block relative to the body of the stringed musical instrument. A second height screw of the two height screws may be configured to adjust a vertical position of the longitudinally rearward end of the block relative to the body of the stringed musical instrument.

In some embodiments, the block includes a second saddling interface. The second saddling interface may be laterally distal to the first saddling interface. The block may be adjustably positionable on the body of the stringed musical instrument such that a deutero string of the stringed musical instrument extends i) from a deutero string longitudinally rearward critical contact point on the second saddling interface, ii) above the neck of the stringed musical instrument, iii) to a deutero string longitudinally forward critical contact point on the nut of the stringed musical instrument. The deutero string of the stringed musical instrument may be laterally distal to and laterally spaced from the proto string of the stringed musical instrument.

Also included in the present disclosure is an assembly for a stringed musical instrument. In some embodiments, the assembly includes a block having a first saddling interface and a fretting crown spaced longitudinally forward of the first saddling interface. The assembly may include a laterally proximal height screw. The assembly may include a laterally distal height screw. The fretting crown may include a proximal lateral end and a distal lateral end opposite the proximal lateral end. The block may be adjustably positionable on a body of the stringed musical instrument such that a proto string of the stringed musical instrument extends i) from a proto string longitudinally rearward critical contact point on the first saddling interface, ii) at a wrist fretable vertical distance above the fretting crown, iii) above a neck of the stringed musical instrument connected to the body of the stringed musical instrument, iv) to a proto string longitudinally forward critical contact point on a nut of the stringed musical instrument disposed on the neck of the stringed musical instrument. The laterally proximal height screw and the laterally distal height screw may be configured to adjust a vertical position of the proximal lateral end of the fretting crown relative to a vertical position of the distal lateral end of the fretting crown.

In some embodiments, the assembly includes a second saddling interface. The second saddling interface may be laterally distal to the first saddling interface. The block may be adjustably positionable on the body of the stringed musical instrument such that a deutero string of the stringed musical instrument extends i) from a deutero string longitudinally rearward critical contact point on the second saddling interface, ii) above the neck of the stringed musical instrument, iii) to a deutero string longitudinally forward critical contact point on the nut of the stringed musical instrument. The deutero string of the stringed musical instrument may be laterally distal to and laterally spaced from the proto string of the stringed musical instrument. The laterally proximal height screw and the laterally distal height screw may be configured to adjust a vertical position of the first saddling interface relative to a vertical position of the second saddling interface.

Also included in the present disclosure is an assembly for a stringed musical instrument. In some embodiments, the assembly includes a block having a saddling interface and a first fretting crown spaced longitudinally forward of the saddling interface. The block may be adjustably positionable on a body of the stringed musical instrument such that a proto string of the stringed musical instrument extends i) from a proto string longitudinally rearward critical contact point on the saddling interface, ii) at a wrist fretable vertical distance above the first fretting crown, iii) above a neck of the stringed musical instrument connected to the body of the stringed musical instrument, iv) to a proto string longitudinally forward critical contact point on a nut of the stringed musical instrument disposed on the neck of the stringed musical instrument. The block may include a longitudinally forward end and a longitudinally rearward end opposite the longitudinally forward end. A vertical position of the longitudinally forward end of the block may be adjustable relative to a vertical position of the longitudinally rearward end of the block.

The block may include a second fretting crown spaced longitudinally forward of the first fretting crown. A distance from the saddling interface to the second fretting crown may be inclusively from 180% to 194.39% of a distance from the saddling interface to the first fretting crown.

The block includes a second fretting crown spaced longitudinally forward of the first fretting crown. A distance from the saddling interface to the second fretting crown may be inclusively from 194.39% to 220% of a distance from the saddling interface to the first fretting crown.

In some embodiments, the block includes a second fretting crown spaced longitudinally forward of the first fretting crown. A distance from the saddling interface to the second fretting crown may be inclusively from 194.72% to 220% of a distance from the saddling interface to the first fretting crown.

The block may include a second fretting crown spaced longitudinally forward of the first fretting crown. A distance from the saddling interface to the second fretting crown may be inclusively from 195.04% to 220% of a distance from the saddling interface to the first fretting crown.

According to some embodiments, the block includes a second fretting crown spaced longitudinally forward of the first fretting crown. A distance from the saddling interface to the second fretting crown may be inclusively from 195.37% to 220% of a distance from the saddling interface to the first fretting crown.

In some embodiments, the block includes a second fretting crown spaced longitudinally forward of the first fretting crown. A distance from the saddling interface to the second fretting crown may be inclusively from 138% to 152% of a distance from the saddling interface to the first fretting crown.

The block may include a second fretting crown and a third fretting crown. The second fretting crown may be spaced longitudinally forward of the first fretting crown. The third fretting crown may be spaced longitudinally forward of the second fretting crown. A distance from the saddling interface to the third fretting crown may be inclusively from 283.48% to 325% of a distance from the saddling interface to the first fretting crown.

In some embodiments, the block includes a second fretting crown and a third fretting crown. The second fretting crown may be spaced longitudinally forward of the first fretting crown. The third fretting crown may be spaced longitudinally forward of the second fretting crown. A distance from the saddling interface to the third fretting crown may be inclusively from 284.12% to 325% of a distance from the saddling interface to the first fretting crown.

In some embodiments, the assembly includes a shim configured to adjust the vertical position of the longitudinally forward end of the block, the vertical position of the longitudinally rearward end of the block, or both relative to the body of the stringed musical instrument.

According to some embodiments, the saddling interface is a first saddling interface. The block may include a second saddling interface laterally distal to the first saddling interface. The block may be adjustably positionable on the body of the stringed musical instrument such that a deutero string of the stringed musical instrument extends i) from a deutero string longitudinally rearward critical contact point on the second saddling interface, ii) above the neck of the stringed musical instrument, iii) to a deutero string longitudinally forward critical contact point on the nut of the stringed musical instrument. The deutero string of the stringed musical instrument may be laterally distal to and laterally spaced from the proto string of the stringed musical instrument.

The first saddling interface may be inclusively from 0.0 millimeters (mm) to 50 mm farther longitudinally rearward than the second saddling interface. The first saddling interface may be inclusively from 0.127 mm to 50 mm farther longitudinally rearward than the second saddling interface. The first saddling interface may be inclusively from 0.25 mm to 50 mm farther longitudinally rearward than the second saddling interface. The first saddling interface may be inclusively from 0.375 mm to 50 mm farther longitudinally rearward than the second saddling interface. The first saddling interface may be inclusively from .5 mm to 50 mm farther longitudinally rearward than the second saddling interface.

According to some embodiments, the assembly further includes three height screws spaced apart in a triangular arrangement. The three height screws may be configured to adjust i) the vertical position of the longitudinally forward end of the block relative to the body of the stringed musical instrument, ii) the vertical position of the longitudinally rearward end of the block relative to the body of the stringed musical instrument, and iii) a vertical position of the first saddling interface relative to a vertical position of the second saddling interface.

In some embodiments, the block includes a first string guide indentation configured to position the proto string of the stringed musical instrument on the first saddling interface.

According to some embodiments, a vertical position of the first saddling interface and a vertical position of the second saddling interface are adjustable relative to one another.

The first fretting crown may include a first lateral end and a second lateral end opposite the first lateral end. The block may be configured to couple to the body of the stringed musical instrument such that the first lateral end of the first fretting crown is laterally between the proto string of the stringed musical instrument and a deutero string of the stringed musical instrument. The deutero string of the stringed musical instrument may extend i) from the body of the stringed musical instrument, ii) above the neck of the stringed musical instrument, iii) to the nut of the stringed musical instrument. The deutero string of the stringed musical instrument may be laterally spaced from the proto string of the stringed musical instrument.

In some embodiments, the assembly includes a height screw configured to adjust a vertical position of the block relative to the body of the stringed musical instrument. In some embodiments, the vertical position of the longitudinally forward end of the block is adjustable relative to the vertical position of the longitudinally rearward end of the block by pivoting the block on the height screw.

The block may include an upward facing face and a forward facing surface. The first fretting crown may include a rounded edge between the upward facing face and the forward facing surface.

The first fretting crown is oriented at a fingerboard matching angle that matches a fingerboard angle of a fingerboard.

The first fretting crown may include a first lateral end and a second lateral end opposite the first lateral end. The block is configured to couple to the body of the stringed musical instrument such that the first lateral end of the first fretting crown is laterally between the proto string of the stringed musical instrument and a trito string of the stringed musical instrument. The trito string of the stringed musical instrument may extend i) from the body of the stringed musical instrument, ii) above the neck of the stringed musical instrument, iii) to the nut of the stringed musical instrument. The trito string of the stringed musical instrument may be laterally spaced i) from the proto string of the stringed musical instrument, and ii) from the deutero string of the stringed musical instrument.

In some embodiments, the assembly further includes a positioning screw configured to adjust a longitudinal position of the block relative to the body of the stringed musical instrument.

According to some embodiments, a longitudinal position of the block is adjustable relative to the body of the stringed musical instrument.

The foregoing, and other features and advantages of the invention, will be apparent from the following, more particular description of the preferred embodiments of the invention, the accompanying drawings, and the claims.

### BRIEF DESCRIPTION OF DRAWINGS

These and other features, aspects, and advantages are described below with reference to the drawings, which are intended to illustrate, but not to limit, the invention.

FIG. 1 illustrates an orthographic view of an instrument, a picking hand, and a fretting hand, according to some embodiments. As illustrated in FIG. 1, a broken line represents a fretting saddling member hidden by the picking hand, according to some embodiments.

FIG. 2 illustrates an orthographic view of a picking hand of a right handed player, according to some embodiments.

FIG. 3 illustrates an orthographic view of an instrument and a picking hand, according to some embodiments. As illustrated in FIG. 3, a broken line represents a fretting saddling member hidden by the picking hand, according to some embodiments.

FIG. 4 illustrates a perspective view of an assembly including a fretting saddling member on a body and a picking hand, according to some embodiments. As illustrated in FIG. 4, the pisiform bone wrist area of the picking hand is depressing a string against a fretting crown, and the string is pluckable with the thumb, according to some embodiments.

FIG. 5 illustrates a partial orthographic side view of a body, a fretting saddling member, and a string, according to some embodiments. As illustrated in FIG. 5, a string contacts a saddling interface and extends above fretting crowns on the fretting saddling member, according to some embodiments.

FIG. 6 illustrates a partial orthographic side view of a body, a fretting saddling member, a string, and a wrist, according to some embodiments. As illustrated in FIG. 6, the pisiform bone wrist area is depressing a string against a fretting crown, according to some embodiments.

FIG. 7 illustrates an orthographic view of an instrument and an assembly, according to some embodiments. As illustrated in FIGS. 7-14, a fretting saddling member which couples to a support is included by an assembly of an instrument, according to some embodiments.

FIG. 8 illustrates an orthographic view of an instrument and an assembly from the back, according to some embodiments.

FIG. 9 illustrates an isometric view of an assembly on a body, according to some embodiments.

FIG. 10 illustrates a partial exploded view of an assembly on a body, according to some embodiments.

FIG. 11 illustrates an orthographic view of an assembly on a body, according to some embodiments.

FIG. 12 illustrates a partial cross-sectional view of a longitudinally forward end of a neck, along 12-12 in FIG. 7, according to some embodiments.

FIG. 13 illustrates a partial cross-sectional view of a body and an assembly, along 13-13 in FIG. 7, according to some embodiments.

FIG. 14 illustrates an isometric view of a fretting saddling member, according to some embodiments.

FIG. 15 illustrates a partial orthographic view of an assembly on a body, according to some embodiments. The fretting saddling members illustrated in FIGS. 16-18 may be attached to the support shown in FIG. 15 in place of the fretting saddling member illustrated in that figure.

FIG. 16 illustrates an orthographic view of a fretting saddling member, according to some embodiments.

FIG. 17 illustrates an orthographic view of a fretting saddling member, according to some embodiments.

FIG. 18 illustrates an orthographic view of a fretting saddling member, according to some embodiments.

FIG. 19 illustrates a partial orthographic view of an assembly on a body, according to some embodiments. The fretting saddling members illustrated in FIGS. 20 and 21 may be attached to the support shown in FIG. 19 in place of the fretting saddling member illustrated in that figure.

FIG. 20 illustrates an orthographic view of a fretting saddling member, according to some embodiments.

FIG. 21 illustrates an isometric view of a fretting saddling member, according to some embodiments.

FIG. 22 illustrates a partial view of an instrument, from a longitudinally rearward viewpoint, showing a fretting saddling member, a fretting appendage, a fingerboard fret, and a fingerboard, according to some embodiments.

FIG. 23 illustrates an isometric view of an assembly on a body, according to some embodiments. As illustrated in FIGS. 23 and 24, an assembly includes a fretting saddling member and a fretting appendage, according to some embodiments.

FIG. 24 illustrates a partial exploded view of an assembly, according to some embodiments.

FIG. 25 illustrates an isometric view of an assembly on a body, according to some embodiments. As illustrated in FIGS. 25-27, a fretting saddling member is coupled to a support which includes height adjustment holes and fastening slots, according to some embodiments.

FIG. 26 illustrates a partial exploded view of an assembly on a body, according to some embodiments.

FIG. 27 illustrates a partial cross-sectional view of a body and an assembly, along 27-27 in FIG. 25, according to some embodiments.

FIG. 28 illustrates an isometric view of a fretting saddling member, according to some embodiments.

FIG. 29 illustrates an isometric view of an assembly on a body, according to some embodiments. As illustrated in FIGS. 29 and 30, a fretting saddling member includes two string fretting crowns, according to some embodiments.

FIG. 30 illustrates an isometric view of a fretting saddling member, according to some embodiments.

FIG. 31 illustrates an isometric view of an assembly on a body, according to some embodiments. As illustrated in FIG. 31, an assembly includes two fretting saddling members and a support without a rear wall, according to some embodiments.

FIG. 32 illustrates an orthographic view of an assembly on a body, according to some embodiments. As illustrated in FIG. 32, an assembly includes fretting saddling members and a vibrato mechanism, according to some embodiments.

FIG. 33 illustrates an orthographic view of an assembly on a body of an instrument, according to some embodiments. As illustrated in FIGS. 33 and 34, an assembly includes a pickup, headless tuners are shown on a body, and a neck is illustrated including string anchors for distal strings, according to some embodiments.

FIG. 34 illustrates an orthographic view of a forward end of a headless neck, according to some embodiments.

FIG. 35 illustrates an orthographic view of an instrument with a hollow body and two fretting saddling members, according to some embodiments.

FIG. 36 illustrates a partial isometric view of an assembly on a body, according to some embodiments.

FIG. 37 illustrates a partial isometric view of a fretting saddling member, according to some embodiments.

### DETAILED DESCRIPTION OF THE INVENTION

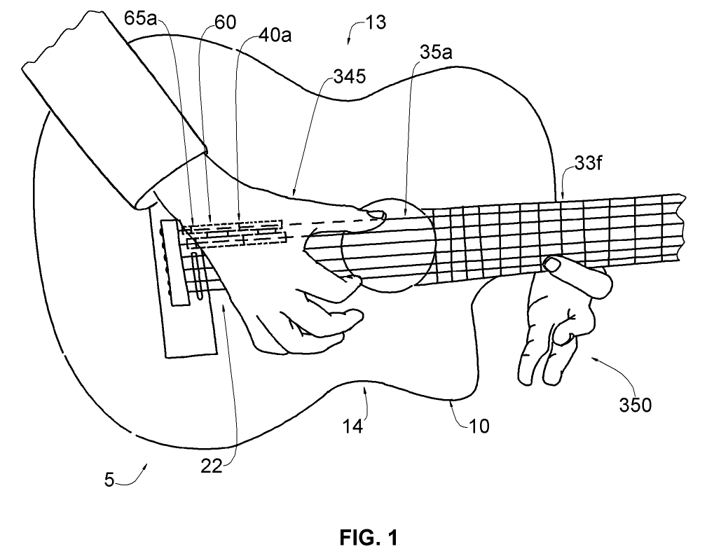

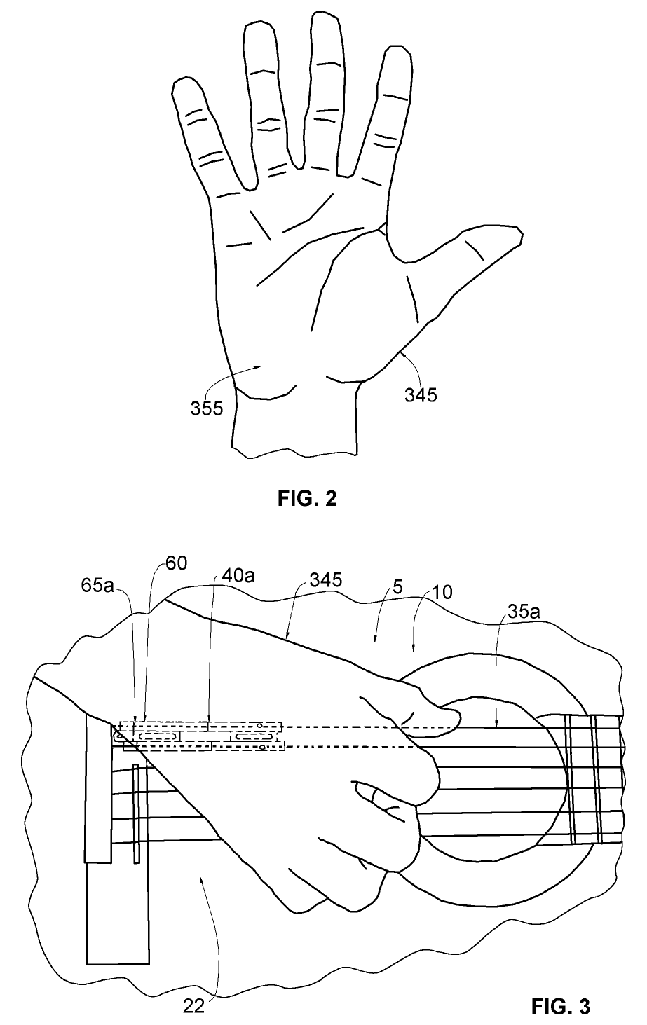

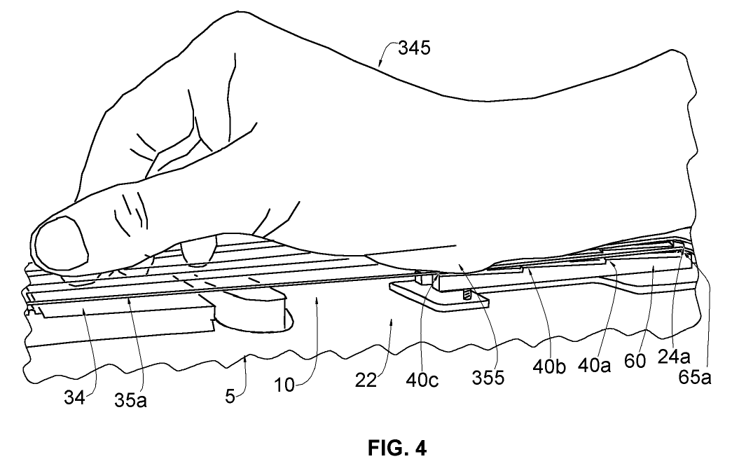

As illustrated in FIG. 1, an instrument 5 is played with a picking hand 345 and a fretting hand 350. As illustrated in FIG. 2, a picking hand 345 includes a pisiform bone wrist area 355. As illustrated in FIG. 3, a picking hand 345 is used to wrist fret on an instrument 5. As illustrated in FIG. 4, a picking hand 345 is used to wrist fret on an instrument 5. An instrument 5 may include a fretting saddling member 60. The fretting saddling member may include a saddling interface 65, which contacts a string 35 at a rearward critical contact point 24 and directs the string above fretting crown segments (a proximal fretting crown segment 40 is an example of a fretting crown segment). The fretting saddling member may be positioned as part of an assembly 22 on a body 10 of the instrument. The instrument may be an acoustic instrument, the body may be hollow, and the assembly may couple the fretting saddling member to a soundboard of the body. The picking hand includes the pisiform bone wrist area 355. The instrument may be played by wrist fretting. Wrist fretting is a previously unknown method of stopping a string in which the pisiform bone wrist area of the picking hand wrist is used to depress the string slightly longitudinally rearward of a fretting crown, shortening the sounding length of the string. The string may then be plucked between the fretting crown and a nut. The pisiform bone wrist area includes the pisiform bone and the flesh, bones, and skin surrounding it. The skin of the wrist may directly contact the string during a wrist fretting action. Both “hand” and “wrist” may be used to indicate the location of the pisiform bone wrist area of the human body. The wrist, including the pisiform bone wrist area, may be understood to be part of the hand.

FIG. 1 illustrates an instrument 5, a picking hand 345, and a fretting hand 350 in a right handed playing posture. A player may wrist fret with the picking hand pisiform bone wrist area, using a first proximal fretting crown segment 40a of a proximal sequence of fretting crown segments of a fretting saddling member 60. The first proximal fretting crown segment may be at a wrist fretable vertical distance under a proto string 35a. The proto string may be a laterally outermost proximal string. The pisiform bone wrist area may depress the proto string between a proximal saddling interface 65a (where the proto string makes critical contact with the fretting saddling member) and the first proximal fretting crown segment until the proto string contacts the first proximal fretting crown segment, shortening the sounding length of the proto string. The fretting saddling member, hidden by the hand, is indicated by a broken line. The player may use the index finger of the fretting hand to fret a laterally outermost distal string at a thirteenth fingerboard fret 33f. If the instrument were in standard guitar tuning, the picking hand thumb might be plucking F2 on the proto string, and the picking hand index finger might be plucking F5 on the laterally outermost distal string. A proximal body side 13 may be nearer to the player’s chest, and a distal body side 14 may be nearer to the player’s legs.

FIG. 2 illustrates a picking hand 345 of a right handed player. The pisiform bone wrist area 355, of a picking hand 345, and the flesh, bones, and skin surrounding it, may be used to wrist fret. With steady practice, a player may develop a tough callus where the skin of the wrist over the pisiform bone contacts the string during a wrist fretting action.

FIG. 3 illustrates an instrument 5 and a picking hand 345, in a right handed posture. A player is illustrated wrist fretting. The picking hand may be positioned to enable the pisiform bone wrist area to depress a proto string 35a rearward of a first proximal fretting crown segment 40a and forward of a proximal saddling interface 65a of a fretting saddling member 60. The proto string may be a laterally outermost proximal string. The picking hand may cover the fretting saddling member, which may be positioned under the proto string and under a consecutive string. The fretting saddling member, hidden by the hand, is indicated by a broken line. The thumb may pluck a wrist fretted note on the proto string, while other fingers may pluck other strings. In a real-world situation, from this perspective, a wrist fretting action may not be visible to a viewer. The player may move the wrist to wrist fret at other fretting crowns on the fretting saddling member, including fretting crowns under the consecutive string.

FIG. 4 illustrates an instrument 5 and a picking hand 345. By wrist fretting, a player may shorten the sounding length of a proto string 35a, which may be a laterally outermost proximal string. The proto string may contact a proximal saddling interface 65a at a first rearward critical contact point 24a. The proximal saddling interface may direct the proto string at a wrist fretable vertical distance above a proximal sequence of fretting crown segments of a fretting saddling member 60, including a first proximal fretting crown segment 40a, a second proximal fretting crown segment 40b, and a third proximal fretting crown segment 40c. The pisiform bone wrist area 355 of the picking hand 345 may depress the proto string slightly longitudinally rearward of the third proximal fretting crown segment (forward of the second proximal fretting crown segment) until the proto string contacts the third proximal fretting crown segment. A shortened sounding length of the string between the third proximal fretting crown segment and a nut may have a pitch above an open note of the proto string. The player may pluck the proto string between the third proximal fretting crown segment and the nut with the picking hand thumb to produce a wrist fretted note, while the remaining fingers of the picking hand may pluck strings which are distal to the proto string. An accessibility surface 34 at the longitudinally rearward end of the fingerboard may provide room for the picking hand fingers and thumb to manipulate strings.

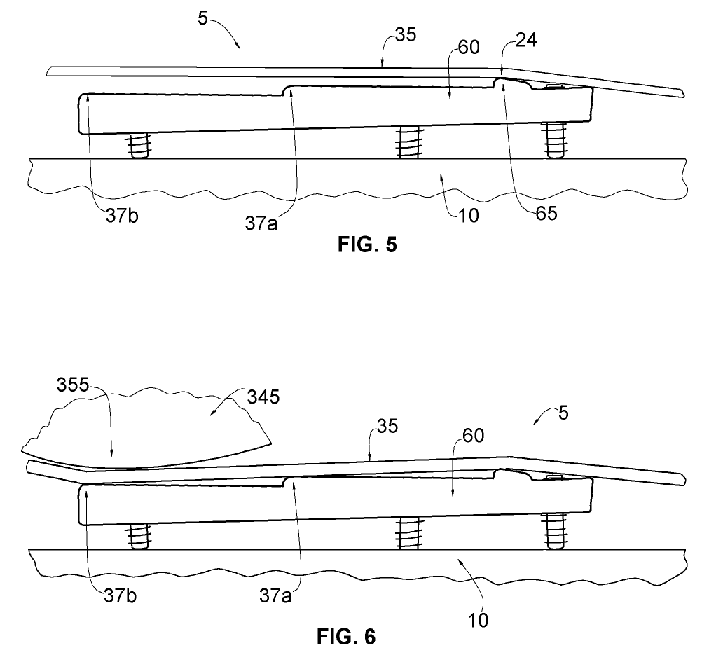

FIG. 5 illustrates a body 10 of an instrument 5, a fretting saddling member 60, and a string 35. FIG. 5 illustrates the string and the fretting saddling member set up so that wrist fretting may be performed. The fretting saddling member may be under and in contact with a string 35. The string may contact a saddling interface 65 at a rearward critical contact point 24. The rearward critical contact point may establish an end of the sounding length of the open string. The saddling interface may direct the string at a wrist fretable vertical distance above a sequence of fretting crowns, including a first one string fretting crown 37a and a second one string fretting crown 37b. The distance between the sequence of fretting crowns of the fretting saddling member and the string may allow fretted fingerboard notes and an open note of the string to be sounded by plucking or strumming. A fretting action on a fingerboard fret may bring the string nearer to the fretting crowns without bringing the string into contact with the fretting crowns.

FIG. 6 illustrates a body 10, a fretting saddling member 60, a string 35, and a pisiform bone wrist area 355. FIG. 6 further illustrates a wrist fretting action as it may appear occurring on an instrument 5 which is set up like that as shown and described in FIG. 5. The pisiform bone wrist area 355 of a picking hand 345 may bring a string into contact with a second one string fretting crown 37b of a sequence of fretting crowns of a fretting saddling member 60. The pisiform bone wrist area may depress the string between the second one string fretting crown and a first one string fretting crown 37a until the string contacts the second one string fretting crown, shortening the sounding length of the string. The skin of the pisiform bone wrist area directly contacts the string. The fretting saddling member is firmly locked in place; in a wrist fretting action, the wrist brings the string to the fretting crown. This wrist fretting action may bring the string nearer to fingerboard frets of a fingerboard without bringing the string into contact with the fingerboard frets.

A fretting crown may extend under one or more strings 35. A string contactable area of a fretting crown usable for wrist fretting with a specific string (without bending the string) may be understood to be a fretting crown segment. A fretting crown segment is part of a fretting crown. A fretting crown may include one, two, three, four, or more fretting crown segments and two lateral ends. A fretting crown may extend laterally under one string, two strings, three strings, four strings, five strings, six strings, or more. A one string fretting crown 37 may extend laterally under a single string, may be of a width configured for use with one string, and may include one fretting crown segment. A two string fretting crown 38 may extend laterally under two consecutive strings, may be of a width configured for use with two strings, and may include two consecutive fretting crown segments. Some players, because of the size of their hands, may find it easier to play on one string fretting crowns, two string fretting crowns, or fretting crowns of other widths; however, basic wrist fretting may be performed on fretting crowns of any width. To describe commonalities between instruments 5 with one string fretting crown, two string fretting crowns, and fretting crowns of other widths, this disclosure will describe instruments in terms of fretting crown segments, which may be included by one string fretting crowns, two string fretting crowns, or fretting crowns of other widths.

In some embodiments, a fretting saddling member includes two saddling interfaces, and one or two sequences of fretting crown segments. A fretting saddling member for a single string, having only one saddling interface and a sequence of one string fretting crowns may be constructed. A fretting saddling member with three or more saddling interfaces and sequences of fretting crowns for each may also be constructed.

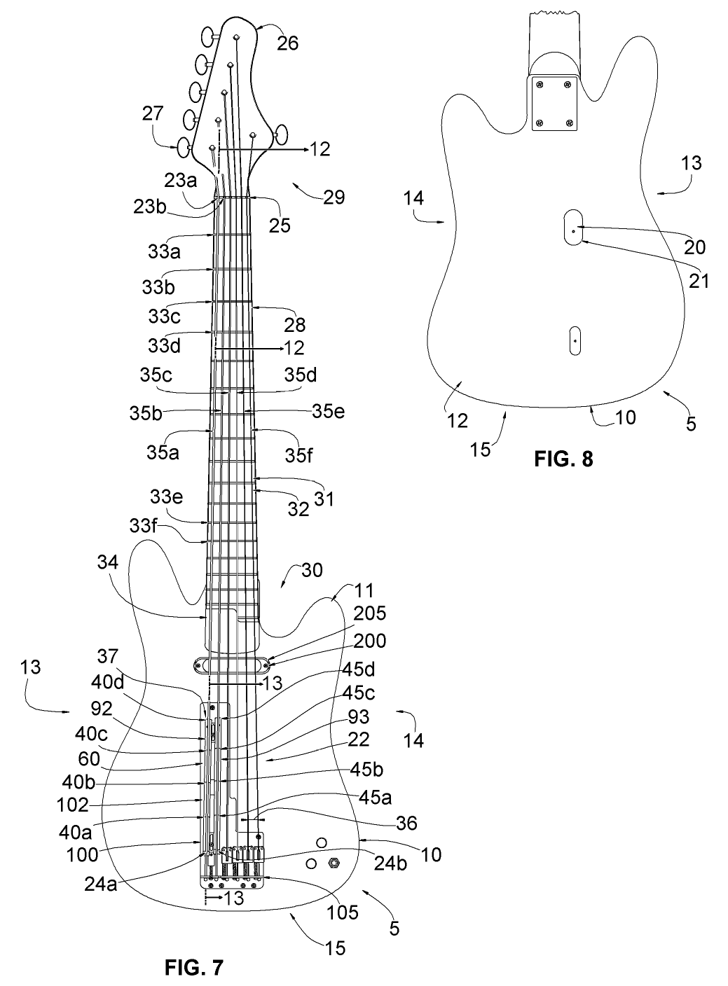

FIG. 7 illustrates an instrument 5 and an assembly 22. FIG. 8 illustrates a back 12 of an instrument 5. An instrument 5 in a six string form may include a body 10. The body may include a top 11, a proximal body side 13, a distal body side 14, a back 12, and a rearward bout 15. One or more body cavities 20 may extend from the top through the back (or may be routs, blind holes, an interior of a soundbox, etc.), and may allow a part of an assembly 22 to insert into the cavity. An aperture 21 of the body cavity at the back may allow access to fastener and height screw heads and drives. A pickup 200 may be installed in a pickup opening 205 of the body and under a plurality of strings.

FIG. 7 illustrates an instrument 5 and an assembly 22. A rearward end 30 of a neck 28 may be connected to a body 10. The neck may extend longitudinally away from the body. A forward end 29 of the neck may be away from (remote from) the body. Tuning machines 27 may be coupled to a headstock 26 of the forward end of the neck. A fingerboard 32 may be connected to the neck. The fingerboard on the neck may include a fret attachment surface 31 to which a sequence of fingerboard frets may be coupled. An accessibility surface 34 of the fingerboard at the rearward end of the neck may be at a lower vertical level than the fret attachment surface, and may be smooth. On the fingerboard, a first fingerboard fret 33a may run perpendicularly to a centerline of the neck, under a plurality of strings. The first fingerboard fret may extend laterally across the fingerboard, and may be longitudinally spaced from a second fingerboard fret 33b, which may be consecutive to the first fingerboard fret. The fingerboard may be included by the neck.

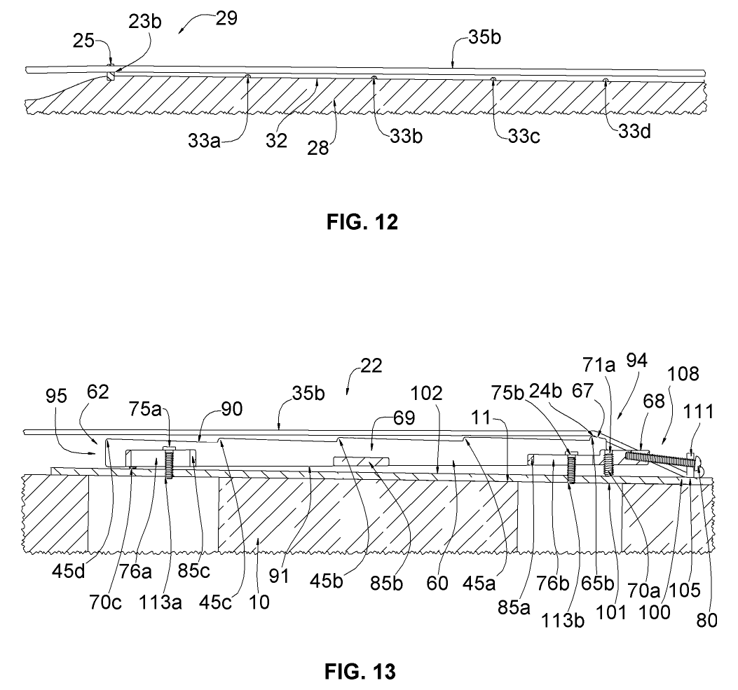

FIG. 7 illustrates an instrument 5 and an assembly 22. FIG. 12 illustrates a partial cross-sectional view of a forward end 29 of a neck 28. A sequence of fingerboard frets on the fingerboard 32 may include a first fingerboard fret 33a, a second fingerboard fret 33b, a third fingerboard fret 33c, a fourth fingerboard fret 33d, a fifth fingerboard fret, a sixth fingerboard fret, a seventh fingerboard fret, an eighth fingerboard fret, a ninth fingerboard fret, a tenth fingerboard fret, an eleventh fingerboard fret, a twelfth fingerboard fret 33e, a thirteenth fingerboard fret 33f, a fourteenth fingerboard fret, a fifteenth fingerboard fret, a sixteenth fingerboard fret, a seventeenth fingerboard fret, and an eighteenth fingerboard fret which may define fretted fingerboard notes a semitone, a whole step, a minor third, a major third, a perfect fourth, a tritone, a perfect fifth, a minor sixth, a major sixth, a minor seventh, a major seventh, an octave, an octave and a semitone, an octave and a whole step, an octave and a minor third, an octave and a major third, an octave and a perfect fourth, and an octave and a tritone above an open note of a string 35. Of the sequence of fingerboard frets, the first fingerboard fret 33a may be longitudinally foremost. In some embodiments, a fingerboard fret (which may be a rearmost fingerboard fret) at the rearward end of the fingerboard does not extend laterally all the way across the fingerboard. The number of fingerboard frets may vary, and may be fewer than 18, 18, 19, 20, 21, 22, 23,24, or more.

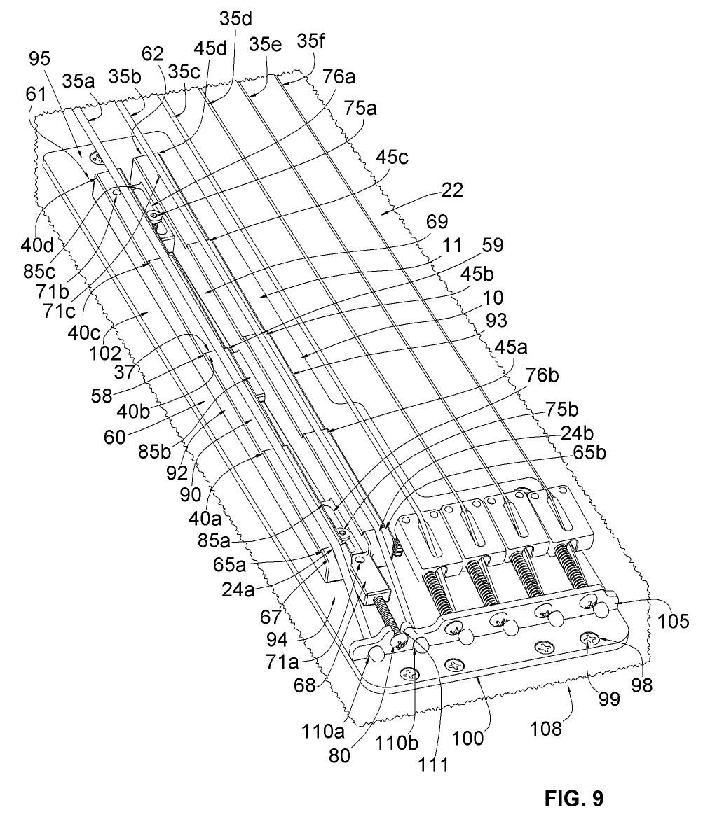

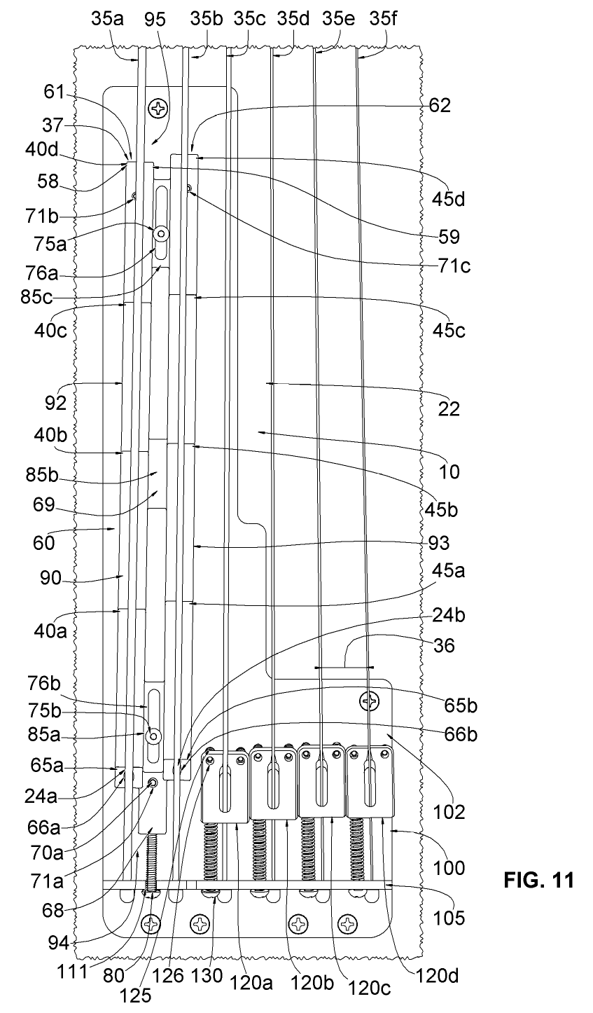

FIG. 7 illustrates an instrument 5 and an assembly 22. FIG. 9 illustrates an assembly 22 on a body 10. FIG. 11 illustrates an assembly 22 on a body 10. FIG. 12 illustrates a partial cross-sectional view of a forward end 29 of a neck 28. FIG. 13 illustrates a partial cross-sectional view of a body 10 and an assembly 22. A nut 25 may be coupled to a forward end 29 of a neck 28. A plurality of laterally spaced strings may attach at the forward end of the neck to tuning machines 27, which may tension the strings. The strings may contact the nut at a forward critical contact point 23, extend substantially longitudinally above a fingerboard 32 and fingerboard frets 33, contact an assembly 22 on the body 10, and attach at the body. The strings may consecutively include a proto string 35a, a deutero string 35b, a trito string 35c, a tetarto string 35d, a pempto string 35e, and a hecto string 35f. The proto string may be a laterally outermost proximal string. The hecto string may be a laterally outermost distal string. The strings may be closer together at the nut than at the assembly on the body. Two consecutive strings may be, relative to one another, a laterally proximal string and a laterally distal string. Two consecutive strings, at their rearward critical contact points 24, may be spaced, center to center, at a lateral string spacing 36. (As illustrated, a lateral string spacing is shown slightly forward of the actual location, for clarity.) In an additional or alternative embodiment, an instrument has more or fewer strings; for example, a tetarto string or a pempto string can be a laterally outermost distal string.

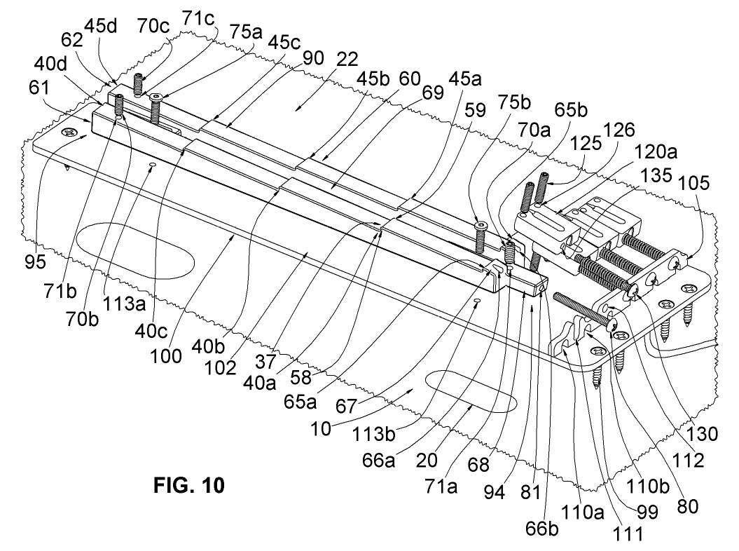

FIG. 7 illustrates an instrument 5 and an assembly 22. FIG. 9 illustrates an assembly 22 on a body 10. FIG. 10 illustrates a partial exploded view of an assembly 22 on a body 10. FIG. 11 illustrates an assembly 22 on a body 10. A proto string 35a may contact a nut 25 at a proto string forward critical contact point 23a where the proto string may be coupled by the nut to a forward end 29 of a neck 28. The proto string may extend above a fingerboard 32, fingerboard frets 33, an accessibility surface 34, a body 10, a pickup 200, and a proximal sequence of fretting crown segments (including a first proximal fretting crown segment 40a, a second proximal fretting crown segment 40b, a third proximal fretting crown segment 40c, and a fourth proximal fretting crown segment 40d) on a fretting saddling member 60. The proto string may contact a proximal saddling interface 65a on the fretting saddling member 60 at a proto string rearward critical contact point 24a, where the proto string may be coupled to the body by the fretting saddling member. The proto string may contact a proximal string guide indentation 66a in a clearance surface 67 of the fretting saddling member, and may insert through a rear wall 105 of a support 100 at a first stringing opening 110a. Stated in a different manner: A ball end of the proto string 35a may seat behind the rear wall 105. The proto string may insert through the first stringing opening 110a, may contact and be guided by the proximal string guide indentation 66a, and may be in contact with the proximal saddling interface 65a at the proto string rearward critical contact point 24a. The proto string may be directed by the proximal saddling interface at a wrist fretable vertical distance above the proximal sequence of fretting crown segments. The proto string may extend above the body 10, the pickup 200, the accessibility surface 34, and the sequence of fingerboard frets, to the nut 25.

Respective to a second stringing opening 110b, a first stringing opening may be a proximal stringing opening. Respective to the first stringing opening, the second stringing opening may be a distal stringing opening.

FIG. 7 illustrates an instrument 5 and an assembly 22. FIG. 9 illustrates an assembly 22 on a body 10. FIG. 10 illustrates a partial exploded view of an assembly 22 adjacent to a body 10. FIG. 11 illustrates an assembly 22 on a body 10. FIG. 12 illustrates a partial cross-sectional view of a forward end 29 of a neck 28. FIG. 13 illustrates a partial cross-sectional view of a body 10 and an assembly 22. A deutero string 35b may contact a nut 25 at a deutero string forward critical contact point 23b where the deutero string may be coupled by the nut to a forward end 29 of a neck 28. The deutero string may extend above a fingerboard 32, fingerboard frets 33, an accessibility surface 34, a body 10, a pickup 200, and a distal sequence of fretting crown segments (including a first distal fretting crown segment 45a, a second distal fretting crown segment 45b, a third distal fretting crown segment 45c, and a fourth distal fretting crown segment 45d) on a fretting saddling member 60. The deutero string may contact a distal saddling interface 65b on the fretting saddling member at a deutero string rearward critical contact point 24b, where the deutero string may be coupled to the body by the fretting saddling member. The deutero string may contact a distal string guide indentation 66b in a clearance surface 67 of the fretting saddling member, and may insert through a rear wall 105 of a support 100 at a second stringing opening 110b. Stated in a different manner: A ball end of the deutero string 35b may seat behind the rear wall 105. The deutero string may insert through the second stringing opening 110b, may contact and be guided by the distal string guide indentation 66b, and may be in contact with the distal saddling interface 65b at the deutero string rearward critical contact point 24b. The deutero string may be directed by the distal saddling interface at a wrist fretable vertical distance above the distal sequence of fretting crown segments. The deutero string may extend above the body 10, the pickup 200, the accessibility surface 34, and the sequence of fingerboard frets, to the nut 25.

In some embodiments, the clearance surface is discontinuous, with one portion for the proto string and one portion for the deutero string.

A sequence of fretting crown segments may include one, two, three, four, or more fretting crown segments. Of a sequence of fretting crown segments, a foremost fretting crown segment may be nearest to a forward member end 95.

FIG. 7 illustrates an instrument 5 and an assembly 22. FIG. 9 illustrates an assembly 22 on a body 10. FIG. 10 illustrates a partial exploded view of an assembly 22 adjacent to a body 10. FIG. 11 illustrates an assembly 22 on a body 10. The trito string 35c, the tetarto string 35d, the pempto string 35e, and the hecto string 35f may contact a nut 25 at a trito string forward critical contact point, a tetarto string forward critical contact point, a pempto string forward critical contact point, and a hecto string forward critical contact point where those strings may be coupled by the nut to a forward end 29 of a neck 28. The trito, the tetarto, the pempto, and the hecto string may extend above: a fingerboard 32, fingerboard frets 33, an accessibility surface 34, a body 10, and a pickup 200. The trito, the tetarto, the pempto, and the hecto string may contact a trito string saddle 120a, a tetarto string saddle 120b, a pempto string saddle 120c, and a hecto string saddle 120d at a trito string rearward critical contact point, a tetarto string rearward critical contact point, a pempto string rearward critical contact point, and a hecto string rearward critical contact point where those strings may be coupled to the body by their respective saddles. The trito, the tetarto, the pempto, and the hecto string may insert through a rear wall 105 of a support 100 at a third, a fourth, a fifth, and a sixth stringing opening. Ball ends of the trito, the tetarto, the pempto, and the hecto strings may seat behind the rear wall.

There may be a small vertical distance between strings 35 and fingerboard frets 33. A forward critical contact point 23 of a string and a rearward critical contact point 24 of that string may establish the sounding length of the open note of that string. Two consecutive strings, at their rearward critical contact points, may be spaced, center to center, at a lateral string spacing 36.

A fingerboard fret 33, which defines a fretted fingerboard note, may be usable to establish a sounding length of a string 35 by stopping the string, and that sounding length of the string may be used to play the defined note. A string that may be fretted may be said to be at a “fretable” vertical distance above a playable fingerboard fret.

A fretting crown segment (for example, a proximal fretting crown segment 40 or a distal fretting crown segment 45) which defines a wrist fretable note may be usable to establish a sounding length of a respective string 35 by stopping the string, and that sounding length of the string may be used to play the defined note. A fretting crown segment, which defines a wrist fretable note, may be at a wrist fretable vertical distance under a string 35; the string may be at a wrist fretable vertical distance above the fretting crown. To define a wrist fretable note, a fretting crown may be adjusted in a position in which it is vertically high enough to be used for wrist fretting with a string and vertically low enough that the string may be used to play an open note.

In combination, FIGS. 7-11 and 13 illustrate the following: An assembly 22 may be positioned on a body 10. The assembly may include features involved in saddling function, support function, wrist fretting function, locking function, positional adjustment function, pickup function, pickguard function, string retaining function, and other functions. The assembly may include a support 100, a support screw 99, a saddle 120, an action screw 125, a saddle spring, an intonation screw 130, a fretting saddling member 60, a height screw 70, a fastener 75, a positioning screw 80, a ground wire, and/or other features. A part of an assembly, such as a fastener or a height screw, may insert into a body cavity 20.

FIG. 7 illustrates an instrument 5 and an assembly 22. FIG. 9 illustrates an assembly 22 on a body 10. FIG. 10 illustrates a partial exploded view of an assembly 22 adjacent to a body 10. FIG. 11 illustrates an assembly 22 on a body 10. FIG. 13 illustrates a partial cross-sectional view of a body 10 and an assembly 22. A support 100 may be positioned on and coupled to a body 10. The support may include a lower support surface 101 contacting the top 11 of the body, and an upper support surface 102. Support screws 99 may insert downward into support screw holes 98 in the support and may couple the support to the body. At a rearward support end 108, there may be located a rear wall 105, which may run laterally across the upper support surface, and which may extend upward from the upper support surface. The rearward support end may extend rearward of the rear wall to provide space for support screws and support screw holes to couple the support to the body. The rear wall may include six laterally spaced stringing openings 110, which may laterally position strings 35. In the rear wall, near its laterally proximal end, and laterally between a first stringing opening 110a and a second stringing opening 110b, may be a vertically running positioning slot 111 for longitudinally positioning a fretting saddling member 60. The positioning slot may be open at its upper end. Intonation openings 112 for intonation screws for trito, tetarto, pempto, and hecto string saddles may be next to the third, fourth, fifth, and sixth stringing openings. The rear wall, with its stringing openings, may act as a string retainer for ball ends of the strings. The support may include steel sheet metal or another material for the upper support surface, the lower support surface, and for the rear wall. The upper support surface and lower support surface may be two sides of a flat piece of sheet metal, or another material, or may be shaped in another manner.

FIG. 7 illustrates an instrument 5 and an assembly 22. FIG. 10 illustrates a partial exploded view of an assembly 22 adjacent to a body 10. FIG. 11 illustrates an assembly 22 on a body 10. An assembly 22 may include a saddle 120, which may be coupled to and positioned on an upper support surface 102 forward of a rear wall 105, and distal to a fretting saddling member 60. The saddle may be coupled to and positioned on the support. The saddle may be coupled to and positioned on the body by the support. An intonation screw 130 may insert substantially longitudinally through an intonation opening 112 of a rear wall 105 into an intonation hole 135 in the saddle. The head of the intonation screw may seat behind the rear wall. The intonation opening may limit vertical and lateral movement of the intonation screw at the rear wall, laterally positioning the saddle with the intonation screw. The saddle may include two action holes 126 into which two action screws 125 may be inserted substantially vertically. An action screw may extend substantially vertically between the support and the saddle. The saddle, the action screws, and the intonation screw may tilt at an angle as the saddle’s vertical position is adjusted. A saddle spring may maintain the position of the saddle. A string 35 may insert into a stringing opening 110, may seat behind the rear wall, may be in contact with the saddle at a rearward critical contact point, and may be directed by the saddle above the body, a pickup, an accessibility surface 34, a fingerboard 32 and a sequence of fingerboard frets, to a nut 25. Turning the intonation screw may adjust a longitudinal position of the saddle and the rearward critical contact point of the string. Turning the action screws may adjust a vertical position of the saddle, and the vertical distance between the string and the fingerboard. An action screw may act as a height screw for a saddle. A saddle may be vertically positionable and longitudinally positionable independently of other saddles and of the fretting saddling member.

A saddle, and with it a rearward critical contact point of a string, may be longitudinally and vertically adjusted relative to the body, the support, a neck 28, the fingerboard, a sequence of fingerboard frets, and the nut.

In combination, FIGS. 7, 9-11, 13, and 14 illustrate the following: A fretting saddling member 60 may include an upper member surface 90 (which may be discontinuous), a downward member surface 91, a proximal lateral member side 92, a distal lateral member side 93, a rearward member end 94, a forward member end 95, a clearance surface 67 (which may be discontinuous), a proximal string guide indentation 66a, a distal string guide indentation 66b, a proximal saddling interface 65a, a distal saddling interface 65b, a proximal a sequence of fretting crown segments (including a first proximal fretting crown segment 40a, a second proximal fretting crown segment 40b, a third proximal fretting crown segment 40c, and a fourth proximal fretting crown segment 40d), a distal sequence of fretting crown segments (including a first distal fretting crown segment 45a, a second distal fretting crown segment 45b, a third distal fretting crown segment 45c, and a fourth distal fretting crown segment 45d), a positioning projection 68, and a central longitudinal recess 69. The proximal saddling interface and the proximal sequence of fretting crown segments may be oriented (spaced) along the line of the proto string 35a. The distal saddling interface and the distal sequence of fretting crown segments may be oriented (spaced) along the line of the line of the deutero string 35b. Because the strings may be closer at a nut 25 than at the assembly, a line established by the proximal saddling interface and the proximal sequence of fretting crown segments may slightly converge (toward the nut 25) with a line established by the distal saddling interface and the distal sequence of fretting crown segments. A lateral edge, including along the central longitudinal recess of the upper member surface, of the fretting saddling member may be beveled, rounded, or both. The fretting saddling member may be coupled to and positioned on a support 100, which may couple the fretting saddling member to and position the fretting saddling member on a body 10. The fretting saddling member may be positioned on the support, between an upper support surface 102 and the strings. A fastener 75 may adjustably couple the fretting saddling member to the support, and thus to the body. At the rearward member end (rearward of the saddling interfaces), the clearance surface, which may be discontinuous, may curve downward from the upper member surface, and may include the string guide indentations. The string guide indentations may be at a lower vertical level than the saddling interfaces. A rearmost contact point of a string may be on the clearance surface, rearward of its respective saddling interface and its rearward critical contact point 24. In additional or alternative embodiments, either the distal sequence of fretting crown segments or the proximal sequence of fretting crown segments is not present.

In combination, FIGS. 7, 9-11, 13, and 14 illustrate the following: A saddling interface 65 on a fretting saddling member 60 may include a string contactable area, which may establish a rearward critical contact point 24 of a string 35. The saddling interface may establish the position of the rearward critical contact point of the string vertically, longitudinally, and laterally, and may direct the string at a wrist fretable vertical distance above a respective sequence of fretting crown segments, a body 10, a pickup 200, and a sequence of fingerboard frets, to a nut 25. A proximal string guide indentation 66a may be longitudinally between a first stringing opening 110a and a proximal saddling interface 65a, may establish a lateral position of a proto string 35a, and may prevent lateral movement of the proto string. Proximal fretting crown segments 40 of a proximal sequence of fretting crown segments may be on an upper member surface 90 at longitudinally spaced distances, forward of the proximal saddling interface. A distal string guide indentation 66b may be longitudinally between a second stringing opening 110b and a distal saddling interface 65b, may establish a lateral position of a deutero string 35b, and may prevent lateral movement of the deutero string. Distal fretting crown segments 45 of a distal sequence of fretting crown segments may be on the upper member surface at longitudinally spaced distances forward of the distal saddling interface. A saddling interface and a respective sequence of fretting crown segments may define lines which are coplanar. Due to the presence of a central longitudinal recess 69 and/or other features, the upper member surface may be discontinuous; the upper member surface may include several areas which are not necessarily in a single plane.

In combination, FIGS. 7, 9-11, 13, and 14 illustrate the following: In an upper member surface 90 of a fretting saddling member 60, a central longitudinal recess 69 may run longitudinally on the centerline of the fretting saddling member, laterally between a proto string 35a and a proximal sequence of fretting crown segments (including a first proximal fretting crown segment 40a, a second proximal fretting crown segment 40b, a third proximal fretting crown segment 40c, and a fourth proximal fretting crown segment 40d), and a deutero string 35b and a distal sequence of fretting crown segments (including a first distal fretting crown segment 45a, a second distal fretting crown segment 45b, a third distal fretting crown segment 45c, and a fourth distal fretting crown segment 45d). The central longitudinal recess may be centered between a proximal lateral member side 92 and a distal lateral member side 93 of the fretting saddling member. The central longitudinal recess may divide the fretting saddling member into a longitudinally elongated proximal bar 61 and a longitudinally elongated distal bar 62, which may be respectively centered under the proto string and the deutero string, and which may gently converge toward a nut 25. (Although the term “recess” is used, the central longitudinal recess may be understood to extend partly or entirely vertically through the fretting saddling member, and may be discontinuous. The recess may be a gap, rout, divide, hole, cleft, rift, interstice, etc. between the two bars.) The proximal bar may include, in longitudinal order: a proximal string guide indentation 66a, a proximal saddling interface 65a, and the proximal sequence of fretting crown segments. The proximal string guide indentation and the proximal saddling interface may be laterally centered on the proximal bar. The proximal sequence of fretting crown segments may be centered under the proto string. The proximal bar may contact, may be centered under, and may be aligned with the proto string. The distal bar may include, in longitudinal order: a distal string guide indentation 66b, a distal saddling interface 65b, and the distal sequence of fretting crown segments. The distal string guide indentation and the distal saddling interface may be laterally centered on the distal bar. The distal sequence of fretting crown segments may be included by a distal sequence of one string fretting crowns on the distal bar centered under the deutero string. The distal bar may contact, may be centered under, and may be aligned with the deutero string. The proximal string guide indentation, the proximal saddling interface, and the proximal sequence of fretting crown segments may be laterally spaced from: the distal string guide indentation, the distal saddling interface, and the distal sequence of fretting crown segments.

A neck scale length may be understood to be a nominal sounding length of an open string from a saddle 120 to a nut 25; more specifically, from a rearward critical contact point 24 of the string on the saddle to a forward critical contact point 23 of the string on the nut. A nominal sounding length of a fretted fingerboard note may be calculated, based on a neck scale length, using the twelfth root of two. A nominal oddment length may be calculated by subtracting a nominal sounding length from the neck scale length. (On some stringed musical instruments, fingerboard frets may be formed or positioned with tolerances of less than 0.127 millimeters (mm); the following nominal lengths are calculated as an example.) A nominal semitone sounding length may be 94.3874% of a neck scale length. A nominal whole step sounding length may be 89.0899% of a neck scale length. A nominal minor third sounding length may be 84.0896% of a neck scale length. A nominal major third sounding length may be 79.3701% of a neck scale length. A nominal perfect fourth sounding length may be 74.9154% of a neck scale length. A nominal semitone oddment length may be 5.6126% of a neck scale length. A nominal whole step oddment length may be 10.9101% of a neck scale length. A nominal minor third oddment length may be 15.9104% of a neck scale length. A nominal major third oddment length may be 20.6299% of a neck scale length. A nominal perfect fourth oddment length may be 25.0846% of a neck scale length. A nominal octave oddment length may be 50.0000% of a neck scale length.

A player may play fretted fingerboard notes with the fretting hand 350. To play a fretted fingerboard note, the player may depress a string 35 against a fingerboard fret 33 with a finger of the fretting hand, stopping the string with the fingerboard fret, and shortening the sounding length of the string. The shortened sounding length of the string, between the fingerboard fret and a rearward critical contact point 24, may be plucked with the picking hand. A sequence of fingerboard frets may have a chromatic spacing. A first fingerboard fret 33a may be positioned to define fretted fingerboard notes a semitone above open notes of open strings. For a string, the sequence of fingerboard frets may define a sequence of successive semitones above a fundamental pitch of that string. The fingerboard frets may be longitudinally spaced based on a neck scale length.

A fingerboard fret 33 intended to produce a fretted fingerboard note of a specific interval above open notes of open strings may be positioned at a nominal oddment length, respective to that interval, from a nut 25. More specifically, that fingerboard fret may be positioned at the nominal oddment length from the expected positions of the forward critical contact points 23 of the strings on the nut. For example, a twelfth fingerboard fret 33e may be positioned at a nominal octave oddment length from a nut; a neck scale length may be twice the distance from the twelfth fingerboard fret to the nut. In an additional or alternative embodiment, a method of adjusting a position of a nut or a position of a forward critical contact point of a string on the nut, away from a nominal position suggested by a neck scale length, such as the use of a compensated nut, may be used.

In combination, FIGS. 7, 9-11, 13, and 14 illustrate the following: On a fretting saddling member 60, a proximal sequence of fretting crown segments may include a first proximal fretting crown segment 40a, a second proximal fretting crown segment 40b, a third proximal fretting crown segment 40c, and a fourth proximal fretting crown segment 40d. A distal sequence of fretting crown segments may include a first distal fretting crown segment 45a, a second distal fretting crown segment 45b, a third distal fretting crown segment 45c, and a fourth distal fretting crown segment 45d. A one string fretting crown 37, including a proximal lateral end 58, a distal lateral end 59, and a fretting crown segment, may be integrated with or attached to the fretting saddling member. A first, a second, a third, and a fourth proximal fretting crown segments may be respectively included by a first, a second, a third, and a fourth proximal one string fretting crown. A first, a second, a third, and a fourth distal fretting crown segments may be respectively included by a first, a second, a third, and a fourth distal one string fretting crown.

In combination, FIGS. 7, 9-11, 13, and 14 illustrate the following: A fretting saddling member 60 may be positionable on an instrument 5 such that a proto string 35a and a deutero string 35b contact a proximal saddling interface 65a and a distal saddling interface 65b of the fretting saddling member at respective rearward critical contact points 24. A proximal sequence of fretting crown segments (including a first proximal fretting crown segment 40a, a second proximal fretting crown segment 40b, a third proximal fretting crown segment 40c, and a fourth proximal fretting crown segment 40d) may be on the fretting saddling member, under the proto string, and between a neck 28 and the proximal saddling interface. A distal sequence of fretting crown segments (including a first distal fretting crown segment 45a, a second distal fretting crown segment 45b, a third distal fretting crown segment 45c, and a fourth distal fretting crown segment 45d) may be on the fretting saddling member, under the deutero string, and between the neck and the distal saddling interface. Each sequence of fretting crown segments may be positioned on the fretting saddling member in a wrist fretting direction of use, and may be usable to shorten the sounding length of its respective string opposite the direction of use of the fingerboard frets. Each fretting crown segment may include a string contactable area, which may be used to stop its respective string. A sequence of fretting crown segments may define a chromatic sequence of wrist fretable notes (a sequence of successive semitones) above an open note of a respective string.

The string contactable area on a fingerboard fret 33, a fretting crown segment, or a saddling interface 65 may face upward toward a string 35. Each fretting crown segment in a sequence of fretting crown segments and a respective saddling interface (including the rearward critical contact point 24 of the string) may be positioned on a fretting saddling member 60 such that an object with a planar surface, such as a file, may contact all simultaneously.

In combination, FIGS. 7, 9-11, 13, and 14 illustrate the following: Respective to a proto string 35a, in longitudinal order, a fretting saddling member 60 may include a proximal string guide indentation 66a, a proximal saddling interface 65a, and a proximal sequence of fretting crown segments, which may include a first proximal fretting crown segment 40a, a second proximal fretting crown segment 40b, a third proximal fretting crown segment 40c, and a fourth proximal fretting crown segment 40d, which may define wrist fretable notes a semitone, a whole step, a minor third, and a major third above the open note of the proto string. Respective to a deutero string 35b, in longitudinal order, a fretting saddling member may include a distal string guide indentation 66b, a distal saddling interface 65b, and a distal sequence of fretting crown segments, which may include a first distal fretting crown segment 45a, a second distal fretting crown segment 45b, a third distal fretting crown segment 45c, and a fourth distal fretting crown segment 45d, which may define wrist fretable notes a semitone, a whole step, a minor third, and a major third above the open note of the deutero string.

As illustrated in FIG. 7, a fingerboard includes an accessibility surface 34. The accessibility surface 34 may be at a rearward end 30 of a neck 28, and may be at a lower vertical level than a fret attachment surface 31 of a fingerboard 32. The accessibility surface may be part of the fingerboard. The accessibility surface may provide space for a player’s fingers and thumb when the player is wrist fretting. When wrist fretting, the thumb and fingers may be above the neck or the fingerboard. Contact with the fingerboard and the fingerboard frets by the picking hand fingers and thumb may make plucking strings difficult for some players; this may depend on hand size and finger length. The accessibility surface may be at a greater vertical distance from the strings 35 than the fret attachment surface. The accessibility surface may be smooth, and may be flat or gently curved. The accessibility surface may prevent the thumb and fingers of the picking hand from colliding with the fingerboard or fingerboard frets. The accessibility surface may begin rearward of the fingerboard frets, and may be between the fingerboard frets and an assembly 22 on a body 10. In some embodiments, a rearmost fingerboard fret may extend only part of the way across the neck; a proximal end of this fret may be laterally distal to an outermost proximal string; a portion of the accessibility surface may be laterally proximal to this fingerboard fret. An accessibility surface may be omitted. An accessibility surface may be part of the fingerboard and/or the neck.

As illustrated in FIGS. 7 and 12, a nut 25 is coupled to a neck 28. A nut 25 may be understood to be a feature establishing a forward critical contact point 23 of a string 35. A nut may include one or more components. A nut may include a feature of a Martin or Fender style nut, a compensated nut, a headless headpiece, a locking nut, a roller nut, a combination of a string guide and a “zero fret,” or a nut of another variety.

In some embodiments, an instrument 5 includes a fretting saddling member 60 positioned in conjunction with a proto string 35a and a deutero string 35b. However, a fretting saddling member for two strings may be positioned in conjunction with any two strings on an instrument. A string which is configured for wrist fretting may be understood to be a wrist fretting string. An instrument 5 may include a wrist fretting string and a single direction fretting string. A single direction fretting string may be distal to a distal lateral end 59 of each fretting crown included by an assembly 22. A single direction fretting string may be used to play open notes or fretted fingerboard notes while accompaniment is played on a wrist fretting string. For some players, an instrument including a combination of one or more proximal wrist fretting strings and one or more distal single direction fretting strings may be easy to learn, comfortable to play, and useful for producing wrist fretted low notes in the lowest octave of the instrument. It is possible for an instrument to have a fretting saddling member positioned with two strings other than a proto string and a deutero string.

In combination, FIGS. 7, 9, and 11 illustrate the following: An instrument 5 has a fretting saddling member 60 and strings. A plurality of consecutive strings may be as follows: A proto string 35a, which may be a laterally outermost proximal string, and a deutero string 35b, are wrist fretting strings. A trito string 35c, a tetarto string 35d, a pempto string 35e, and a hecto string 35f, may be single direction fretting strings.

As illustrated in FIG. 7, an assembly 22 includes a pickup 200. The pickup 200 may be mounted under strings 35, forward of a fretting saddling member 60, and rearward of the fingerboard frets 33. Strings may be grounded with a ground wire. The pickup may be vertically adjustable. When a string is wrist fretted and plucked, a rearward longitudinal end of a sounding length of the string may be nearer to the pickup than when the open string is plucked. This may produce a brightening of the sound that some players may enjoy; this effect may get stronger as the pickup is mounted nearer to the fretting crown segment (for example, a proximal fretting crown segment 40). If a pickup is mounted nearer to the fingerboard 32, the tone brightening effect may be less noticeable; this may produce a mellower tone that some players may enjoy. In additional or alternative embodiments, to take advantage of both sounds, a first pickup is mounted nearer to the fretting saddling member, and a second pickup is mounted nearer to a neck 28. In alternative or additional embodiments, an additional pickup is added. In additional or alternative embodiments, a pickup is omitted. In additional or alternative embodiments, a pickup is mounted in a different position.

In combination, FIGS. 9, 10, 11, 13, and 14 illustrate the following: A fretting saddling member 60 may include a positioning projection 68. The positioning projection, at a rearward member end 94, may include a positioning hole 81. The positioning projection may extend rearward from the rearward crosspiece at the rearward member end, and may be laterally centered between the line of the proto string 35a and the line of the deutero string 35b, on the centerline of a fretting saddling member 60. A positioning screw 80 may insert through a positioning slot 111 in a rear wall 105 of a support 100, and may insert into the positioning hole. A positioning screw and a positioning hole may be threaded.

In additional or alternative embodiments, the positioning projection, the positioning screw, and the positioning slot are omitted.

In some embodiments, a longitudinal position and a vertical position of a fretting saddling member 60 are adjustable when its respective fasteners 75 are in a non locking configuration. A forward member end 95 may be adjusted up and down. A rearward member end 94 may be adjusted up and down. The fretting saddling member may be longitudinally movable along a line that is centered between its respective strings 35, and that is substantially parallel with both strings. An assembly 22 may allow a user to adjust the angle of between the distal sequence of fretting crown segments (if present) and its respective string which has that string’s rearward critical contact point as its vertex, the angle of between the proximal sequence of fretting crown segments (if present) and its respective string which has that string’s rearward critical contact point as its vertex, and the angle of the fretting saddling member around an axis along its centerline. The position of the fretting saddling member may be adjusted relative to a support 100, a body 10, a nut 25, a fingerboard 32, and a sequence of fingerboard frets. Spatial relationships of features of the fretting saddling member relative to one another may be preserved throughout adjustment. For example, saddling interfaces and fretting crowns may remain in fixed positions on the fretting saddling member relative to one another. A fretting saddling member may include a proximal saddling interface 65a (on which is a rearward critical contact point of a respective string), a distal saddling interface 65b, (on which is a rearward critical contact point of a respective string), and one or more proximal fretting crown segments 40 and/or one or more distal fretting crown segments 45; relative positions of these features to one another may be unchanged after repositioning of the fretting saddling member.

In additional or alternative embodiments, a shim adjusts a vertical position of the forward member end 95, a vertical position of the rearward member end 94, or both.

In an assembly, moving a fretting saddling member forward or rearward may shorten or lengthen the sounding length of an open note of the respective string, the sounding lengths of fretted fingerboard notes, and the sounding lengths of wrist fretable notes.

During an adjustment of the longitudinal position and vertical position of a fretting saddling member 60, a proximal bar 61 (and a proximal sequence of one string fretting crowns) may remain substantially centered under the proto string 35a, and a distal bar 62 (and a distal sequence of one string fretting crowns) may remain substantially centered under the deutero string 35b.

In combination, FIGS. 9, 10, 11, 13, and 14 illustrate the following: A fretting saddling member 60 may include a positioning projection 68. A positioning screw 80 may be used to adjust a longitudinal position of the fretting saddling member. A positioning slot 111 may run vertically in a rear wall 105. A positioning projection 68 may extend rearward at a rearward member end 94, and may be centered between a proto string 35a and a deutero string 35b. The positioning screw and the positioning slot may be aligned with the centerline of the fretting saddling member and centered between the line of the proto string and the line of the deutero string. The positioning screw may insert through the positioning slot from behind the rear wall and into the positioning hole. The head of the positioning screw may seat against the rear wall. The tension on the two strings may push forward and downward on the fretting saddling member at the saddling interfaces 65 and clearance surfaces 67. The strings may hold the fretting saddling member in place against height screws 70 and a support 100. The strings may pull the head of the positioning screw against the rear wall, preventing forward movement of the fretting saddling member. By turning the positioning screw, the fretting saddling member may be moved forward toward a nut 25 or rearward away from the nut; this may allow the user to equally adjust the longitudinal positions of the saddling interfaces, the rearward critical contact points 24 of the two strings 35, and the sequences of fretting crown segments. During an adjustment of the vertical position of the fretting saddling member, the positioning screw may slide up or down in the positioning slot. The positioning slot and positioning screw, in cooperation with a fastener, may center the fretting saddling member between the proto string and the deutero string, and may align the fretting saddling member with the proto string and the deutero string. The positioning screw may adjust the fretting saddling member’s longitudinal position along a line centered between the proto string and the deutero string.

In additional or alternative embodiments, a longitudinal positioning screw head and a positioning hole in the fretting saddling member may be angled downward such that the head of the longitudinal positioning screw is pointed toward the body.

As illustrated in FIGS. 9-11 and 14, a fretting saddling member 60 includes a proximal forward height adjustment hole 71b. The proximal forward height adjustment hole may be located in the fretting saddling member, near a proximal portion of a forward member end 95, under and partly proximal to a proto string 35a. The proximal forward height adjustment hole may be longitudinally rearward of a fourth proximal fretting crown segment 40d in the proximal sequence of fretting crown segments. The proximal forward height screw 70b may insert substantially vertically into the proximal forward height adjustment hole and contact an upper support surface 102 of a support 100 under the proximal forward height adjustment hole. The proximal forward height screw may tilt as the fretting saddling member tilts. As the fretting saddling member is longitudinally repositioned, the proximal forward height screw may also be longitudinally repositioned, and may slide along the upper support surface, while supporting the fretting saddling member in a range of vertical positions. When a rearward height screw 70a or a distal forward height screw 70c is raised or lowered, the fretting saddling member may pivot on the proximal forward height screw, which may pivot against the support. In additional or alternative embodiments, the proximal forward height adjustment hole is farther forward or rearward. In some embodiments, a fretting saddling member is pivotally mounted on height screws.

A proximal forward height screw 70b and a distal forward height screw 70c may adjust a vertical position of a proximal lateral end of a fretting crown (on a fretting saddling member 60) relative to a vertical position of a distal lateral end of the fretting crown.

In combination, FIGS. 9-11 and 14 illustrate the following: A proximal forward height adjustment hole 71b is located in a proximal bar 61 of a fretting saddling member 60.

In combination, FIGS. 9-11, 13, and 14 illustrate the following: A fretting saddling member 60 includes a distal forward height adjustment hole 71c. The distal forward height adjustment hole may be located in the fretting saddling member near a distal portion of a forward member end 95, under and partly distal to a deutero string 35b. The distal forward height adjustment hole may be slightly longitudinally rearward of a foremost fretting crown segment of a distal sequence of fretting crown segments. A distal forward height screw 70c may insert substantially vertically into the distal forward height adjustment hole and contact an upper support surface 102 of a support 100 under the distal forward height adjustment hole. The distal forward height screw may tilt as the fretting saddling member tilts. As the fretting saddling member is longitudinally repositioned, the distal forward height screw may also be longitudinally repositioned, and may slide along the upper support surface, while supporting the fretting saddling member in a range of vertical positions. When a rearward height screw 70a or a proximal forward height screw 70b is raised or lowered, the fretting saddling member may pivot on the distal forward height screw, which may pivot against the support.

In additional or alternative embodiments, the distal forward height adjustment hole is farther forward or rearward.

In combination, FIGS. 9-11, 13, and 14 illustrate the following: A distal forward height adjustment hole 71c may be located in a distal bar 62 of the fretting saddling member 60.

In combination, FIGS. 9-11, 13, and 14 illustrate the following: A fretting saddling member 60 includes a rearward height adjustment hole 71a. The rearward height adjustment hole may be located in a rearward member end 94 of the fretting saddling member and may be on a centerline of the fretting saddling member near the rearmost contact points of a proto string 35a and a deutero string 35b. A rearward height screw 70a may insert substantially vertically into the rearward height adjustment hole and contact an upper support surface 102 of a support 100 under the rearward height adjustment hole. The rearward height screw may tilt with the fretting saddling member. As the fretting saddling member is longitudinally repositioned, the rearward height screw may also be longitudinally repositioned, and may slide along the support while supporting the fretting saddling member in a range of vertical positions. When a forward height screw is raised or lowered, the fretting saddling member may pivot on the rearward height screw, which may pivot against the support.

In combination, FIGS. 9-11, 13, and 14 illustrate the following: A rearward height adjustment hole 71a may be in a positioning projection 68.

In additional or alternative embodiments, the rearward height adjustment hole is farther forward or rearward. A rearward height adjustment hole may be in front of, longitudinally even with, or to the rear of saddling interfaces. In some embodiments, a rearward height screw is positioned rearward of the last rearward contact points of the strings on the fretting saddling member.

With its respective fasteners 75 in a non locking configuration, the position of a fretting saddling member 60 may be adjustable. A proximal forward height screw 70b, a distal forward height screw 70c, and a rearward height screw 70a may: i) adjust the height of a proto string 35a above a fingerboard 32 and fingerboard frets 33, ii) adjust the height of a deutero string 35b above a fingerboard and fingerboard frets, iii) adjust the vertical distance between a proximal sequence of fretting crown segments (which may include a first proximal fretting crown segment 40a, a second proximal fretting crown segment 40b, a third proximal fretting crown segment 40c, and a fourth proximal fretting crown segment 40d) and the proto string, iv) adjust the vertical distance between a distal sequence of fretting crown segments (which may include a first distal fretting crown segment 45a, a second distal fretting crown segment 45b, a third distal fretting crown segment 45c, and a fourth distal fretting crown segment 45d) and the deutero string v) adjust the angle between the proximal sequence of fretting crown segments and the proto string, which has a vertex at a proto string rearward critical contact point 24a, and vi) adjust the angle between the distal sequence of fretting segments and the deutero string, which has a vertex at a deutero string rearward critical contact point 24b.

A proximal forward height screw 70b and a distal forward height screw 70c may adjust the vertical position of a forward member end 95 relative to a support 100, a body 10, and two respective strings 35. The proximal forward height screw may adjust the vertical position of a proximal portion of the forward member end relative to the support, the body, and the respective strings. The proximal forward height screw may adjust the vertical distance between a proximal sequence of fretting crown segments (which may include a first proximal fretting crown segment 40a, a second proximal fretting crown segment 40b, a third proximal fretting crown segment 40c, and a fourth proximal fretting crown segment 40d) and a proto string 35a. The proximal forward height screw may adjust the angle between the proximal sequence of fretting crown segments and the proto string, which has a vertex at a proto string rearward critical contact point 24a. A distal forward height screw 70c may adjust the vertical position of a distal portion of the forward member end relative to the support, the body, and the respective strings. The distal forward height screw may adjust the vertical distance between a distal sequence of fretting crown segments (which may include a first distal fretting crown segment 45a, a second distal fretting crown segment 45b, a third distal fretting crown segment 45c, and a fourth distal fretting crown segment 45d) and a deutero string 35b. The distal forward height screw may adjust the angle between the distal sequence of fretting segments and the deutero string, which has a vertex at a deutero string rearward critical contact point 24b. In additional or alternative embodiments, a proximal or a distal sequence of fretting crown segments is omitted; height adjustment function is otherwise similar.

The forward height screws 70 may adjust the angular position of a fretting saddling member around a substantially longitudinal axis. This may adjust the vertical positions of i) the proximal saddling interface 65a relative to the distal saddling interface 65b, ii) the proto string rearward critical contact point 24a relative to the deutero string rearward critical contact point 24b, and iii) the proximal sequence of fretting crown segments relative to the distal sequence of fretting crown segments. This rotational adjustment may be used to adjust the proto string 35a and the deutero string 35b to be at the same vertical distance from the fingerboard 32 (or in another configuration). This rotational adjustment may be used to adjust the proto string and the deutero string to be respectively at the same vertical distance from a proximal fretting crown segment 40 and a distal fretting crown segment 45 with the same ordinal number (or in another configuration). This rotational adjustment may be used to bring fingerboard matching angles 56 of fretting crowns and saddling interfaces into position relative to a fingerboard. Fingerboard matching angles are described in further detail below.

A rearward height screw 70a may adjust the vertical position of the rearward member end 94 (including saddling interfaces 65 and rearward critical contact points 24 of the two respective strings) relative to a support 100, a body 10, a neck 28, a fingerboard 32, and fingerboard frets 33. The rearward height screw may adjust the vertical position of a proximal saddling interface 65a (and thus the proto string rearward critical contact point 24a) and the vertical position of a distal saddling interface 65b (and thus the deutero string rearward critical contact point 24b) substantially equally. The rearward height screw may adjust the angles between the two sequences of fretting crowns and their respective strings, which have the rearward critical contact points of those strings as vertices.

The forward height screws 70 and the rearward height screw 70a may adjust a vertical position of a forward member end 95 relative to a vertical position of a rearward member end 94.

A height screw 70 may adjust a vertical position of a fretting saddling member 60. A height screw may extend vertically between a fretting saddling member and a support 100; thus, the height screw may extend between the fretting saddling member and a body 10. A height adjustment hole 71 may be spaced from a longitudinal slot or a fastening opening 113 such that a height screw does not fall into the longitudinal slot or collide with a fastener 75. A proximal forward height adjustment hole 71b and/or a distal forward height adjustment hole 71c may be longitudinally spaced from a rearward height adjustment hole 71a. The proximal forward height adjustment hole may be laterally spaced from the distal forward height adjustment hole. Three height screws may tripodally (i.e., the three height screws support the fretting saddling member at three spaced points forming a triangle) support a fretting saddling member in a range of vertical positions, including during a sliding longitudinal position adjustment. Each height screw may pivot the fretting saddling member on the other two height screws. A height screw may be threaded and a height adjustment hole may be threaded. A height screw may be adjusted by turning it to adjust the fretting saddling member up and down. A height screw may be adjusted when a fastener 75 or fasteners are in a non locking configuration. A height screw may cooperate with a fastener in locking a position of a fretting saddling member. A fastener, in a locking configuration, may apply force to a height screw through a support and a fretting saddling member.

In some embodiments, a height adjustment hole 71 is in a fretting saddling member 60; a fastener may lock an end of the height screw 70 against a support 100. The fastener may lock multiple height screws associated with the fretting saddling member to the support, and may lock the position of the fretting saddling member by doing so. The fastener may lock the fretting saddling member to the support by locking the height screws against the support. In some embodiments, the height adjustment hole is tapped into the material of the fretting saddling member. In some embodiments, the height screw in the height adjustment hole in the fretting saddling member is adjustable from above. With height adjustment holes in a fretting saddling member, a fastener may lock the fretting saddling member to a body 10 by locking the height screws against the support.

In combination, FIGS. 9-11, 13, and 14 illustrate the following: A fretting saddling member 60 may include a member fastening slot 76. The member fastening slot 76 may be a longitudinal through slot. The member fastening slot may be centered between the lateral member sides of the fretting saddling member, centered between a proto string 35a and a deutero string 35b, and centered between a proximal sequence of one string fretting crowns and a distal sequence of one string fretting crowns. The member fastening slot may run along the centerline of the fretting saddling member. A fastener 75 may be inserted downward through the member fastening slot into a fastening opening 113 in an upper support surface 102 of a support 100 under the member fastening slot. The fastening opening in the support may be centered between the proto string and the deutero string. The head of the fastener may seat in a central longitudinal recess 69. The member fastening slot may include a proximal guide surface and a distal guide surface, which may contact the fastener. The fastener may remain stationary while the fretting saddling member is longitudinally or vertically repositioned. The guide surfaces of the member fastening slot may slide against the fastener during adjustment of the position of the fretting saddling member. The fastener may fit snugly in the member fastening slot. The proximal guide surface and the distal guide surface may establish a lateral position of the fretting saddling member and prevent lateral movement while allowing longitudinal and vertical adjustment.

In combination, FIGS. 9-11, 13, and 14 illustrate the following: A support 100 may include a forward fastening opening 113a and a rearward fastening opening 113b, which may be longitudinally spaced from one another and centered between a proto string 35a and a deutero string 35b. A fretting saddling member 60 may include a forward member fastening slot 76a and a rearward member fastening slot 76b, which may be longitudinally spaced from one another. A forward fastener 75a may insert through the forward member fastening slot into the forward fastening opening. A rearward fastener 75b may insert through the rearward member fastening slot into the rearward fastening opening. The fastening openings and the fasteners may center the member fastening slots and the fretting saddling member between the proto string and a deutero string, and may align the fretting saddling member with the proto string and the deutero string. A proximal sequence of one string fretting crowns on a proximal bar 61 may be centered under and aligned with the proto string, and a distal sequence of one string fretting crowns on a distal bar 62 may be centered under and aligned with the deutero string by the fasteners and the fastening openings. The fasteners and the fastening openings may align a proximal saddling interface 65a with a first stringing opening 110a and with the nut. The fasteners and the fastening openings may align a distal saddling interface 65b with a second stringing opening 110b and with the nut.

In additional or alternative embodiments, a member fastening slot and a respective fastening opening may be farther forward or rearward.

A forward fastener 75a and a rearward fastener 75b may center a fretting saddling member 60 laterally between, and align the fretting saddling member with, a proto string 35a and a deutero string 35b. A forward fastener and a rearward fastener may establish a line of longitudinal adjustment centered between the proto string and the deutero string. Each fastener may independently lock the longitudinal position, the vertical position, the lateral position, and the angular position of the fretting saddling member without the use of the other. A forward member fastening slot 76a, a forward fastening opening 113a, and a forward fastener 75a may be relatively nearer to a forward member end 95; a rearward member fastening slot 76b, a rearward fastening opening 113b, and a rearward fastener may be relatively nearer to a rearward member end 94 . The forward fastening slot, the forward fastening opening, the forward fastener, the rearward fastening slot, the rearward fastening opening, and the rearward fastener may be inside a triangle defined by a proximal forward height adjustment hole 71b and distal forward height adjustment hole 71c, and a rearward height adjustment hole 71a. A fastening slot, a fastening opening, and a fastener may be farther longitudinally rearward than the forward height adjustment holes and forward height screws, and farther longitudinally forward than the rearward height adjustment hole and a rearward height screw.

In some embodiments, a member fastening slot is in the central longitudinal recess and/or is a portion of a central longitudinal recess 69. The head of a fastener in the central longitudinal recess may sit below the vertical level of the fretting crowns. A forward member fastening slot 76a and/or a rearward member fastening slot 76b may be in a crosspiece, which may be in the central longitudinal recess.

An assembly 22 may include a fastening means, which may include a fastener 75. The fastener may couple a fretting saddling member 60 to a support 100, coupling the fretting saddling member to a body 10. The fretting saddling member may be detached from the support and the body 10 by removal of the fastener. The fastener may have a non locking configuration and a locking configuration. With the fastener in the non locking configuration, a longitudinal position, a vertical position, and an angular position of the fretting saddling member (which may include a forward member end 95, a rearward member end 94, a proximal fretting crown segment 40, a distal fretting crown segment 45, and saddling interfaces 65 on which may be rearward critical contact points 24 of respective strings 35) may be adjustable relative to the support, the body, a neck 28, a fingerboard 32, and a nut 25. In a locking configuration, the fastener locks the longitudinal position, the vertical position, and the angular position of the fretting saddling member and its respective features.

With the fastener 75 in a non locking configuration, a fretting saddling member 60 may be vertically adjusted, longitudinally adjusted, and rotated around an axis centered between the proto string 35a and the deutero string 35b. Fasteners may be locked and unlocked by turning them. Wrist fretting may be performed with a fastener firmly locking the fretting saddling member in place on the support 100.

In combination, FIGS. 9-11, 13, and 14 illustrate the following: Several crosspieces 85 may connect a proximal bar 61 and a distal bar 62, traversing a central longitudinal recess 69. An upper surface of a crosspiece may be below the sequences of fretting crowns. A rearward crosspiece 85a, at a rearward member end 94, may connect the proximal bar with the distal bar laterally between a proximal saddling interface 65a and a distal saddling interface 65b, and laterally between a proximal string guide indentation 66a and a distal string guide indentation 66b. A positioning projection 68 may connect to the rearward crosspiece. A middle crosspiece 85b may connect the proximal bar with the distal bar longitudinally near the second fretting crown segment of the sequence of fretting crown segments. A forward crosspiece 85c at a forward member end 95 may connect the proximal bar with the distal bar near the longitudinally foremost of the fretting crown segments on the fretting saddling member.

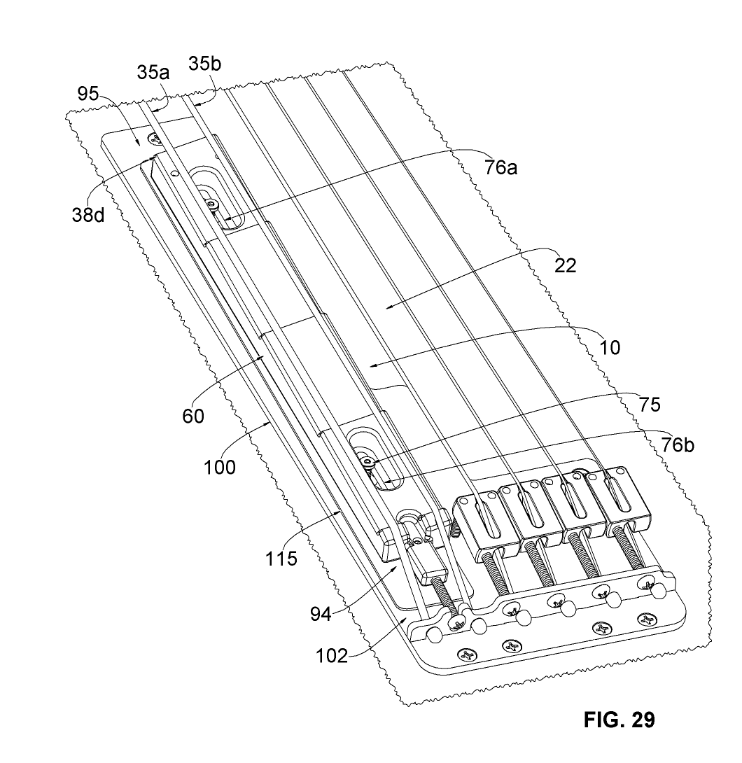

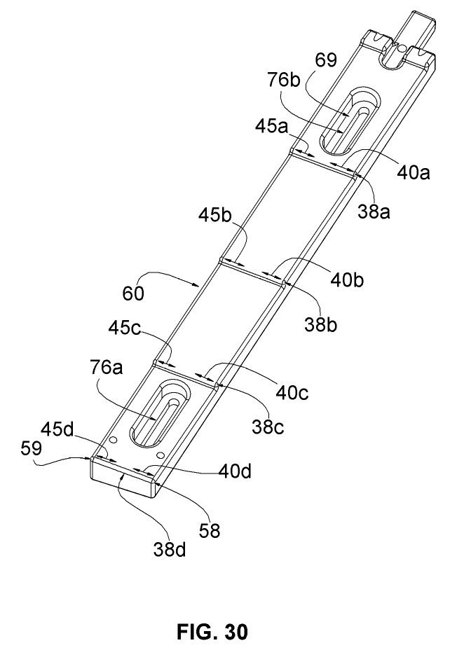

The number and location of crosspieces may vary. A member fastening slot 76 may be in a crosspiece. If no central longitudinal recess is present, the lateral center of the fretting saddling member may be mostly continuous, as in FIGS. 29 and 30.

Several factors affect the pitch of a fretted fingerboard note during a fretting action at a fingerboard fret 33. A few examples are: i) the force required to fret the string 35 due to the height of the string above the fingerboard 32, and ii) the thickness and material of the string. If a rearward critical contact point of a string 24 were positioned exactly as suggested by a neck scale length, fingerboard frets might produce sharp and out of tune pitches. To correct this, the rearward critical contact point of the string may be moved rearward, away from the nut 25, increasing the sounding lengths of the string’s open note and the string’s fretted fingerboard notes. Adjusting the rearward critical contact point of a string into an intonated position may intonate (fine tune) the fretted fingerboard notes of the string relative to its open note.

A string 35 may contact a saddle 120 at a rearward critical contact point. To correct sharp fretted fingerboard notes, the saddle may be moved rearward. To correct flat fretted fingerboard notes, the saddle may be moved forward. A longitudinally adjustable saddle may position a rearward critical contact point of a string at a distance less than, equal to, or greater than a neck scale length from a forward critical contact point of that string on a nut. In additional or alternative embodiments, the rearward critical contact points of one or more strings are positioned in intonated positions by a shaped and/or angled saddle.

On a fretting saddling member, a proximal saddling interface 65a may be positioned relative to a distal saddling interface 65b such that adjusting the position of the fretting saddling member to position one saddling interface to intonate the fretted fingerboard notes of its string intonates the fretted fingerboard notes of the other string. On a fretting saddling member 60, the proximal saddling interface 65a (and its associated rearward critical contact point) may be positioned i) farther rearward than, ii) longitudinally the same as, or iii) farther forward than the distal saddling interface 65b (and its associated rearward critical contact point).

A string 35 may contact a saddling interface 65 on a fretting saddling member 60 at a rearward critical contact point 24. To correct sharp fretted fingerboard notes and sharp wrist fretted notes, the fretting saddling member may be adjusted rearward. To correct flat fretted fingerboard notes and flat wrist fretted notes, the fretting saddling member may be adjusted forward. A fretting saddling member (including fretting saddling members arranged as described in the previous paragraph) may positioned such that any combination of the following is achieved: i) a proximal saddling interface 65a (and an associated rearward critical contact point) is at a distance from a nut 25 which is less than, equal to, or greater than a neck scale length, and ii) a distal saddling interface 65b (and an associated rearward critical contact point) is at a distance from a nut which is less than, equal to, or greater than a neck scale length.

Factors affecting the pitch of fretted fingerboard notes also affect the pitch of wrist fretted notes. Additionally, a previously unknown set of factors affects the pitch of wrist fretted notes. On a fretting saddling member 60, a fretting crown segment may be positioned relative to a saddling interface 65 to account for these factors and to define an intonated wrist fretable note.

An example of a previously unknown factor affecting the pitch of a wrist fretted note is: To intonate notes of the fingerboard frets 33, the position of a rearward critical contact point 24 of a wrist fretting string may be adjusted relative to the nut 25. A fretting saddling member 60, which is adjustably positionable, may compensate for this factor. By including a saddling interface 65 and a sequence of fretting crowns on the fretting saddling member, adjustment of the longitudinal position of the fretting saddling member to intonate fingerboard fretted notes may also adjust the longitudinal position of that sequence of fretting crowns. The positions, relative to one another, of the features on the fretting saddling member may remain the same before and after repositioning. Thus, adjusting the position of the fretting saddling member to intonate the fretted fingerboard notes may i) completely or partly intonate the wrist fretable notes, and ii) compensate for the shift in the position of the saddling interface to intonate the fretted fingerboard notes.

This paragraph will describe a more complex set of previously unknown factors affecting the pitch of wrist fretted notes. When positioning a fretting saddling member 60 on an instrument 5, three example scenarios may be envisioned. These scenarios may be termed scenario A, scenario B, and scenario C. Scenarios A, B, and C may be as follows: The angle of a sequence of fretting crown segments to a string 35, which has a saddling interface 65 as its vertex, may be A) less than, B) equal to, or C) greater than the angle of a sequence of fingerboard frets to the string which has a nut 25 as its vertex. The number of fingerboard frets 33 playable with the string may be A) less than twelve, B) about twelve, or C) more than twelve. The distance between the string and a fretting crown segment may be A) less than, B) equal to, or C) greater than the distance between the string and a fingerboard fret with the same ordinal number. The amount of force to wrist fret at the fretting crown segment may be A) less than, B) equal to, or C) greater than the amount of force to fret at the corresponding fingerboard fret.

This paragraph will describe how features of example fretting saddling members 60 may be arranged (for intonation) to compensate for the factors in the scenarios in the previous paragraph. A scenario A fretting saddling member, a scenario B fretting saddling member, and a scenario C fretting saddling member may be constructed. On a scenario A fretting saddling member, a scenario B fretting saddling member, and a scenario C fretting saddling member: A fretting crown segment may be positioned at a distance from a saddling interface 65 which is A) greater than, B) equal to, or C) less than a nominal oddment length of its associated interval. The distance between the fretting crown segment and the saddling interface may be A) greater than, B) equal to, or C) less than the distance between a fingerboard fret 33 with the same ordinal number and the nut 25. The distance between the fretting crown segment and the rearward critical contact point 24 of the string 35 may be A) greater than, B) equal to, or C) less than the distance between the corresponding fingerboard fret and the forward critical contact point 23 of the string.

A proximal saddling interface 65a (and a respective rearward critical contact 24 point of a string 35) and a distal saddling interface 65b (and a respective rearward critical contact point of a string) and i) a proximal sequence of fretting crown segments and/or ii) a distal sequence of fretting crown segments may be arranged on a fretting saddling member 60 such that vertical position, a longitudinal position, and angular positions of the fretting saddling member (including the positions of the saddling interfaces, proximal fretting crown segments 40, and distal fretting crown segments 45) may be adjusted such that: 1) The open note of a proto string 35a is playable. 2) The open note of a deutero string 35b is playable. 3) The proximal saddling interface 65a directs the proto string 35a at a wrist fretable vertical distance above each proximal fretting crown segment 40 in the sequence of proximal fretting crown segments. 4) The distal saddling interface directs 65b the deutero string 35b at a wrist fretable vertical distance above each distal fretting crown segment 45 in the sequence of distal fretting crown segments. 5) The proto string may be used to play intonated fretted fingerboard notes with the fingerboard frets 33 under it. Each fingerboard fret under the proto string defines a fretted fingerboard note. 6) The deutero string may be used to play intonated fretted fingerboard notes with the fingerboard frets 33 under it. Each fingerboard fret under the deutero string defines a fretted fingerboard note. 7) Each proximal fretting crown segment in the proximal sequence of fretting crown segments defines an intonated wrist fretable note above the open note of the proto string. All the proximal fretting crown segments 40 are playable. 8) Each distal fretting crown segment in the distal sequence of fretting crown segments defines an intonated wrist fretable note above the open note of the deutero string. All the distal fretting crown segments 45 are playable.

It is to be noted that descriptions of a fretting saddling member 60 and its relationship to strings 35, although described in regard to a proto string 35a and a deutero string 35b, may be understood to be descriptive of any laterally distal string and laterally proximal string configured for use with a similar fretting saddling member. Thus, a fretting saddling member described relative to a proto string and a deutero string might, for example, function in the same manner with a trito string 35c and a tetarto string 35d. Similarly, the described intonation method may be used with a fretting saddling member configured for a single string, or for three or more strings.

In a chromatic arrangement, a first, a second, a third, and a fourth fretting crown segment in a sequence of fretting crown segments may define wrist fretable notes a semitone, a whole step, a minor third, and a major third above the open note of a respective open string 35. Each fretting crown segment in the sequence of fretting crown segments may be positioned to define a wrist fretable note which is the same as a fretted fingerboard note of a fingerboard fret 33 with the same ordinal number. The vertical position and the longitudinal position of the fretting saddling member 60 may be adjusted such that: i) a vertical position and a longitudinal position of each fretting crown segment enables that fretting crown segment to define a wrist fretable note above the open note of its respective string; and ii) each sequence of fretting crown segments defines a sequence of wrist fretable notes above the open note of its respective string. In some embodiments, a fretting crown segment and a fingerboard fret with the same ordinal number produce the same pitch, but do so with unequally long sounding lengths of a string 35.

The following paragraph discloses, with particularity, example fretting saddling member feature positions.

Illustrations in FIGS. 7 and 9-11, 13, and 14 include a fretting saddling member 60. The features of the fretting saddling member may be fixedly located on the fretting saddling member. (In additional or alternative embodiments, some features may be adjustably located on the fretting saddling member.) Features may be located on the fretting saddling member as follows: 1) The proximal saddling interface 65a may be farther longitudinally rearward than the distal saddling interface 65b. 2) Each proximal fretting crown segment 40 may be nearer to the proximal saddling interface 65a than a nominal oddment length of its respective interval (and by the same amount). The distances between i) a first proximal fretting crown segment 40a, a second proximal fretting crown segment 40b, a third proximal fretting crown segment 40c, and a fourth proximal fretting crown segment 40d and ii) a proximal saddling interface 65a may respectively be less than the distances between iii) a first fingerboard fret 33a, a second fingerboard fret 33b, a third fingerboard fret 33c, and a fourth fingerboard fret 33d and iv) a nut 25. 3) Each distal fretting crown segment 45 may be nearer to the distal saddling interface 65b than a nominal oddment length of its respective interval (and by the same amount). The distances between i) a first distal fretting crown segment 45a, a second distal fretting crown segment 45b, a third distal fretting crown segment 45c, and a fourth distal fretting crown segment 45d and ii) the distal saddling interface may respectively be less than the distances between iii) the first fingerboard fret, the second fingerboard fret, the third fingerboard fret, and the fourth fingerboard fret and iv) the nut. 4) The proximal saddling interface 65a and the proximal sequence of fretting crown segments may include a first fingerboard matching angle. Fingerboard matching angles are disclosed in further detail below. 5) The distal saddling interface 65b and the distal sequence of fretting crown segments may include a second fingerboard matching angle.

The following paragraph discloses with particularity an example fretting saddling member set up.

On an instrument 5, with one or more respective fasteners 75 in a non locking configuration, a longitudinal and vertical position of a fretting saddling member 60 may be adjusted. The height of the proto string 35a above the fingerboard 32 may be adjusted by adjusting the vertical position of the proximal saddling interface 65a. The height of the deutero string 35b above the fingerboard 32 may be adjusted by adjusting the vertical position of the distal saddling interface 65b. The angle of between the proximal sequence of fretting crown segments and the proto string 35a which has the proto string rearward critical contact point 24a as its vertex may be adjusted until all the fingerboard frets 33 under the proto string are playable and all the proximal fretting crown segments 40 are playable. The angle of between the distal sequence of fretting crown segments and the deutero string which has the deutero string rearward critical contact point 24b as its vertex may be adjusted until all the fingerboard frets under the deutero string are playable and all the distal fretting crown segments 45 are playable. (If a proximal or distal sequence of fretting crown segments is not present, setup is similar.)

In combination, FIGS. 7 and 9-13, and 14 continue to illustrate an example set up as follows: A sequence of fingerboard frets may include a first fingerboard fret 33a, a second fingerboard fret 33b, the third fingerboard fret 33c, and a fourth fingerboard fret 33d. A proximal sequence of fretting crown segments may include a first proximal fretting crown segment 40a, a second proximal fretting crown segment 40b, a third proximal fretting crown segment 40c, and a fourth proximal fretting crown segment 40d. A distal sequence of fretting crown segments may include a first distal fretting crown segment 45a, a second distal fretting crown segment 45b, a third distal fretting crown segment 45c, and a fourth distal fretting crown segment 45d. With features located as described in the paragraph describing example fretting saddling member positions above, and the instrument 5 set up as described in the paragraph describing example fretting saddling member set up above: 1) The angle of between the proximal sequence of fretting crown segments and the proto string 35a, which has the proto string rearward critical contact point 24a as its vertex, may be greater than the angle between the sequence of fingerboard frets and the proto string which has the nut 25 as its vertex. The proto string may be farther from each proximal fretting crown segment 40 than from a fingerboard fret 33 with the same ordinal number. 2) The angle of between the distal sequence of fretting crown segments and the deutero string 35a, which has the deutero string rearward critical contact point 24a as its vertex, may be greater than the angle between the sequence of fingerboard frets and the deutero string, which has the nut 25 as its vertex. The deutero string may be farther from each distal fretting crown segment 40 than from a fingerboard fret 33 with the same ordinal number.

In combination, FIGS. 7, 9-13, and 14 illustrate the following: With features located as described in the paragraph describing example fretting saddling member positions above, and the instrument set up as described in the paragraph describing example fretting saddling member set up above, the instrument may be used to play in tune open notes, in tune fingerboard fretted notes, and in tune wrist fretted notes with the proto string 35a and the deutero string 35b. With the instrument set up as described: 1) The distance from the proto string rearward critical contact point 24a to the proto string forward critical contact point 23a may be longer than the distance from the deutero string rearward critical contact point 24b to the deutero string forward critical contact point 23b, and both distances may be longer than a neck scale length. 2) The distance from a fingerboard fret 33 to the proto string rearward critical contact point 24a may be longer than the distance from that fingerboard fret to the deutero string rearward critical contact point 24b, and both distances may be longer than a nominal sounding length of the interval respective to that fingerboard fret. 3) The distance from each proximal fretting crown segment 40 to the proto string forward critical contact point 23a may be longer than the distance from a distal fretting crown segment 45 with the same ordinal number to the deutero string forward critical contact point 23b, and each distance may be longer than the distance from a fingerboard fret with the same ordinal number to the rearward critical contact point of the respective string.

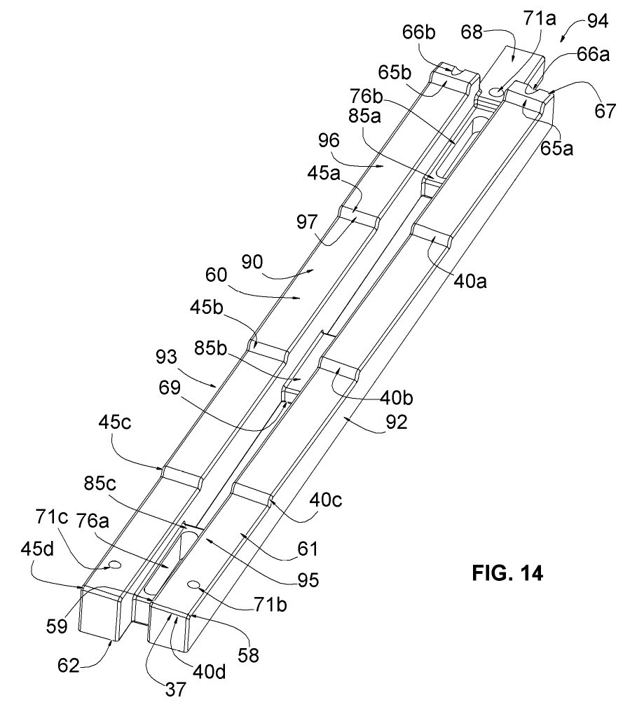

FIG. 14 illustrates a fretting saddling member 60. An upper member surface 90 of the fretting saddling member may include multiple upward facing faces 96, which may be separated by forward facing surfaces 97. A fretting crown may be formed as a rounded edge where an upward facing face of the upper member surface and a forward facing surface meet. For a fretting crown, lateral edges of an upward facing face and a forward facing surface may meet to form a proximal lateral end 58 and a distal lateral end 59 of the fretting crown. The upper member surface may be divided between the proximal bar 61 and the distal bar 62, such that one string fretting crowns 37 on each of the two bars are formed from upward facing faces and forward facing surfaces on those bars. A saddling interface 65 may be a rounded edge where an upward facing face of the upper member surface, of the clearance surface 67, or of a transition from the upper member surface to the clearance surface meets a forward facing surface.

A rounded edge between an upward facing face up the upper member surface and a forward facing surface may be perpendicular to a string, or may be angled at a range of angles associated with “fanned frets.”

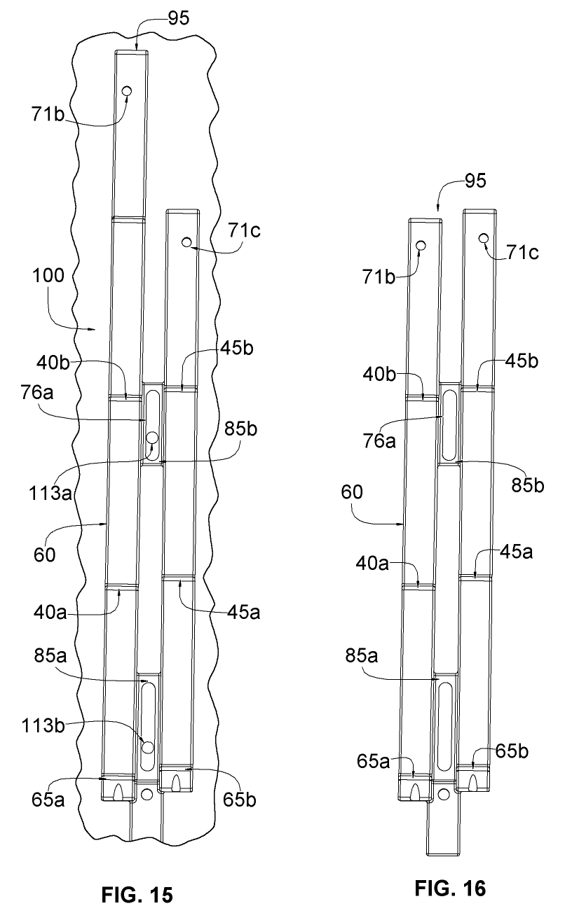

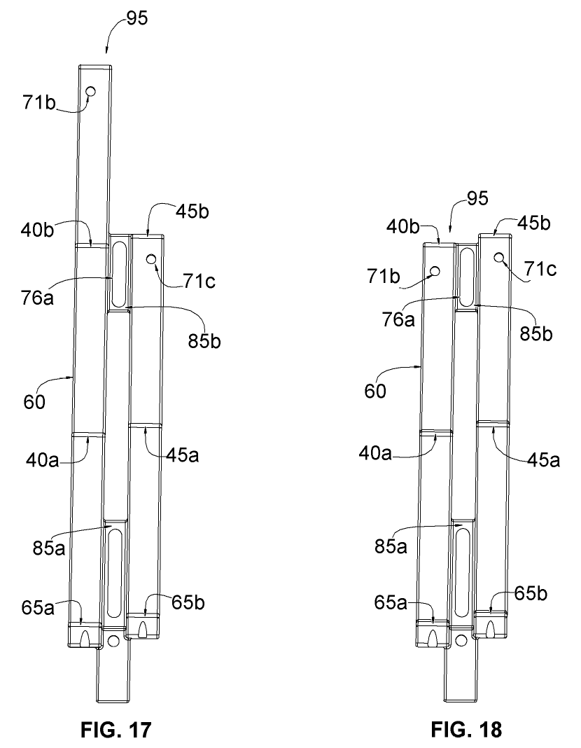

In combination, FIGS. 15-21 illustrate the following: A fretting saddling member 60 may have a varied number of proximal fretting crown segments 40 and distal fretting crown segments 45. A fretting saddling member may have at least a proximal fretting crown segment or a distal fretting crown segment. A fretting saddling member may further have any combination of one, two, three, four, or more proximal fretting crown segments, and/or one, two, three, four, or more distal fretting crown segments. A proximal forward height adjustment hole 71b or distal forward height adjustment hole 71c may be slightly to the rear of a respective proximal or distal fretting crown segment.

In combination, FIGS. 15-18 illustrate the following: A forward member fastening slot 76a in a fretting saddling member 60, and a forward fastening opening 113a in a support 100, may be between slightly rearward of a second proximal fretting crown segment 40b and a second distal fretting crown segment 45b. The forward member fastening slot (positioned to be centered between and aligned with two respective strings) is in the middle crosspiece 85b, the front crosspiece being omitted due to reduced length. A rearward fastening opening 113b may be below a rearward crosspiece 85a. With fewer fretting crown segments, a forward member end 95 may be relatively nearer to a proximal saddling interface 65a and a distal saddling interface 65b. The proximal forward height adjustment hole 71b and the distal forward height adjustment hole 71c may also be relatively nearer to the saddling interfaces. Other than the alterations to the above described features, an instrument with support features like those in FIG. 15, and a fretting saddling member like the ones in FIGS. 15-18, may be similar to an instrument depicted in FIGS. 7-14.

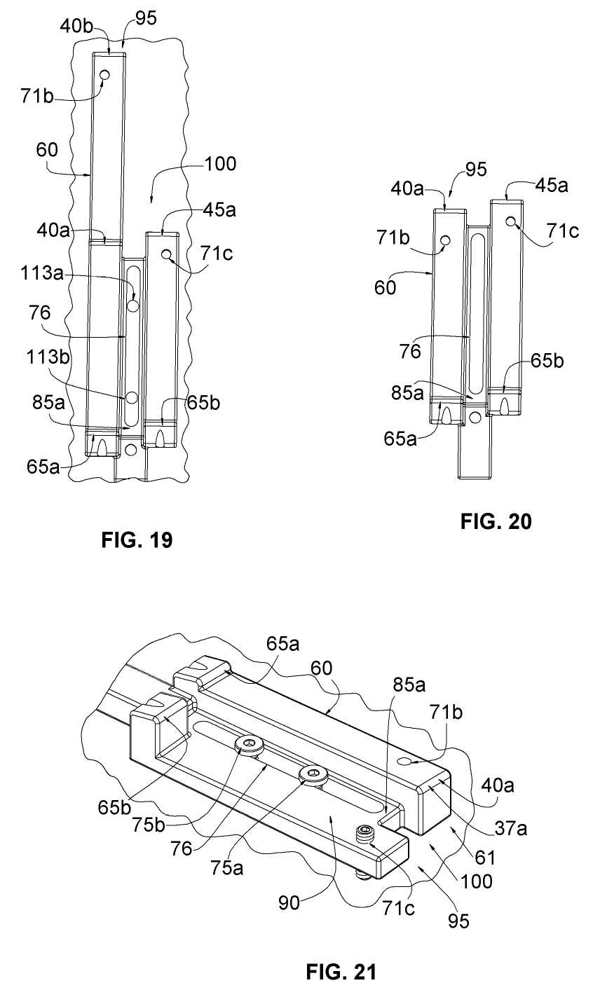

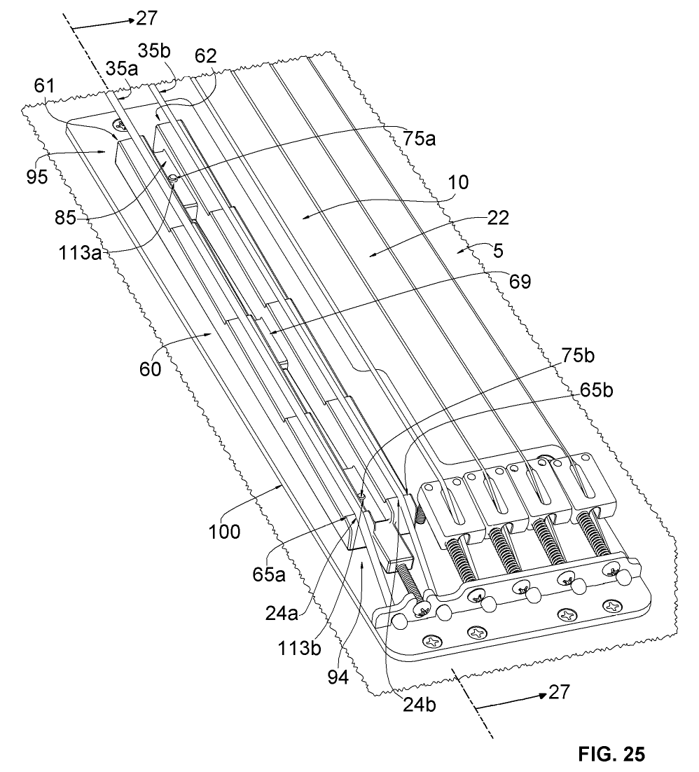

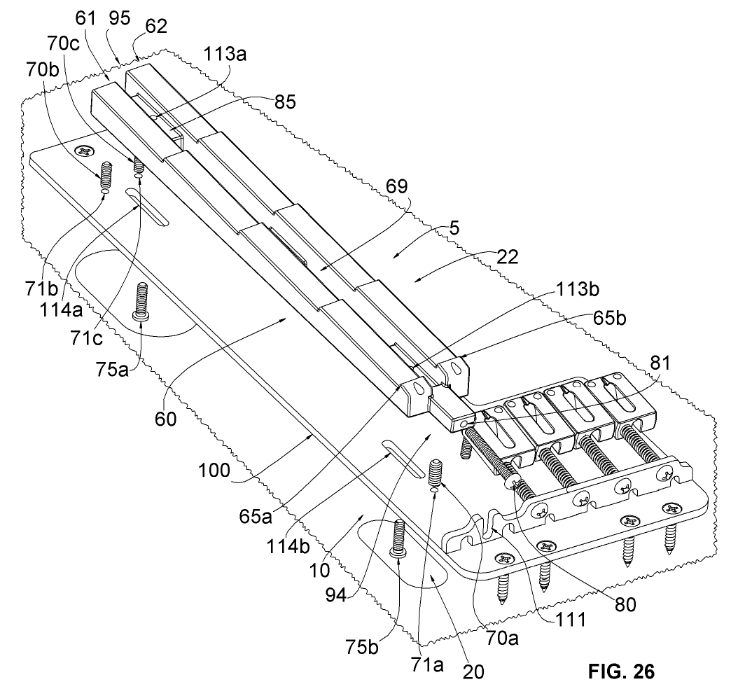

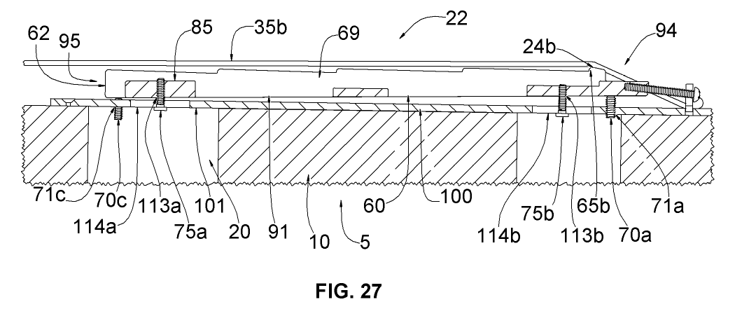

In combination, FIGS. 15 and 19-21 illustrate the following: A fretting saddling member 60 can have varied numbers of fretting crown segments. The length of a single member fastening slot 76 may allow it to be positioned above a forward fastening opening 113a and a rearward fastening opening 113b in a support 100, and for a rearward fastener 75b and a forward fastener 75a to insert through the member fastening slot into the forward fastening opening and the rearward fastening opening. The member fastening slot (positioned to be centered between and aligned with the two respective strings) is in the rear crosspiece 85a, which is now the only crosspiece (except in FIG. 15, which has a middle crosspiece 85b). The member fastening slot may be longitudinally farther rearward than a first proximal fretting crown segment 40a and a second distal fretting crown segment 45a. Positions of the longitudinal slots and fastening openings may be varied to accommodate various numbers of fretting crown segments. With fewer fretting crown segments, a forward member end 95, may be relatively nearer to a proximal saddling interface 65a and a distal saddling interface 65b. The proximal forward height adjustment hole 71b and the distal forward height adjustment hole 71c, may also be relatively nearer to the saddling interfaces. As illustrated (labeled in FIGS. 25-27 below but not labeled here) in FIG. 21, a distal bar 62, has an upper member surface 90 at a lower vertical level (to prevent contact with a respective string), and a first one string fretting crown 37a on the proximal bar 61. Other than the alterations to the above described features, an instrument with support features like those in FIG. 19, and a fretting saddling member like the ones in FIGS. 19-21, may be similar to an instrument as depicted in FIGS. 7-14.

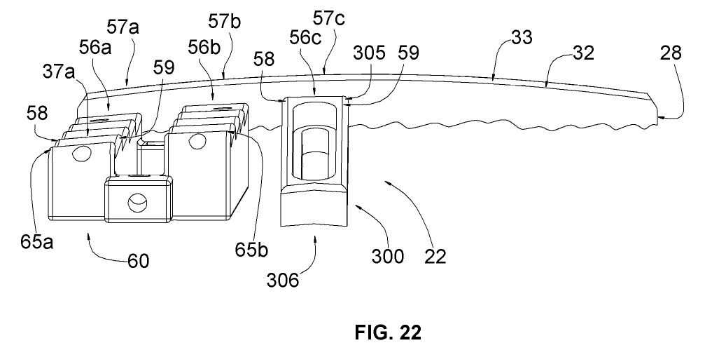

In combination, FIGS. 22-24 illustrate the following: An assembly 22 includes a fretting saddling member 60 and a fretting appendage 300. The instrument 5 (as illustrated via a combination of FIGS. 22-24) may be similar to an instrument as shown and described in FIGS. 7-14, with the addition of the fretting appendage and two corresponding appendage fastening openings 330 in a support 100 under a trito string 35c. A plurality of consecutive strings may be as follows: A proto string 35a, which may be a laterally outermost proximal string, a deutero string 35b, and the trito string 35c, may be wrist fretting strings. A tetarto string 35d, a pempto string 35e, and a hecto string 35f may be single direction fretting strings.

The following paragraph discloses fingerboard matching angles, as may be used in conjunction with any other features disclosed throughout the present specification.

FIGS. 22-24 illustrate a fretting saddling member 60 and a fretting appendage 300. A proximal saddling interface 65a of the fretting saddling member may be contacted by a proto string 35a at proto string rearward critical contact point 24a. A distal saddling interface 65b of the fretting saddling member may be contacted by a deutero string 35b at deutero string rearward critical contact point 24b. The fretting saddling member may include a proximal sequence of fretting crown segments, including a first proximal fretting crown segment 40a, a second proximal fretting crown segment 40b, a third proximal fretting crown segment 40c, and a fourth proximal fretting crown segment 40d. The fretting saddling member may include a distal sequence of fretting crown segments, including a first distal fretting crown segment 45a, a second distal fretting crown segment 45b, a third distal fretting crown segment 45c, and a fourth distal fretting crown segment 45d. The proximal sequence of fretting crown segments is included by a proximal sequence of one string fretting crowns. A proximal first one string fretting crown 37a, including a proximal lateral end 58, the first proximal fretting crown segment, and a distal lateral end 59, is forward of the proximal saddling interface. The distal sequence of fretting crown segments is included by a distal sequence of one string fretting crowns. The proximal sequence of fretting crown segments and the proximal saddling interface may include a first fingerboard matching angle 56a matching a first fingerboard angle 57a (associated with the proto string) of a fingerboard 32. The distal saddling interface 65b and the distal sequence of fretting crown segments may include a second fingerboard matching angle 56b matching a second fingerboard angle 57b (associated with the deutero string) of the fingerboard. The fretting appendage may include an appendage fretting crown 305, which may include a third fingerboard matching angle 56c, matching a third fingerboard angle 57c associated with the trito string. The proximal saddling interface and the proximal sequence of fretting crown segments may be angled around a substantially longitudinal axis relative to the distal saddling interface and the distal sequence of fretting crown segments. A fingerboard matching angle may allow a string above a fretting crown segment to vibrate freely when a player plucks an open note or a fretted fingerboard note. The fingerboard matching angle may allow the fretting hand to bend the string without “fretting out” on a fretting crown segment. In additional or alternative embodiments, the difference between the proximal fingerboard matching angle of the proximal saddling interface and proximal sequence of fretting crown segments and the distal fingerboard matching angle of the distal saddling interface and distal sequence of fretting crown segments of a fretting saddling member is the same for each of multiple fretting saddling members used with an instrument.

It is to be noted that, with the configuration of fretting crown segments described in the previous paragraph, if the deutero string 35b is tuned a perfect fourth above the open note of the proto string 35a, and the trito string 35c is tuned a perfect fourth above the open note of the deutero string, the full chromatic scale may be played by wrist fretting.

FIG. 22 illustrates a fretting saddling member 60, a fretting appendage 300, and a fingerboard 32. A sequence of fretting crown segments and a respective saddling interface 65 may include a fingerboard matching angle 56. An instrument 5 may include a fingerboard 32, which may be curved. Each of the fretting crown segments in a sequence of fretting crown segments and a saddling interface may share the same fingerboard matching angle. A fingerboard angle respective to a string which is nearer to the centerline of a neck 28 may be smaller than a fingerboard angle respective to a string which is nearer to an edge of the neck. For a curved fingerboard, a fingerboard angle may manifest as a tangent to a curve of the fingerboard under a string; a fingerboard angle may be measured near a rearmost fingerboard frets 33. A fingerboard fret 33 may curve with the fingerboard. For common curved fingerboard radii, a fingerboard matching angle may be between zero and ten degrees, depending on a lateral position of a string and a radius of a fingerboard. However, for an instrument with a small fingerboard radius and a wide neck, a fingerboard matching angle may be as large as twenty degrees. The string contactable fretting crown segments and the saddling interfaces may be linear. In an additional or alternative embodiment, a sequence of fretting crown segments is arched to achieve one or more fingerboard matching angles. In an additional or alternative embodiment, a fingerboard matching angle of an arched fretting crown is visible as a tangent to the fretting crown at a string contactable point. In additional or alternative embodiments, a fingerboard is flat, which may be described as “infinite radius.” A flat fingerboard may include a fingerboard angle of zero degrees. For a flat fingerboard, a fingerboard matching angle of zero degrees may be appropriate.

Although some buzz may result, a generic fretting saddling member 60 including fingerboard matching angles 57 of zero degrees (stated a different way, fingerboard matching angles for a flat fingerboard), may be used with any two strings 35 of an instrument 5 with a radiused fingerboard 32. Similarly, a generic fretting saddling member with averaged or estimated fingerboard matching angles may be used to approximately match two fingerboard angles. Any instrument may have a flat fingerboard or a curved fingerboard and appropriate fingerboard matching angles

When setting up an instrument, 5 a fretting saddling member 60 may be adjustably positioned as follows: i) the distance between a proto string 35a and a fingerboard fret 33 may be set to a first vertical distance, ii) the distance between a deutero string 35b and that fingerboard fret may be set to the first vertical distance, iii) the distance between the proto string and a proximal fretting crown segment 40 may be set to a second vertical distance, iv) the distance between the deutero string and a distal fretting crown segment 45 of the same ordinal number as the proximal fretting crown segment may be set to the second vertical distance. The fretting saddling member may be arranged such that the proximal saddling interface 65a and a proximal sequence of fretting crown segments (including the proximal fretting crown segment) are positioned such that a first fingerboard matching angle 56a that they include matches a first fingerboard angle 57a, and vi) the distal saddling interface 65b and a distal sequence of fretting crown segments (including the above mentioned distal fretting crown segment) are positioned such that a second fingerboard matching angle 56b that they include matches a second fingerboard angle 57b.

Any saddling interface 65 and any sequence of fretting crown segments may include a fingerboard matching angle 56 corresponding to a fingerboard angle 57 respective to its string 35.

As illustrated in FIGS. 22-24, an assembly 22 includes a fretting appendage 300. The fretting appendage 300 may be coupled to and positioned on an upper support surface 102 of a support 100 under a trito string 35c for wrist fretting. The fretting appendage may be coupled to and positioned on a body 10 by the support. The fretting appendage may include a fretting end 301 including an appendage fretting crown 305. Opposite the fretting end, the fretting appendage may include a supporting end 302 including an appendage pivot 306 (including two lateral contact projections) longitudinally spaced from the appendage fretting crown. With two appendage fasteners 310 in a non locking configuration, the longitudinal position of the fretting appendage, including the appendage fretting crown, may be adjustable relative to the support, the body, and trito string rearward critical contact point 24c. An appendage height screw 315 may insert into an appendage height adjustment hole 316 in a height tab 320 of the fretting end, may extend downward, and may contact the upper support surface of the support. With the appendage fastener in a non locking configuration, the appendage height screw may be turned to adjust the vertical position of the fretting end (including the appendage fretting crown) relative to the respective string, the support, and the body, by pivoting the fretting appendage on the appendage pivot. The appendage height screw may support the fretting appendage in a range of vertical positions and slide against the support during a longitudinal repositioning of the fretting appendage. The appendage fastener 310 may lock the longitudinal, vertical, and lateral position of the fretting appendage, including the appendage fretting crown. Each appendage fastener may insert through an appendage fastening slot 325 in the fretting appendage, centered between lateral appendage sides of the fretting appendage, into an appendage fastening opening 330 centered under the trito string. The two appendage fastening openings may be aligned with the trito string. The head of the appendage fastener may seat in a recess above the appendage fastening slot. The fretting appendage may be positionable such that the appendage fretting crown defines a wrist fretable note a semitone above an open note of the trito string and is centered under the trito string. The appendage fretting crown of the fretting appendage may be positionable at a wrist fretable vertical distance under the trito string. A proximal lateral appendage side 335 of the fretting appendage and a proximal lateral end 58 of the appendage fretting crown may be laterally between a deutero string and the trito string. A distal lateral appendage side 340 of the fretting appendage and a distal lateral end 59 of the appendage fretting crown may be laterally between the trito string and a tetarto string. The through slot may be a longitudinal slot and may be centered under aligned with the line of the trito string. Each fastener may independently lock the position of the fretting appendage without the use of the other.

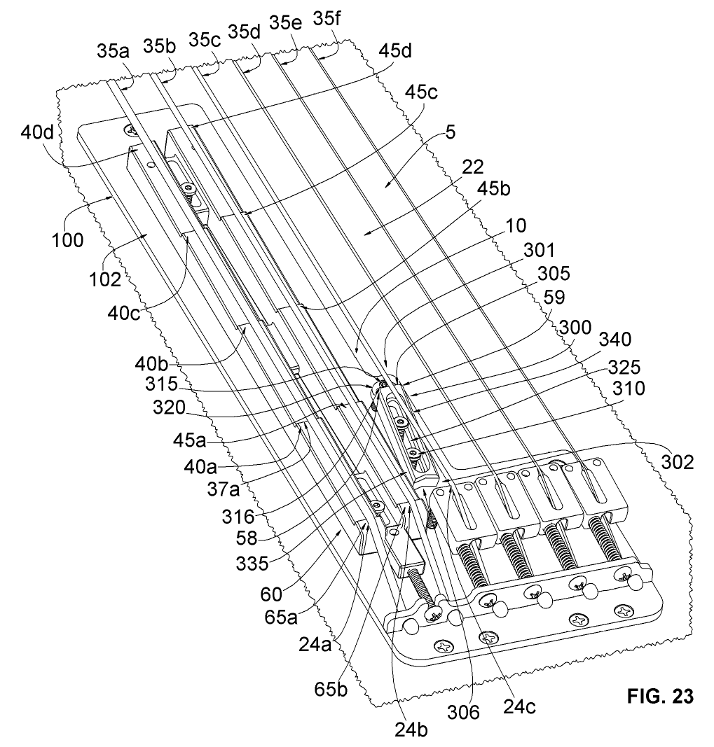

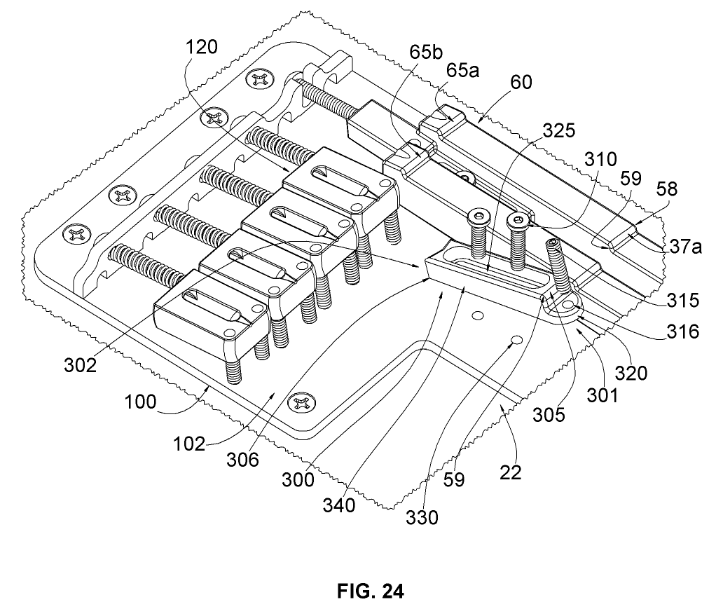

As illustrated in FIGS. 23 and 24, an assembly 22 includes a fretting appendage 300. In an additional or alternative embodiment, an appendage fastener inserts upward through a longitudinal appendage fastening slot in a support into an appendage fastening opening in the fretting appendage, and locks the longitudinal, vertical, and lateral position of the fretting appendage. In an additional or alternative embodiment, an appendage height screw 315 inserts into an appendage height adjustment hole in the support and contacts a downward surface of the fretting appendage to adjust the vertical position of the fretting end. The height screw may support the fretting appendage, which may slide along the height screw during longitudinal and vertical repositioning of the fretting appendage. The appendage fastener may slide along the appendage fastening slot during longitudinal and vertical positioning.

As illustrated in FIGS. 23 and 24, an assembly includes a fretting appendage 300. The longitudinal position of a fretting appendage 300 may be adjusted such that the distance from the appendage fretting crown 305 to a trito string forward critical contact point is less than, equal to, or greater than a nominal semitone sounding length. The fretting appendage may be under the trito string 35c. The longitudinal position of the appendage fretting crown may be adjusted such that the distance from the appendage fretting crown to the trito string rearward critical contact point 24c is less than, equal to, or greater than the distance from a first fingerboard fret to a trito string forward critical contact point. A saddle 120 of the trito string 35c may be adjusted such that the distance from the trito string forward critical contact point to the trito string rearward critical contact point is longer than, equal to, or shorter than a neck scale length. A fretting appendage may be a shaped block of a material. The block may include multiple components, such as a threaded insert or a piece of fretwire. The block may include rectilinear, curved, rounded, or decorative shapes. A block may be solid, hollow, or skeletonized, and may include a bent sheet of a material. The block may be sheet metal or another material. Any feature or a function of a fretting appendage described in this document may be included by the block included by the fretting appendage.

As illustrated in FIGS. 23 and 24, an assembly includes a fretting appendage 300. In an additional or alternative embodiment, a fretting appendage 300 is positioned under any string 35. In an additional or alternative embodiment, a fretting appendage may be positionable to define a wrist fretable note a semitone, whole step, minor third, major third or other interval, above an open note of its respective string.

The farthest longitudinally forward point on a fretting saddling member may be understood to be a forward extent. The forward extent may be at the forward member end.

In combination, FIGS. 25-27 illustrate the following: A fretting saddling member 60 may be positioned on and coupled to a support 100. A proximal forward height adjustment hole 71b is located in the support 100 under a proximal bar 61, under a proximal portion of a forward member end 95 of a fretting saddling member 60, slightly proximal of a proto string 35a. The proximal forward height adjustment hole may be far enough longitudinally rearward of a forward extent of the fretting saddling member to remain under the forward member end throughout the longitudinal positioning range of the fretting saddling member. A proximal forward height screw 70b may insert vertically into the proximal forward height adjustment hole and contact a downward member surface 91 of the fretting saddling member in the proximal portion of the forward member end. The proximal forward height screw may extend vertically between the support and the forward member end. The proximal forward height screw may adjust the vertical position of the proximal portion of the forward member end. As the fretting saddling member is longitudinally repositioned, the fretting saddling member may slide on and against and be supported by the proximal forward height screw in a range of vertical positions. When a rearward height screw 70a or a distal forward height screw 70c may be raised or lowered, the fretting saddling member may pivot on and against the proximal forward height screw.

In combination, FIGS. 25-27 illustrate the following: A fretting saddling member 60 may be positioned on and coupled to a support 100. The support may be positioned above a body cavity 20. A distal forward height adjustment hole 71c is located in the support 100 under a distal bar 62, under a distal portion of a forward member end 95 of the fretting saddling member 60, slightly distal of a deutero string 35b. The distal forward height adjustment hole may be far enough longitudinally rearward of a forward extent of the fretting saddling member to remain under the forward member end throughout the longitudinal positioning range of the fretting saddling member. A distal forward height screw 70c may insert vertically into the distal forward height adjustment hole and contact a downward member surface 91 of the fretting saddling member, in the distal portion of the forward member end. The distal forward height screw may extend vertically between the support and the distal portion of the forward member end. The distal forward height screw may adjust the vertical position of the distal corner of the forward member end. As the fretting saddling member is longitudinally repositioned, it may slide on and against and be supported by the distal forward height screw in a range of vertical positions. When a rearward height screw or a distal forward height screw is raised or lowered, the fretting saddling member may pivot on and against the distal forward height screw.

In combination, FIGS. 25-27 illustrate the following: A fretting saddling member 60 may be positioned on and coupled to a support 100 on a body 10 of an instrument 5. A support 100 may include a rearward height adjustment hole 71a under a rearward member end 94 of a fretting saddling member 60. The rearward height adjustment hole may be centered between a proto string and a deutero string under the rearward member end, near a crosspiece or a positioning projection. The rearward height adjustment hole may remain near or to the rear of rearward critical contact points 24 of a proto string 35a and a deutero string 35b on the fretting saddling member throughout the longitudinal positioning range of the fretting saddling member. A rearward height screw 70a may insert vertically into the rearward height adjustment hole and contact a downward member surface 91 of the fretting saddling member. The rearward height screw may extend vertically between the support and the fretting saddling member. As the fretting saddling member is longitudinally repositioned, it may slide on and against and be supported by the rearward height screw in a range of vertical positions. When a forward member end is raised or lowered using a forward height screw, the fretting saddling member may pivot on the rearward height screw.

In some embodiments, a height adjustment hole 71 is in a support 100. A fastener 75 may lock an end of a height screw 70 against a fretting saddling member. In this manner, the fastener may lock the fretting saddling member to the body. In some embodiments, the height adjustment hole is tapped into the support. The height screw in the height adjustment hole in the support may be adjusted through an aperture of a body cavity 20 at the back of the instrument 5.

In combination, FIGS. 25-27 illustrate the following: An assembly 22 may include a fretting saddling member 60, which may be positioned on and coupled to a support 100. With height adjustment holes 71 in a support 100, a fastener 75 may lock a fretting saddling member 60 to the support (and thus to a body 10) by locking the fretting saddling member against the height screws.

A fastener 75 may be locked or unlocked by turning it. For the convenience of the user, each of multiple, redundant, fasteners may be individually fully capable of locking the longitudinal position, vertical position, lateral position, and the angular position of a fretting saddling member 60 without the use of another fastener. A fastener may be threaded and may be a screw. A fastening opening 113 may be a threaded hole. In some embodiments, a fastening opening is tapped into the material of the fretting saddling member. In some embodiments, a fastening opening is tapped into the material of the support. In additional or alternative embodiments, a fastening opening includes a threaded insert.

In some embodiments, with a fastener 75 or fasteners in a non locking configuration, features of an assembly 22 act at longitudinally, laterally, and/or vertically separated points to limit lateral movement of a fretting saddling member 60. These may include: i) a support fastening slot 114, a fastener, and a fastening opening 113 in a fretting saddling member; ii) a member fastening slot 76, a fastener, and a fastening opening in a support; and iii) a positioning slot 111, a positioning hole 81, and a positioning screw 80. Each of these features may align a fretting saddling member with a proto string 35a and a deutero string 35b, may center the fretting saddling member laterally between the proto string and the deutero string, and may assist in maintaining a fingerboard matching angle 56 of the fretting saddling member. Each of these features may restrict a lateral position of a fretting saddling member. Restricting lateral movement of a fretting saddling member at two points may enable adjustment of the longitudinal position of a fretting saddling member along a line of longitudinal adjustment, which is centered between a proto string and a deutero string and which is substantially parallel to both strings. A length of a fastening slot, longitudinal positions of fastening openings, and longitudinal positions of height adjustment holes may be fitted to a longitudinal and vertical positioning range of the fretting saddling member.

In some embodiments, a forward fastening opening 113a is in a support 100, and a forward member fastening slot 76a is in a fretting saddling member 60. In some embodiments, a forward fastening opening is in a fretting saddling member, and a forward support fastening slot 114a is in a support. In some embodiments, a rearward fastening opening 113b is in a support, and a rearward member fastening slot 76b is in a fretting saddling member. In some embodiments, a rearward fastening opening is in a fretting saddling member, and a rearward support fastening slot 114b is in a support. A forward fastener 75a and a rearward fastener 75b may each independently lock a vertical position, a longitudinal position, and an angular position of the fretting saddling member. In a non locking configuration, a vertical position, a longitudinal position, and angular positions of the fretting saddling member may be adjustable. Together, in the non locking configuration, the two fasteners may guide a fretting saddling member during sliding adjustment of its longitudinal position at two longitudinally spaced points along the centerline of the two respective strings.

In an additional or alternative embodiment, a fastener 75 includes a threaded rod, threaded nut, latch, hook, clip, pin, bracket, wire, snap, or other feature. A fastener may include multiple components. It is possible to attach or form a fastener as a part of a fretting saddling member 60 or a support 100. A fastening opening 113 may be varied or omitted with a varied fastener form. Varied fastener forms and varied fastener positions are possible. Multiple fasteners may separately lock longitudinal positions, vertical positions, lateral positions, and angular positions of a fretting saddling member. In an additional or alternative embodiment, a fastener, such as a screw, directly connects a fretting saddling member to a body 10 without inserting into a support.

In combination, FIGS. 25-27 illustrate the following: An assembly 22 may include a fretting saddling member 60 positioned on and coupled to a support 100. The support 100 may include a support fastening slot 114, which may be a longitudinal through slot. The support fastening slot may be centered between a proto string 35a and a deutero string 35b. A fretting saddling member 60 may include a fastening opening 113, which may be a blind hole or a through hole in the downward member surface 91 of the fretting saddling member. The fastening opening may be centered between the lateral member sides of the fretting saddling member, and may be in a crosspiece 85 across the central longitudinal recess 69. A fastener 75 may insert upward through the support fastening slot into the fastening opening, which may be positioned above the support fastening slot, and into the central longitudinal recess. The head of the fastener may seat under the support against a lower support surface 101. The fastener may fit snugly in the support fastening slot, which may include a proximal guide surface and a distal guide surface, which may contact the fastener, preventing lateral movement of the fretting saddling member. The fastener may insert vertically from under the support. As height screws 70 raise and tilt the fretting saddling member, the fastener may tilt with it, in a substantially longitudinal axis, and in a substantially lateral axis. The fastener may slide longitudinally along the support fastening slot, against the guide surfaces, when the fretting saddling member is longitudinally repositioned. A single fastener may lock the longitudinal position, the vertical position, the lateral position, and the angular positions of the fretting saddling member, without the use of another fastener. A support may include a forward support fastening slot 114a and a rearward support fastening slot 114b, which may be longitudinally spaced from one another, but otherwise be as described above. The fretting saddling member may include a forward fastening opening 113a and a rearward fastening opening 113b, which may be longitudinally spaced from one another, but otherwise as described above. A forward fastener 75a may insert through the forward support fastening slot into the forward fastening opening. A rearward fastener 75b may insert through the rearward support fastening slot into the rearward fastening opening. A support fastening slot and a fastener may center a fretting saddling member between a proto string 35a and a deutero string 35b, and may align the fretting saddling member with the proto string and the deutero string. A proximal saddling interface 65a, a proximal sequence of one string fretting crowns, and a proximal bar 61 may be centered under and aligned with the proto string by the fastener and the support fastening slot. A distal saddling interface 65b, a distal sequence of one string fretting crowns, and a distal bar 62 may be centered under and aligned with the deutero string by the fastener and the support fastening slot. A proximal string rearward critical contact point 24a may be on the proximal saddling interface. Each sequence of one string fretting crowns may include a respective sequence of fretting crown segments. A distal string rearward critical contact point 24b may be on the distal saddling interface. The fastening openings may extend into a central longitudinal recess 69.

In an additional or alternative embodiment, the length of a single support fastening slot allows a forward fastening opening and a rearward fastening opening in a fretting saddling member to be positioned above the support fastening slot, and for a rearward fastener and a forward fastener to insert through the support fastening slot into the forward fastening opening and the rearward fastening opening.

In combination, FIGS. 25-27 illustrate the following: An assembly 22 may include a fretting saddling member 60 positioned on and coupled to a support 100. The support may include a positioning slot 111. The fretting saddling member may include a positioning hole 81. A positioning screw 80 may insert substantially longitudinally through the positioning slot into the positioning hole, and act to longitudinally position the fretting saddling member.

In some embodiments, a positioning screw 80 tilts as a fretting saddling member 60 is angled.

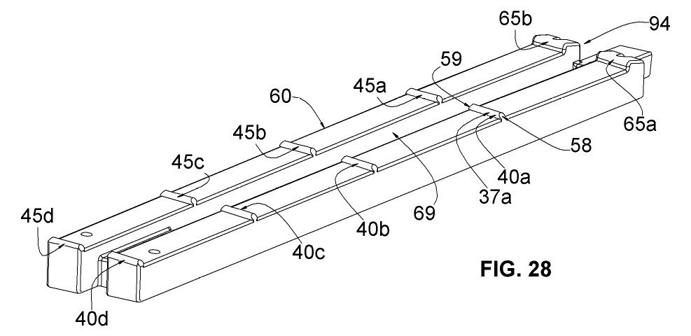

As illustrated in FIG. 28 a distal sequence of fretting crown segments includes a first distal fretting crown segment 45a, second distal fretting crown segment 45b, a third distal fretting crown segment 45c, and a fourth distal fretting crown segment 45d. A proximal sequence of fretting crown segments may include a first proximal fretting crown segment 40a, a second proximal fretting crown segment 40b, a third proximal fretting crown segment 40c, and a fourth proximal fretting crown segment 40d. At a rearward member end 94, the fretting saddling member 60 may include a proximal saddling interface 65a and a distal saddling interface 65b. The proximal sequence of fretting crown segments may be included by a proximal sequence of one string fretting crowns, which is separated by a central longitudinal recess 69 from a distal sequence of one string fretting crowns, which includes the distal sequence of fretting crown segments. Each saddling interface 65 and fretting crown may be in the form of a raised ridge, like a fingerboard fret. The fretting crowns and/or a saddling interfaces may be shaped from the material of the fretting saddling member or formed from fretwire or another firm material and attached to a fretting saddling member. A proximal first one string fretting crown 37a, including a proximal lateral end 58, the first proximal fretting crown segment, and a distal lateral end 59 is forward of the proximal saddling interface. The lateral ends of a fretting crown or a saddling interface (which has a fret-like form) may be beveled, rounded, or both. The proximal saddling interface and proximal sequence of fretting crown segments may include a first fingerboard matching angle. The distal saddling interface and distal sequence of fretting crown segments may include a second fingerboard matching angle. A sequence of fretting crown segments and its respective saddling interface may be coplanar. In an additional or alternative embodiment, a fretting crown may be arched. The fretting saddling member illustrated in FIG. 28 may be used with an instrument like an instrument as shown and described in FIGS. 7-13, in place of a fretting saddling member in those illustrations.

A sequence of fretting crown segments may be located on an upper member surface of a fretting saddling member between a saddling interface and a fingerboard on a neck. Each sequence of fretting crown segments on a fretting saddling member may follow the line of its associated string; the fretting crown segments may be substantially perpendicular to the string.

In combination, FIGS. 29 and 30 illustrate the following: A fretting saddling member 60 may include multiple two string fretting crowns 38. A first proximal fretting crown segment 40a and a first distal fretting crown segment 45a may be included by a first two string fretting crown 38a. A second proximal fretting crown segment 40b and a second distal fretting crown segment 45b may be included by a second two string fretting crown 38b. A third proximal fretting crown segment 40c and a third distal fretting crown segment 45c may be included by a third two string fretting crown 38c. A fourth proximal fretting crown segment 40d and a fourth distal fretting crown segment 45d may be included by a fourth two string fretting crown 38d, which includes a proximal lateral end 58 and a distal lateral end 59. A central longitudinal recess 69 may be positioned discontinuously, above a forward member fastening slot 76a and a rearward member fastening slot 76b. The two string fretting crowns form a sequence of two string fretting crowns under a proto string 35a and a deutero string 35b.

A two string fretting crown 38 may include a proximal fretting crown segment 40 including a first fingerboard matching angle and a distal fretting crown segment 45 including a second fingerboard matching angle.

A two string fretting crown 38 may be bent or angled (around an axis which is substantially vertical) to achieve the compensated longitudinal positions of its proximal and distal fretting crown segments relative to their respective saddling interfaces. A proximal saddling interface 65a and a distal saddling interface 65b may be formed as a ridge or edge, similar to a two string fretting crown; it may also be bent or angled.

In some embodiments, a fretting crown segment is part of a one string fretting crown 37. In some embodiments, two fretting crown segments are part of a two string fretting crown 38. In additional or alternative embodiments, a fretting saddling member includes one or more one string fretting crowns, one or more two string fretting crowns, and/or one or more fretting crowns of other widths. A proximal lateral end 58, a proximal fretting crown segment 40, a distal fretting crown segment 45 with the same ordinal number, and a distal lateral end 59 may be included by a two string fretting crown 38. The two fretting crown segments may be part of a proximal sequence of fretting crown segments under a proximal string and a distal sequence of fretting crown segments under a distal string.

As illustrated in FIG. 29, an assembly 22 includes a shim 115. A shim 115, under a fretting saddling member 60, may contact an upper support surface 102 of a support 100. The support may be on a body 10. The vertical position of a forward member end 95, a rearward member end 94, or both, may be adjusted with the shim. The shim may include a guide surface, which may act as a guide surface of a support. The shim may be used as an alternative to a height screw, or in conjunction with a height screw. A shim may include a hole or slot allowing a fastener 75 to insert through the shim. A fastener may lock a fretting saddling member to a shim, thus locking it to the support. Multiple shims may be stacked for vertical adjustment. A shim in the form of a wedge may be used for vertical adjustment; a sliding action of the shim may be used for vertical adjustment.

In an additional or alternative embodiment, a shim 115 is positioned between a support 100 and a body 10. The vertical position of the support may be adjusted by the shim, adjusting the vertical position of the forward member end of a fretting saddling member, the rearward member end, or both.

As illustrated in FIGS. 29 and 30, a fretting saddling member 60 includes two string fretting crowns 38. A shim 115 and the fretting saddling member illustrated in FIGS. 29 and 30 may be used with an instrument like an instrument as shown and described in FIGS. 7-13.

Any feature or function of a fretting saddling member 60 for two strings and corresponding features of an assembly 22 may be adapted to any two consecutive strings on an instrument 5. A fretting saddling member for two strings and corresponding features of a support may be used with any two strings 35 on an instrument. Sequences of fretting crown segments and saddling interfaces 65 of any fretting saddling member may include fingerboard matching angles matching fingerboard angles under respective strings 35.

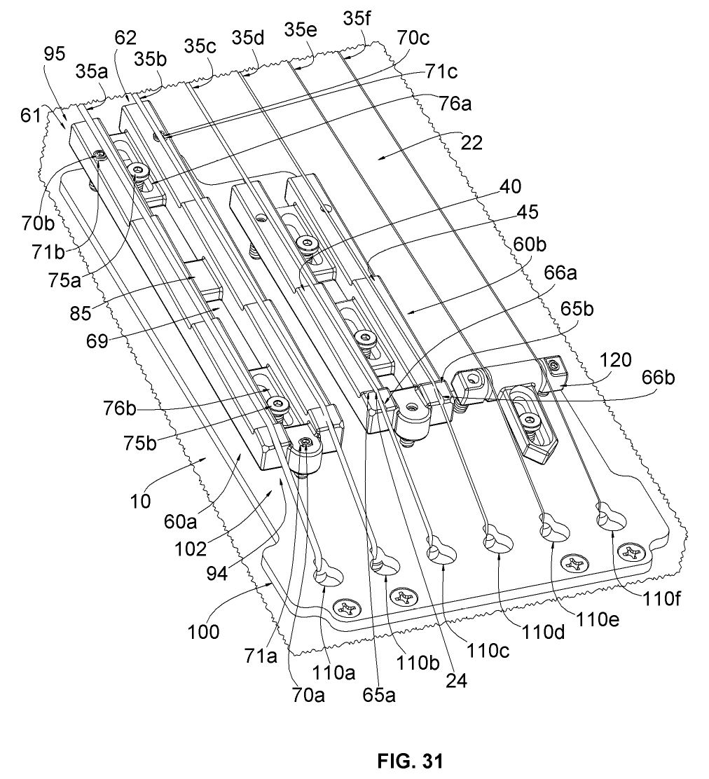

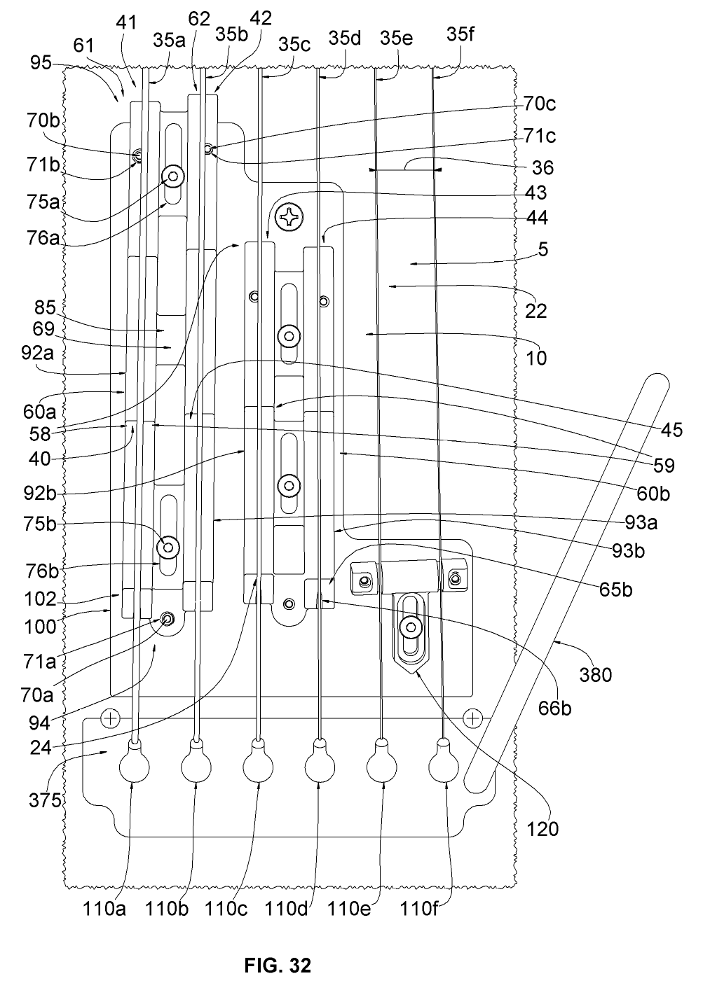

As illustrated in FIGS. 31 and 32, an assembly 22 includes two fretting saddling members 60. A plurality of consecutive strings may be as follows: A proto string 35a, which may be a laterally outermost proximal string, a deutero string 35b, a trito string 35c, and a tetarto string 35d, may be wrist fretting strings. A pempto string 35e and a hecto string 35f may be single direction fretting strings. On a second fretting saddling member 60b, a proximal saddling interface 65a may be farther longitudinally forward of a distal saddling interface 65b. This may be done for intonation purposes with the use of one wound and one unwound string.

As illustrated in FIGS. 31 and 32, an assembly 22 includes two fretting saddling members 60. Each fretting saddling member 60, respective features of the support 100, respective fasteners 75, and respective height screws 70 are basically similar to those for an instrument as shown and described in FIGS. 7-13, with the exceptions that: i) a positioning projection and positioning hole is omitted from each fretting saddling member 60, ii) the assembly omits the positioning screw for each fretting saddling member, iii) a rear wall is omitted from the support 100, iv) the fretting saddling members are longitudinally shorter, having two or three proximal fretting crown segments 40 and two or three distal fretting crown segments 45, v) crosspieces 85 are in alternative locations or fewer in number, vi) stringing openings 110 are flush with the upper support surface 102; in FIG. 32, stringing openings are in a vibrato mechanism 375, vii) on the second fretting saddling member 60b, a proximal saddling interface 65a is longitudinally farther forward than a distal saddling interface 65b, viii) a forward member fastening slot 76a is farther rearward, and ix) a single saddle 120 is adjustably locked to the support for a pempto string 35e and a hecto string 35f.

As illustrated in FIG. 31, a support may have a planar upper support surface 102. A proto string 35a, a deutero string 35b, a trito string 35c, a tetarto string 35d, a pempto string 35e, and a hecto string 35f may insert into a first stringing opening 110a, a second stringing opening 110b, a third stringing opening 110c, a fourth stringing opening 110d, a fifth stringing opening 110e, and a sixth stringing opening 100f in the support, which may be laterally spaced. Each stringing opening may be keyhole shaped, with a hole to accept a ball end of a string rearward of a narrow slot at the forward end of the hole to capture the string and seat the ball end against a lower support surface. The ball ends of the strings may be contained by a body cavity. The stringing openings may establish the lateral positions of the strings at the body 10.

In combination, FIGS. 31 and 32 illustrate the following: Longitudinal positions, vertical positions, and angular positions of fretting saddling members 60 may be adjusted with respective fasteners 75 in a non locking configuration. Each fretting saddling member in FIGS. 31 and 32 may be adjustable in a manner similar to the fretting saddling member in FIGS. 7-13. Without the positioning screw, the longitudinal position of the fretting saddling member is adjustable by manually sliding it by hand. The strings 35 may apply a downward force on a fretting saddling members 60 and may gently hold the fretting saddling members in place on the support 100 with respective fasteners 75 in a non locking configuration. With the fasteners in the non locking configuration and tension on the strings, a gentle application of force with the fingers may adjust the longitudinal position of the fretting saddling member. The position of a fretting saddling member may also be adjusted with tension on or off of the strings. Two fasteners for each fretting saddling member may align that fretting saddling member along a line of longitudinal positioning centered between its two respective strings during vertical, longitudinal, and angular position adjustment. Each fastener 75 may independently lock the longitudinal, lateral, vertical, and angular positions of its fretting saddling member 60.

As illustrated in FIGS. 31 and 32, an assembly 22 may include two fretting saddling members 60. A fretting saddling member may be positioned on and coupled to a planar upper support surface 102 of a support 100. A planar lower support surface may contact a body 10. A vertically and longitudinally adjustable saddle 120, which locks to the upper support surface, contacts and directs a pempto 35e string and a hecto 35f string above a fingerboard to a nut; other saddle designs may alternatively be used. A first fretting saddling member 60a may be used with a proto string 35a and a deutero string 35b. A second fretting saddling member 60b may be used with a trito string 35c and a tetarto string 35d. Each fretting saddling member includes a proximal bar 61 separated from a distal bar 62 by a central longitudinal recess 69. Two stringing openings 110 respective to each fretting saddling member direct two strings 35 to a proximal string guide indentation 66a and a distal string guide indentation 66b of a clearance surface (which may be discontinuous) of that fretting saddling member. On each fretting saddling member, a proximal saddling interface 65a is contacted by a respective string at a rearward critical contact point 24; the proximal saddling interface directs that string at a wrist fretable vertical distance above a sequence of proximal fretting crown segments on the proximal bar, with each proximal fretting crown segment 40 defining a wrist fretable note. On each fretting saddling member, a distal saddling interface 65b is contacted by a respective string at a rearward critical contact point; the distal saddling interface directs that string at a wrist fretable vertical distance above a distal sequence of fretting crown segments on the distal bar; with each distal fretting crown segment 45 defining a wrist fretable note. A rearward height screw 70a may insert into a rearward height adjustment hole 71a in a rearward member end 94 and contact the upper support surface. A proximal forward height screw 70b and a distal forward height screw 70c may insert into a proximal forward height adjustment hole 71b and a distal forward height adjustment hole 71c in a proximal portion and distal portion of a forward member end 95 and contact the upper support surface. A forward fastener 75a may insert through a forward member fastening slot 76a in the fretting saddling member into a forward fastening opening in the support. A rearward fastener 75b may insert through a rearward member fastening slot 76b rearward fastening opening in the support. The member fastening slots may be in crosspieces 85 in the central longitudinal recess. The strings may extend above a fingerboard and a sequence of fingerboard frets to a nut on a neck.

As illustrated in FIG. 32, an instrument 5 includes a plurality of strings. A first fretting saddling member 60a may be coupled to a support 100 on a body 10. An instrument 5 may consecutively include, beginning with a laterally outermost proximal string and ending with a laterally outermost distal string: a proto string 35a, a deutero string 35b, a trito string 35c, a tetarto string 35d, a pempto string 35e, and a hecto string 35f. Two consecutive strings may be laterally spaced at a lateral string spacing 36, center to center, at their rearward critical contact points. The first fretting saddling member 60a may include a first proximal sequence of one string fretting crowns 41 and a first distal sequence of one string fretting crowns 42 positioned for use with the proto string and the deutero string. A first proximal lateral member side 92a of the first fretting saddling member may be laterally proximal to the proto string. A first distal lateral member side 93a of the first fretting saddling member may be laterally between the deutero string and the trito string. A proximal lateral end 58 of each one string fretting crown in a first proximal sequence of one string fretting crowns 41 may be laterally proximal to the proto string. A distal lateral end 59 of each one string fretting crown in a first proximal sequence of one string fretting crowns may be laterally between the proto string and the deutero string. A proximal lateral end 58 of each one string fretting crown in a first distal sequence of one string fretting crowns 42 may be laterally between the proto string and the deutero string. A distal lateral end 59 of each one string fretting crown in a first distal sequence of one string fretting crowns may be laterally between the deutero string and the trito string.

As further illustrated in FIG. 32, an instrument 5 includes two fretting saddling members 60. A second saddling member 60b may be coupled to the support 100. The second fretting saddling member 60b may include a second proximal sequence of one string fretting crowns 43 and a second distal sequence of one string fretting crowns 44, which may be positioned for use with a trito string 35c and a tetarto string 35d. A second proximal lateral member side 92b of the second fretting saddling member may be laterally between the deutero string and the trito string. A second distal lateral member side 93b of the second fretting saddling member may be laterally between the tetarto string and the pempto string. A proximal lateral end 58 of each one string fretting crown in the second proximal sequence of one string fretting crowns 43 may be laterally between the deutero string and the trito string. A distal lateral end 59 of each one string fretting crown in the second proximal sequence of one string fretting crowns may be laterally between the trito string and the tetarto string. A proximal lateral end of each one string fretting crown in the second distal sequence of one string fretting crowns may be laterally between the trito string and the tetarto string. A distal lateral end of each one string fretting crown in the second distal sequence of one string fretting crowns may be laterally between the tetarto string and the pempto string. A first distal lateral member side 93a of a first fretting saddling member 60a may be laterally spaced from a second proximal lateral member side 92b of the second fretting saddling member.

As illustrated in FIG. 32, an assembly 22 includes two fretting saddling members 60. The first fretting saddling member 60a may include a proximal saddling interface and a first proximal sequence of one string fretting crowns 41 (including a first proximal sequence of fretting crown segments), including a first fingerboard matching angle. The first fretting saddling member 60a may include a distal saddling interface and a first distal sequence of one string fretting crowns 42 (including a first distal sequence of one string fretting crown segments), including a second fingerboard matching angle. The second fretting saddling member 60b may include a proximal saddling interface and a second proximal sequence of one string fretting crowns 43 (including a second proximal sequence of fretting crown segments), including a third fingerboard matching angle. The second fretting saddling member 60b may include a distal saddling interface and a second distal sequence of one string fretting crowns 44 (including a second distal sequence of fretting crown segments), including a fourth fingerboard matching angle. Each fretting crown segment may define a wrist fretable note above an open note of its respective string.

As illustrated in FIG. 32, a support 100 of an assembly 22 may include a vibrato mechanism 375. The support may include a base for the fretting saddling member and the saddle and the vibrato mechanism, which may include a first stringing opening 110a, a second stringing opening 110b, a third stringing opening 110c, a fourth stringing opening 110d, a fifth stringing opening 110e, and a sixth stringing opening 110f, which hold the ball ends of the strings 35. Pushing or pulling on a whammy bar 380 may result in a vibrato action. In an additional or alternative embodiment, other vibrato mechanism features, such as those of double locking vibratos are included.

An assembly may include a pickup.

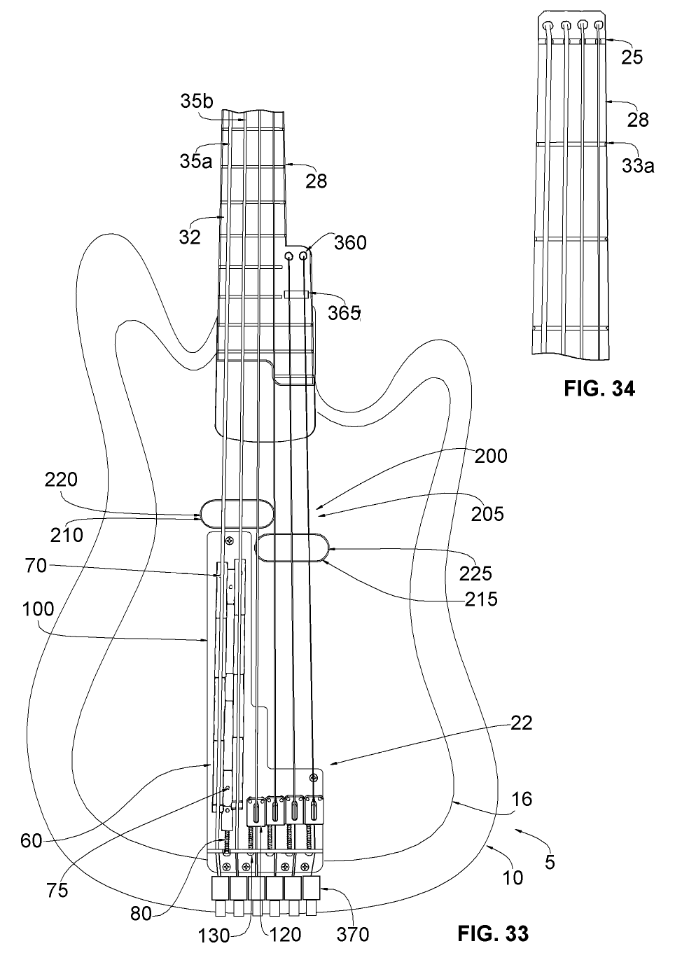

In combination, FIGS. 33 and 34 illustrate the following: An instrument 5 may include a body 10 and a neck 28. A proximal lateral opening 210 and a distal lateral opening 215 of a pickup opening 205 may accommodate the positioning of fretting crown segments under a proto string 35a, which may be a laterally outermost proximal string, and a consecutive string, which may be a deutero string 35b. A pickup 200 may include a proximal lateral coil 220 inserted into the proximal lateral opening, and may include a distal lateral coil 225 inserted into the distal lateral opening. The proximal lateral opening and proximal lateral coil may be under the proto string and the deutero string, between a fretting saddling member 60 and the fingerboard 32. The proximal lateral opening and proximal lateral coil of may be longitudinally farther forward than the distal lateral opening and distal lateral coil. The distal lateral opening and the distal lateral coil may be distal to a foremost fretting crown or crowns of the fretting saddling member and may be under an outermost distal string and a consecutive string.

In an additional or alternative embodiment, the proximal lateral opening 210 and the proximal coil are under the proto string and the deutero string, and the distal lateral opening 215 and distal coil are under a trito string and a tetarto string. In additional or alternative embodiments, any assembly may incorporate a pickup with a proximal lateral coil and a distal lateral coil.

In combination, FIGS. 33 and 34 further illustrate the following: An instrument 5 may include a body 10 and a neck 28. An assembly 22 may include a pickguard 16. Pickguard screws may couple the pickguard to a body 10 of an instrument 5 through pickguard screw holes of the pickguard. The pickguard may partly cover a body cavity of the body. A support 100 may be coupled to the pickguard, the pickguard may be combined with a support, or they may be mounted separately. A fretting saddling member 60 may be coupled to the support, which may be coupled to the pickguard or to the body. The pickguard may include a pickup opening 205, and may couple a pickup 200 to the body. The pickguard and/or a support may align a fretting saddling member, a pickup opening, and a pickup, with a string 35.

In combination, FIGS. 33 and 34 illustrate the following: An instrument 5 may include a body 10 and a neck 28. A headless tuning machine 370 may be positioned on a body 10 as a part of an assembly 22; the respective string may not require a tuning machine on the neck. A headless tuning machine for each string, or a subset of strings may be coupled to the body. If no strings require tuners on a headstock, a headstock may be omitted and a headless headpiece or the like may be used as a nut 25. The support, the fretting appendage, and the other components on the support in FIGS. 33 and 34 are the same as those in FIGS. 7-13; instead of ball ends of strings seating at the rear wall, the strings pass through the stringing openings to the headless tuners.

In combination, FIGS. 33 and 34 illustrate the following: An instrument 5 may include a body 10 and a neck 28. In FIGS. 33 and 34, the features on the support (in front of the headless tuning machines) are similar to those shown and described in FIGS. 7-14. and the support 100, fretting saddling member 60, fasteners 75, saddles 120, intonation screws 130, positioning screw 80, and height screws 70 may be similar to those shown and described with respect to an instrument in FIGS. 7-14.

In combination, FIGS. 33 and 34 illustrate: An instrument 5 may include a body 10 and a neck 28. A string anchor 360 allowing attachment and a mini nut 365 for a laterally outermost distal string may be incorporated into a distal portion of the neck 28, longitudinally forward of the first fingerboard fret 33a and longitudinally rearward of a rearmost fingerboard fret.

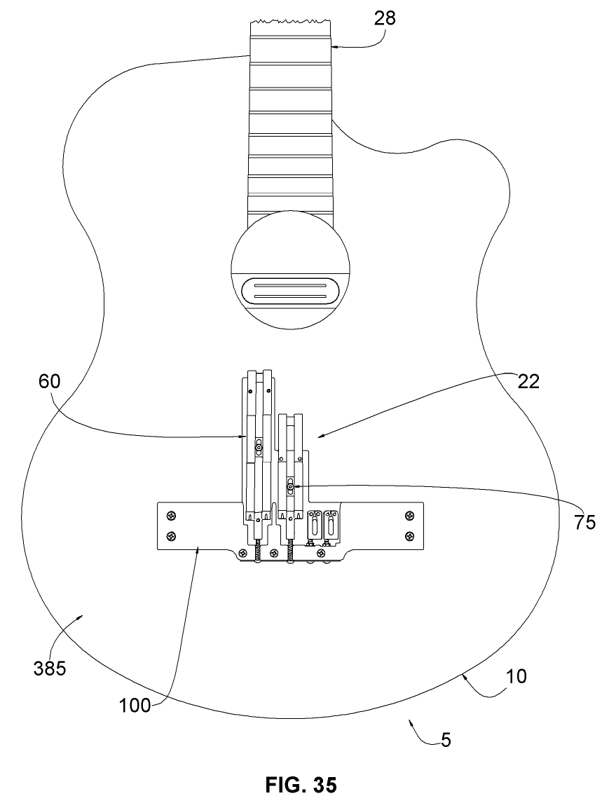

As illustrated in FIG. 35, an assembly 22 on an acoustic stringed musical instrument 5 with a neck 28 includes a support 100 and a fretting saddling member 60 positioned on and coupled to a soundboard 385 of a hollow body 10. The instrument may have an acoustic guitar form. A fastener 75 and the support may connect and couple a fretting saddling member 60 to the soundboard. The support and fretting saddling members may be lightweight materials. The features and functions of the assembly in FIG. 35 are similar to those in FIGS. 7-14.

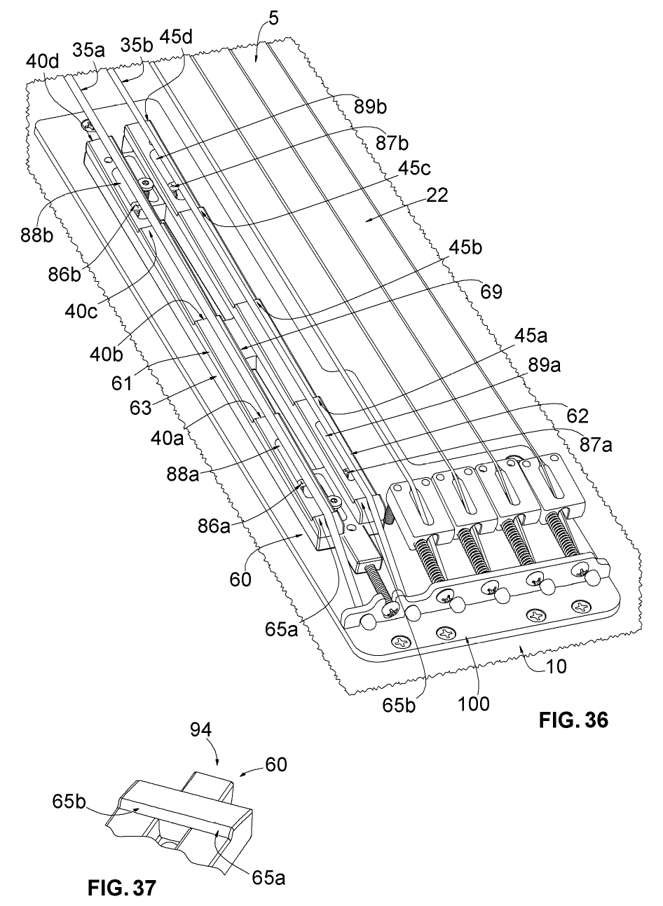

As illustrated in FIG. 36 a fretting saddling member 60 is attached to a support 100 on a body 10 of an instrument 5 as part of an assembly 22. The fretting saddling member may include a platform block 63 to which a proximal bar 61 (in the form of an adjustably positionable bar block) is coupled. The proximal bar may include a proximal saddling interface 65a, a first proximal fretting crown segment 40a, a second proximal fretting crown segment 40b, a third proximal fretting crown segment 40c, and a fourth proximal fretting crown segment 40d. The proximal bar is coupled to the platform block with a first proximal bar intonation screw 86a in a first proximal bar slot under a first proximal bar intonation recess 88a, which inserts into a first proximal platform opening in the platform block and a second proximal bar intonation screw 86b in a second proximal bar slot under a second proximal bar intonation recess 88b, which inserts into a second proximal platform opening in the platform block. A central longitudinal recess 69 separates the proximal bar from a distal bar 62 (in the form of an adjustable positionable bar block) which is coupled to the platform block. A first distal bar intonation screw 87a inserts through a first distal bar slot under a first distal bar intonation recess 89a into a first distal platform opening in the platform block. A second distal bar intonation screw 87b inserts through a second distal bar slot under a second distal bar intonation recess 89b into a second distal platform opening in the platform block. The distal bar includes a distal saddling interface 65b, a first distal fretting crown segment 45a, a second distal fretting crown segment 45b, a third distal fretting crown segment 45c, and a fourth distal fretting crown segment 45d. The proximal bar is configured to work with the proto string 35a, and the distal bar is configured to work with the deutero string 35b. The longitudinal positions of the bars on the platform block may be adjusted with the respective intonation screws. The vertical positions of the bars (including independent adjustments of vertical positions of their forward and rearward ends) may be adjusted by inserting shims between the platform block and the bars. The fretting saddling member may be a shaped and assembled block including a platform block and one or more adjustable bar blocks.

As illustrated in FIG. 37 a fretting saddling member 60 includes a rearward member end 94. The fretting saddling member includes a proximal saddling interface 65a and a distal saddling interface 65b on a single ridge. Additional or alternative embodiments include string guide indentations for two strings. Saddling interfaces in this form may be used with any fretting saddling member in this disclosure.

A support 100 may acoustically couple a fretting saddling member 60 to the soundboard 385 of a hollow body 10 of an acoustic guitar. A fastener 75 coupling a fretting saddling member to a soundboard may be within 80 mm of a rearward critical contact point of a string on the fretting saddling member. The support may include a threaded insert (forming a fastening opening), which inserts into an opening in the soundboard. The fastener may insert into the fastening opening. A support may include multiple components, which may be separately connected to the body of the guitar. For example, a support might include several small threaded inserts, posts, bolts, or other attachment points. Although the fretting saddling member is “on” the support and “on” the body, this is not intended to imply that the fretting saddling member is necessarily above the support. The fretting appendage may be positioned where it can be accessed by the player to play notes. A fretting appendage on a support may be coupled between two components of a support, attached to a threaded hole, suspended from the support, or may have an alternative geometric relationship with the support. A fretting appendage "on" a body may be partly inside the body; what is meant is that it is positioned to be used about the body.

In some embodiments, a longitudinal distance from a nut 25 to a fastener 75 coupling a fretting saddling member 60 to a body 10 and/or a support 100 is less than 79% of a neck scale length. In some embodiments, a longitudinal distance from a nut to a fastener 75 coupling a fretting saddling member to a body and/or a support is greater than or equal to 79%, 84%, 89%, and/or 94% of a neck scale length. In some embodiments, the fastener may couple the fretting saddling member to a soundboard included by a hollow body.

An assembly 22 may include a longitudinal slot such as a member fastening slot or a support fastening slot, which may run substantially longitudinally. A longitudinal slot may restrict the lateral position of a fretting saddling member 60, while allowing adjustment of the longitudinal position, vertical position, and angular positions of the fretting saddling member. An insert, which may be a fastener 75 (in an alternative embodiment, it may be a height screw 70, a portion of a fretting saddling member, a portion of a support 100, and/or another feature) may be inserted into a longitudinal slot. A longitudinal slot may be in a support or in a fretting saddling member. With a longitudinal slot in a support, the insert may insert into the longitudinal slot and connect to the fretting saddling member; the longitudinal position of the fretting saddling member and the insert may be adjusted by manipulating them (sliding them) along the longitudinal slot. With a longitudinal slot in the fretting saddling member, the insert may insert into the longitudinal slot and connect to the support; the longitudinal position of a fretting saddling member may be adjusted by sliding the longitudinal slot along the insert. A longitudinal slot may include a proximal guide surface and a distal guide surface, which may contact the insert. One or more longitudinal slots and one or more fastening openings 113 may be centered between a proximal string and a distal string associated with a fretting saddling member. In an additional or alternative embodiment, a longitudinal slot includes one or more barriers, a movable block, a screw, or another feature, and may be adjustable. The longitudinal position of the fretting saddling member may be adjusted by sliding it using multiple longitudinal slots and/or multiple inserts. A fretting saddling member may be centered between and aligned with its two respective strings by two longitudinally spaced inserts.

The fretting saddling member 60 may include, or may be, a shaped or assembled block of a material or several materials. It may be solid, hollow, or skeletonized, and may include multiple components, such as a threaded insert or a piece of fretwire. It may include flat, bent, curved, rounded, angular, or decorative surfaces. It may include a material such as a metal, a polymer, a composite, or a natural substance, and may include surfaces such as may be made from sheet metal. A block making up a fretting saddling member may include a rectilinear shape or a non rectilinear shape, and may include flat or curved surfaces such as might be made from sheet metal. The block may include a proximal fretting crown segment 40, a distal fretting crown segment 45, a proximal bar 61, a distal bar 62, a proximal saddling interface 65a, a distal saddling interface 65b, a proximal string guide indentation 66a, a distal string guide indentation 66b, a clearance surface 67, a positioning projection 68, a central longitudinal recess 69, a height adjustment hole 71, a member fastening slot 76, a positioning hole 81, a crosspiece 85, an upper member surface 90, a downward member surface 91, a proximal lateral member side 92, a distal lateral member side 93, a rearward member end 94 and/or a forward member end 95. Any feature or function of a fretting saddling member in this document may be included by the block having the fretting saddling member.

A fretting crown or a saddling interface 65 may be formed from fretwire or another firm material and attached to a fretting saddling member 60, or may be shaped into the material of the fretting saddling member, and may face upward. A lateral end of a fretting crown or a saddling interface may be beveled, rounded, or both. A fretting crown may run substantially perpendicularly to the line of its respective string or strings. A fretting crown or a saddling interface may be angled around a vertical axis at a range of angles at which “fanned frets” may function. A fretting crown may be arched. Lateral ends of fretting crowns may be coterminous with lateral member sides of the fretting saddling member and/or with edges of an upper member surface of the fretting saddling member. A fretting saddling member may be independently longitudinally and vertically positionable of another fretting saddling member, a fretting appendage 300, and of saddles 120. A string guide indentation 66 may be shaped into the material of a fretting saddling member. Two string fretting crowns and one string fretting crowns may each be positioned on the same fretting saddling member 60. A fretting appendage with a proximal and a distal fretting crown segment with the same ordinal number, or for making the same interval above respective strings, may incorporate them as parts of two one string fretting crowns or of a two string fretting crown.

In some embodiments, a sequence of fretting crown segments under a proto string 35a includes one, two, three, or four fretting crown segments. In additional or alternative embodiments, a sequence of fretting crown segments under a deutero string 35b includes one, two, three, or four fretting crown segments. In additional or alternative embodiments, a sequence of fretting crown segments under a trito string 35c includes one or two fretting crown segments. In additional or alternative embodiments, a sequence of fretting crown segments under a tetarto string 35d includes one or two fretting crown segments. In additional or alternative embodiments, a sequence of fretting crown segments under the pempto string 35e includes one fretting crown segment. In additional or alternative embodiments, a sequence of fretting crown segments under a hecto string 35f includes one fretting crown segment. Each fretting crown segment may be positioned farther from, at, or nearer than, a nominal oddment length of a respective interval from a rearward critical contact point 24 of a respective string. In a sequence of fretting crown segments, a first, a second, a third, and a fourth fretting crown segment may be respective to the intervals of a semitone, a whole step, a minor third, and a major third. Each fretting segment may be positioned on an instrument 5 as part of a fretting saddling member 60 or a fretting appendage 300.

In an alternative embodiment, a fretting saddling member 60 includes a rearward member end and a forward member end. A proximal rearward height adjustment hole may be located proximally in a rearward member end, or in a support under a proximal portion of the rearward member end. A distal rearward height adjustment hole may be located distally in the rearward member end, or in the support under a distal portion of the rearward member end. A forward height adjustment hole may be centered between the two strings respective to the fretting saddling member 60 in a forward member end, or in the support under a forward member end. The forward height screw may adjust a vertical position of a forward member end. The proximal and distal rearward height screw may adjust the vertical position of a proximal portion and distal portion of a rearward member end, may adjust the vertical position of the rearward member end, and may adjust the angular position of the fretting saddling member around a substantially longitudinal axis. The three height screws may adjust the vertical position of the fretting saddling member and the angle of one or more sequences of fretting crowns to the strings, which have their vertices at the saddling interfaces.

In some embodiments, a height screw is a headless screw. In additional or alternative embodiments, the height screw has another screw form, such as a screw with a head. In an additional or alternative embodiment, a height adjustment hole includes a threaded insert. A proximal height adjustment hole may be in a support or in a fretting saddling member. A distal height adjustment hole may be in a support or in a fretting saddling member. A rearward height adjustment hole may be in a support or in a fretting saddling member.

When wrist fretting, a player may use a picking hand 345 to change a note of a string 35. The pisiform bone wrist area 355 of the picking hand may be used to depress the string immediately rearward of a fretting crown segment, between the fretting crown segment and a rearward critical contact point 24 of the string until the string contacts the fretting crown segment, shortening the sounding length of the string. The string may be directly contacted with the skin of the wrist. If the chosen fretting crown segment is a part of a sequence of fretting crown segments, the contact point of the wrist with the string may be between the chosen fretting crown segment and the next fretting crown segment in the direction of the rearward critical contact point. A shortened sounding length of the string between the fretting crown segment and a nut may then be plucked with the picking hand thumb to produce sound. When wrist fretting, the wrist may move the string to the fretting crown segment, and the fretting crown segment may remain stationary. When using the pisiform bone wrist area of the picking hand to wrist fret, the thumb and fingers of the picking hand may be free to pluck any string, and the fretting hand may be left free. While wrist fretting with the picking hand, the fretting hand 350 may be used to fret fretted fingerboard notes on strings which are distal to the wrist fretting string. This may enable new combinations of low pitched wrist fretted notes and higher pitched fretted fingerboard notes.

A player may play a wrist fretted note on a wrist fretting string, play an open note on the wrist fretting string, or play a fretted fingerboard note on the wrist fretting string. A player may switch between multiple wrist fretable notes defined by a sequence of fretting crown segments under a string. A player may switch between wrist fretable notes playable on two wrist fretting strings. These actions may be performed rapidly; the player may switch from one to another in a fraction of a second. While playing a wrist fretted note, strings which may be distal to the wrist fretting string may be used to play fretted fingerboard notes and open notes. Any string may be equipped with fretting crown segments, and wrist fretting may be performed with the fretting crown segments under any string.

Several arrangements of features of a fretting saddling member are described in this document. This paragraph will review how features may be arranged on a fretting saddling member. A proximal saddling interface 65a may be farther forward than, longitudinally even with, or farther rearward than a distal saddling interface 65b. A first proximal fretting crown segment may be positioned i) nearer than, ii) exactly at, or iii) farther than a nominal semitone oddment length from the proximal saddling interface. A second proximal fretting crown segment may be positioned i) nearer than, ii) exactly at, or iii) farther than a nominal whole step oddment length from the proximal saddling interface. A third proximal fretting crown segment may be positioned i) nearer than, ii) exactly at, or iii) farther than a nominal minor third oddment length from the proximal saddling interface. A fourth proximal fretting crown segment may be positioned i) nearer than, ii) exactly at, or iii) farther than a nominal major third oddment length from the proximal saddling interface. A first distal fretting crown segment may be positioned i) nearer than, ii) exactly at, or iii) farther than a nominal semitone oddment length from the distal saddling interface. A second distal fretting crown segment may be positioned i) nearer than, ii) exactly at, or iii) farther than a nominal whole step oddment length from the distal saddling interface. A third distal fretting crown segment may be positioned i) nearer than, ii) exactly at, or iii) farther than a nominal minor third oddment length from the distal saddling interface. A fourth distal fretting crown segment may be positioned i) nearer than, ii) exactly at, or iii) farther than a nominal major third oddment length from the distal saddling interface. A fretting saddling member may have only one sequence of fretting crown segments. A sequence of fretting crown segments may have one, two, three, four, or more fretting crown segments. These variations may be used on any fretting saddling member.

This paragraph continues the review of how features may be arranged on a fretting saddling member. Each fretting crown segment in a sequence of fretting crown segments may be positioned i) the same amount nearer than, ii) exactly at, or iii) the same amount farther than a nominal oddment length of its respective interval from a saddling interface. Alternatively, fretting crowns in a sequence of fretting crown segments may be positioned at individualized distances from the saddling interface. Relative to a proximal saddling interface, proximal fretting crown segments may be i) at the same distances that, or ii) at different distances than distal fretting crown segments are relative to a distal saddling interface. These variations may be used on any fretting saddling member.

This paragraph continues the review of how features may be arranged on a fretting saddling member. A fretting saddling member may include a proximal sequence of fretting crown segments, a distal sequence of fretting crown segments, or both. The proximal sequence of fretting crown segments may be omitted or may include one, two, three, four, or more fretting crown segments. The distal sequence of fretting crown segments may be omitted or may include one, two, three, four, or more fretting crown segments. In some embodiments, the number of proximal fretting crown segments and the number of distal fretting crown segments are independent of one another. A fretting crown segment may be included by a one string fretting crown. In an additional or alternative embodiment, a proximal fretting crown segment and a distal fretting crown segment with the same ordinal number are included by a two string fretting crown. A proximal sequence of fretting crown segments may include a first fingerboard matching angle matching a first fingerboard angle. A distal sequence of fretting crown segments may include a second fingerboard matching angle matching a second fingerboard angle. These variations may be used on any fretting saddling member. With multiple fretting saddling members, a second fretting saddling member may include a third and a fourth fingerboard matching angle.

For some players, certain lateral widths and longitudinal lengths of features of an assembly 22 may enable wrist fretting while minimizing unintentional contact of the assembly with the picking hand 345. Some players may find a fretting saddling member 60 with a narrower lateral width or a shorter longitudinal length minimizes unintentional contact with the hand. Some players may find that a forward extent of a fretting saddling member, which is farther from a nut 25 and nearer to a saddling interface minimizes unintentional contact with the hand. A laterally narrow and longitudinally short fretting saddling member may be light in weight, and may be positioned comparatively near other parts of an assembly, such as a pickup 200 or a consecutive fretting saddling member or fretting appendage.

Some players may prefer the smooth continuity of two string fretting crowns 38, while other players may prefer having space for their picking hand 345 fingers in a central longitudinal recess 69 between one string fretting crowns 37. A fretting crown may include a proximal lateral end 58 and a distal lateral end 59. By positioning the proximal lateral ends of fretting crowns and/or lateral member sides of a fretting saddling member 60 laterally near to a string 35 being wrist fretted, room for the picking hand fingers may be provided. The lateral width of the central longitudinal recess may provide room for picking hand fingers to manipulate the strings. Laterally narrow proximal bars, distal bars, and fretting crowns may provide room for a player’s fingers that some players may enjoy.

A player may switch among playing a wrist fretted note on a wrist fretting string, playing a fretted fingerboard note on that string, and playing that string as an open string. A simultaneous wrist fretting and fingerboard fretting action on the same string is possible, but may result in unorthodox pitches.

A support may include a metal, a polymer, a composite, or a natural substance. A support 100, including the rear wall 105, may be shaped by being bent, welded, molded, and/or machined. A support may include a pickup opening 205 or a shim 115. The shim may act as a guide surface of the support. A support may be coupled to a body 10 with support screws 99, with adhesives, or other by another coupling method. A support may include multiple components. One or more saddles on the support may each contact one or more strings 35. A support may include a saddle slot for an acoustic saddle, which may be a thin bar of a hard material. A saddle 120 may be shaped or angled to position rearward critical contact points of one or more strings. A support or a saddle may incorporate bridge features of electric, acoustic, flat top, or arched top instruments. A support or a saddle may incorporate bridge features of fixed or vibrato bridges, such as a vibrato mechanism. A support or a saddle may be adapted for use with a string bending device, a headless tuner which may mount on the body, a fine tuner, a separate string retainer, string through body string attachment, or another feature which may be included by the assembly. A saddle may be fully or partly integrated with a support. A support, a fastener, and a positioning screw may be vertically lower than saddling interfaces of a fretting saddling member. In some embodiments, a support of a fretting saddling member may be at least partly laterally between a laterally outermost proximal string and a laterally outermost distal string. A feature of a support, such as a longitudinal slot or a fastening opening, which is centered between two strings may be laterally between those two strings.

An assembly 22 may include a saddle means positionable on the body 10 of the instrument 5. A saddle means may be one or more saddles 120, or a saddling interface 65 of a fretting saddling member 60. A string 35 may contact the saddle means at a rearward critical contact point, and extend above the neck to a forward critical contact point on the nut. A fretting saddling member, which may be used for wrist fretting with a respective string, may be adjustably positionable relative to a saddle means of a consecutive string. An instrument may include saddle means for multiple strings. A saddle of a saddle means may be an acoustic or electric type saddle, and may be of a hardtail or a vibrato type; a saddle of a saddle means may be configured for a single string or for multiple strings. A saddle of a saddle means may be shaped or angled to position a rearward critical contact point of a string in an intonated position.

In some embodiments, a string 35 may be brought into contact with a fretting crown segment by a finger or another part of the picking hand 345.

In some embodiments, wrist fretting may be combined with slide guitar, flat picking, slapping, tapping, and other techniques.

A sequence of fretting crown segments on a fretting saddling member may be numbered starting with the fretting crown segment closest to the saddling interface. A fretting crown may have the same ordinal number as a fretting crown segment it includes. Both chromatic and diatonic sequences of fretting crown segments may be constructed.

It may be useful to provide a neck 28 with a specific number of fingerboard frets, and to place a rearmost fingerboard fret under laterally distal strings, but not under laterally proximal strings. A rearmost fingerboard fret may be a 24^{th}, 23^{rd}, 22^{nd}, 21^{st}, 20^{th}, 19^{th}, 18^{th}, 17^{th}, 16^{th}, 15^{th}, 14^{th}, 13^{th}, or 12^{th} fingerboard fret.

A flat fingerboard 32 on a neck 28 may enable fretting saddling members 60 to be interchangeable between pairs of strings 35. A flat fingerboard like that of a classical guitar may be described as having a “flat radius” or an “infinite radius.” On a neck with a curved surface, relative to one another, two fingerboard matching angles of a fretting saddling member may be the same regardless which two strings the fretting saddling member is paired with; although it may require tilting the fretting saddling member with the height screws, any fretting saddling member with fingerboard matching angles for one pair of strings may be used to match any two fingerboard angles associated with another pair of strings.

Lightweight tuning machines 27 may lessen the need to support a neck 28 with the fretting hand 350 during a wrist fretting action. A lightweight tuning machine, having a mass of less than 70 grams (or 70 grams per tuner per string if tuning machines are connected), may tension a string 35, and may be mounted on a headstock 26.

An instrument may be strung with steel, nylon, and other strings.

An instrument 5 may be tuned to an alternate tuning.

An assembly 22 may include a piezoelectric pickup.

An instrument 5 may include a fretted fingerboard 32. Alternatively, an instrument may include a fretless fingerboard; an instrument with a fretless fingerboard may be otherwise similar to fretted instruments.

An instrument 5 may include features of a six; seven; or eight string electric guitar or acoustic guitar, four; five; or six string bass guitar, banjo, ukulele, steel guitar, zither, or other instrument. The instrument may include features of a fretless variant of one of these.

Fingerboard frets 33 of an instrument 5 may include a diatonic or a microtonal spacing. A sequence of fretting crown segments may be positioned on a fretting saddling member 60 relative to a respective saddling interface 65 to define diatonic or microtonal wrist fretable notes. A described intonation method may be used to intonate a saddling interface and a sequence of fretting crown segments of an instrument with a diatonic or a microtonal spacing. In some embodiments, an instrument 5 includes a varied number of strings 35, such as four, five, six, seven, eight, nine, ten, eleven, or twelve. An instrument may include an extra neck 28 or harp guitar strings.

A fretting saddling member may be configured to be positioned on a soundboard of a hollow body of an instrument. A support may be configured to couple the fretting saddling member to a soundboard. A fastener may be configured to couple the block to the support within 80 mm of a longitudinally rearward critical contact point of a respective string.

Some positions and dimensions may be understood by comparison with a lateral string spacing 36. Some positions and dimensions may be understood by comparison with a neck scale length, a nominal sounding length, or a nominal oddment length. Some positions and dimensions may be understood by comparing relative positions of features. Some distances and positions may be understood by comparing them to the distance from a first fretting crown segment to its respective saddling interface.

In one example, a change of .127 mm in a position of a fingerboard fret, a fretting crown segment, or a critical contact point of a string may be noticeable to some users. In a second example, a position of a feature may be adjusted by less than .127 mm. To continue the second example, an assembly may include a M3x0.5 screw as a positioning screw 80; turning the M3x0.5 screw a quarter of a turn may adjust a longitudinal position of a respective fretting saddling member by about .125 mm; for finer adjustment, the screw may be turned an eighth of a turn. Distances of feature position adjustment for intonation purposes may vary with string type, string thickness, string height, and scale length.

A neck scale length and a lateral string spacing 36 included by an instrument 5 may be typical of a guitar or a bass guitar. However, an instrument may include a neck scale length as long or longer than a neck scale length of a double bass or as short or shorter than a neck scale length of a ukulele. Strings of an instrument may have a lateral string spacing as wide or wider than a lateral string spacing of a double bass or as narrow or narrower than a lateral string spacing of a ukulele.

In some embodiments, a neck scale length is less than 300 mm. In some embodiments, a neck scale length is more than 1200 mm. In some embodiments, a neck scale length is from 300 mm to 1200 mm. In some embodiments, a neck scale length is from 500 mm to 900 mm.

In some embodiments, a lateral string spacing is less than 7.5 mm. In some embodiments, a lateral string spacing is more than 40 mm. In some embodiments, a lateral string spacing is from 7.5 mm to 40 mm. In some embodiments, a lateral string spacing is from 9 mm to 25 mm.

In some embodiments, a longitudinal length of a fretting saddling member is greater than 34% of a neck scale length. In some embodiments, a longitudinal length of a fretting saddling member is less than or equal to 34%, 30%, 26%, 21%, 16%, 11%, or 6% of a neck scale length.

In some embodiments, a pickup is coupled to a body, under a string, such that at least part of the pickup is within 75% of a neck scale length from the nut. In some embodiments, a pickup is coupled to a body, under a string, such that at least part of the pickup is at a distance equal to or greater than 75% 79%, or 84% of a neck scale length from a nut.

A fretting saddling member 60 may contact a proximal string and a distal string, which may be consecutive and laterally spaced. A proximal lateral member side 92 of a fretting saddling member may be laterally proximal to the proximal string and at a lateral distance (ignoring any difference in vertical position) greater than 100% of a lateral string spacing from the proximal string. A proximal lateral member side 92 of a fretting saddling member may be laterally proximal to the proximal string and at a lateral distance (ignoring any difference in vertical position) equal to or less than 100%, 50%, 30%, 20%, 15%, or 10% of a lateral string spacing 36 from the proximal string. A distal lateral member side 93 of a fretting saddling member 60 may be laterally distal to the distal string and at a lateral distance greater than 100% of a lateral string spacing (ignoring any difference in vertical position) from the distal string. A distal lateral member side 92 of a fretting saddling member may be laterally distal to the distal string and at a lateral distance (ignoring any difference in vertical position) equal to or less than 100%, 50%, 30%, 20%, 15%, or 10% of a lateral string spacing 36 from the distal string.

A fretting saddling member may include a sequence of fretting crowns which is under a string. A fretting crown may be a one string fretting crown, a two string fretting crown, or a fretting crown of a greater width. The fretting crown may include a proximal lateral end and a distal lateral end. In some embodiments, a lateral end of a fretting crown, measured in a lateral direction only (ignoring any difference in vertical position), is more than 100% of a lateral string spacing from the string. In some embodiments, a lateral end of a fretting crown, measured in a lateral direction only, (ignoring any difference in vertical position) is 100% or less, 75% or less, 50% or less, 40% or less, 30% or less, 25% or less, 20% or less, 15% or less, or 10% or less, of a lateral string spacing from the string.

A fretting saddling member may include a saddling interface and a respective string guide indentation, and may be associated with a rearward height adjustment hole, which may be in the fretting saddling member or in a support. In some embodiments, the rearward height adjustment hole is farther than 300% of a lateral string spacing from the saddling interface and/or the string guide indentation. In some embodiments, the rearward height adjustment hole is at a distance less than or equal to 300%, 200%, or 150% of a lateral string spacing from the saddling interface and/or the string guide indentation.

In some embodiments, a longitudinal distance from a nut to a forward extent of a fretting saddling member is less than 70% of a neck scale length. In some embodiments, a longitudinal distance from a nut to a forward extent of a fretting saddling member is greater than or equal to 70%, 74%, 79%, 84%, 89%, or 94% of a neck scale length.

In some embodiments, a lateral width of a fretting saddling member is greater than 500% of a lateral string spacing. In some embodiments, a lateral width of a fretting saddling member is less than or equal to 500%, 400%, 300%, or 200% of a lateral string spacing. In some embodiments, a fretting saddling member is laterally wider than 60 mm. In some embodiments, a lateral width of a fretting saddling member is less than or equal to 60 mm, 50 mm, 40 mm, 30 mm, or 25 mm.

In some embodiments, a lateral width of a fretting crown is greater than 500% of a lateral string spacing. In some embodiments, a lateral width of a fretting crown is less than or equal to 500%, 400%, 300%, or 200%, 100%, 75%, 50%, or 40% of a lateral string spacing. In some embodiments, a fretting crown is laterally wider than 60 mm. In some embodiments, a lateral width of a fretting crown is less than or equal to 60 mm, 50 mm, 40 mm, 30 mm, 20 mm, 15 mm, 10 mm, or 8 mm. A fretting crown may be a one string fretting crown, a two string fretting crown, or a three or more string fretting crown.

In some embodiments, a lateral distance between a first pivot point and a second pivot point (for example, points at which two height screws are used for pivoting) of a fretting saddling member on a support is greater than 60 mm. In some embodiments, a lateral distance between a first pivot point and a second pivot point of a fretting saddling member on a support is less than or equal to 60 mm, 50 mm, 40 mm, 30 mm, 20 mm, or 10 mm.

A fastener or the height screw respective to a fretting saddling member may tilt from 0 degrees to about 17 degrees. A fastener or the height screw may tilt more than 17 degrees.

In some embodiments, an intonated note, above an open note of a string tuned to concert pitch, may be understood to be within 20 cents, 15 cents, 10 cents, and/or 7 cents of concert pitch.

At a point under a fretting saddling member, a vertical thickness of the support to which the fretting saddling member is coupled may be greater than 3 mm. At a point under a fretting saddling member, a vertical thickness of the support to which the fretting saddling member is coupled may be less than or equal to 3 mm, 2.5 mm, 2 mm, 1.5 mm, and/or 1 mm.

A fretting saddling member may include a sequence of fretting crown segments and respective saddling interface. In a chromatic spacing, a first, a second, a third, and a fourth fretting crown segment may be associated with intervals of a semitone, a whole step, a minor third, and a major third. For each of a first, a second, a third, and a fourth fretting crown segment, a nominal oddment length respective to that fretting crown segment’s associated interval may be i) 0 mm to 2 mm less than, ii) equal to or up to .127 mm greater than, iii) from .127 mm to .5 mm greater than, iv) from .5 mm to 1.5 mm greater than, v) from 1.5 mm to 5 mm greater than, or v) from 5 mm to 10 mm greater than the distance between that fretting crown segment and the respective saddling interface. Each fretting crown segment may be included by a one string fretting crown, by a two string fretting crown, or by a fretting crown of a greater width.

On a fretting saddling member, a proximal saddling interface may be longitudinally even with a distal saddling interface. On a fretting saddling member a proximal saddling interface may be from 0 mm to 50 mm farther longitudinally rearward than a distal saddling interface. On a fretting saddling member a proximal saddling interface may be from .127 mm to 50 mm farther longitudinally rearward than a distal saddling interface. On a fretting saddling member a proximal saddling interface may be from .25 mm to 50 mm farther longitudinally rearward than a distal saddling interface. On a fretting saddling member a proximal saddling interface may be from .375 mm to 50 mm farther longitudinally rearward than a distal saddling interface. On a fretting saddling member a proximal saddling interface may be from .5 mm to 50 mm farther longitudinally rearward than a distal saddling interface.

On a fretting saddling member a distal saddling interface may be from 0 mm to 50mm farther longitudinally rearward than a proximal saddling interface. On a fretting saddling member a distal saddling interface may be from .25 mm to 50 mm farther longitudinally rearward than a proximal saddling interface. On a fretting saddling member a distal saddling interface may be from .5 mm to 50 mm farther longitudinally rearward than a proximal saddling interface.

An assembly of an instrument may include a fretting saddling member including a proximal saddling interface and a proximal sequence of fretting crown segments. The proximal sequence of fretting crown segments may include a first, a second, a third, and a fourth proximal fretting crown segment. The fretting saddling member may include a distal saddling interface and a distal sequence of fretting crown segments. The distal sequence of fretting crown segments may include a first, a second, a third, and a fourth distal fretting crown segment. The instrument may include a nut, a first, a second, a third, and a fourth fingerboard fret. A proto string forward critical contact point may be on the nut. A proto string rearward critical contact point may be on the proximal saddling interface. A deutero string forward critical contact point may be on the nut. A deutero string rearward critical contact point may be on the distal saddling interface. The deutero string may be consecutive to the proto string.

A first distance may be equal to or greater than, at least .127 mm greater than, at least .25 mm greater than, at least .5 mm greater than, at least 1 mm greater than, at least 2 mm greater than, or at least 3 mm greater than a second distance. This may include one or more of the following: i) First distance: From a proto string rearward critical contact point to a twelfth fingerboard fret. Second distance: From a proto string forward critical contact point to the twelfth fingerboard fret. ii) First distance: From a deutero string rearward critical contact point to the twelfth fingerboard fret. Second distance: From a deutero string forward critical contact point to the twelfth fingerboard fret. iii) First distance: From the proto string forward critical contact point to the proto string rearward critical contact point. Second distance: From the deutero string forward critical contact point to the deutero string rearward critical contact point. iv) First distance: From an ordinally numbered fretting crown segment of the proximal sequence of fretting crown segments to the proto string forward critical contact point. Second distance: From a fingerboard fret having the same ordinal number to the proto string rearward critical contact point. v) First distance: From an ordinally numbered fretting crown segment of the distal sequence of fretting crown segments to the deutero string forward critical contact point. Second distance: From a fingerboard fret having the same ordinal number to the deutero string rearward critical contact point. vi) First distance: From an ordinally numbered fretting crown segment of the proximal sequence of fretting crown segments to the proto string forward critical contact point. Second distance: From a fretting crown segment having the same ordinal number of the distal sequence of fretting crown segments to the deutero string forward critical contact point.

A fretting saddling member may include a proximal saddling interface, a distal saddling interface, and a first proximal fretting crown segment longitudinally forward of the proximal saddling interface. In some embodiments, the distance from the proximal saddling interface to a longitudinally forward extent of the fretting saddling member is greater than 522% of the distance from the proximal saddling interface to the first proximal fretting crown segment. In some embodiments, the distance from the proximal saddling interface to a longitudinally forward extent of the fretting saddling member is equal to or less than 522%, 447%, 368%, 284%, 195%, and/or 110% of the distance from the proximal saddling interface to the first proximal fretting crown segment. The longitudinally forward extent may be the farthest longitudinally forward point at the forward member end.

A fretting saddling member may include a proximal saddling interface, a distal saddling interface, and a first distal fretting crown segment longitudinally forward of the distal saddling interface. In some embodiments, the distance from the distal saddling interface to a longitudinally forward extent of the fretting saddling member is greater than 522% of the distance from the distal saddling interface to the first distal fretting crown segment. In some embodiments, the distance from the distal saddling interface to a longitudinally forward extent of the fretting saddling member is equal to or less than 522%, 447%, 368%, 284%, 195%, and/or 110% of the distance from the distal saddling interface to the first distal fretting crown segment.

In some embodiments, a distance from the laterally proximal saddling interface to the second laterally proximal fretting crown segment is inclusively from 180% to 194.39% of a distance from the laterally proximal saddling interface to the first laterally proximal fretting crown segment. In some embodiments, a distance from the laterally proximal saddling interface to the second laterally proximal fretting crown segment is inclusively from 194.39% to 220% of a distance from the laterally proximal saddling interface to the first laterally proximal fretting crown segment. In some embodiments, a distance from the laterally proximal saddling interface to the second laterally proximal fretting crown segment is inclusively from 194.72% to 220% of a distance from the laterally proximal saddling interface to the first laterally proximal fretting crown segment. In some embodiments, a distance from the laterally proximal saddling interface to the second laterally proximal fretting crown segment is inclusively from 195.04% to 220% of a distance from the laterally proximal saddling interface to the first laterally proximal fretting crown segment. In some embodiments, a distance from the laterally proximal saddling interface to the second laterally proximal fretting crown segment is inclusively from 195.37% to 220% of a distance from the laterally proximal saddling interface to the first laterally proximal fretting crown segment. In some embodiments with a diatonic spacing, a distance from the laterally proximal saddling interface to the second laterally proximal fretting crown segment is inclusively from 138% to 152% of a distance from the laterally proximal saddling interface to the first laterally proximal fretting crown segment.

In some embodiments, a distance from the laterally proximal saddling interface to the third laterally proximal fretting crown segment is inclusively from 255% to 283.48% of a distance from the laterally proximal saddling interface to the first laterally proximal fretting crown segment. In some embodiments, a distance from the laterally proximal saddling interface to the third laterally proximal fretting crown segment is inclusively from 283.48% to 325% of a distance from the laterally proximal saddling interface to the first laterally proximal fretting crown segment. In some embodiments, a distance from the laterally proximal saddling interface to the third laterally proximal fretting crown segment is inclusively from 284.12% to 325% of a distance from the laterally proximal saddling interface to the first laterally proximal fretting crown segment.

In some embodiments, a distance from the laterally proximal saddling interface to the first laterally proximal fretting crown segment is inclusively from 100% to 120% of a distance from the first fingerboard fret to the nut. In some embodiments, a distance from the laterally proximal saddling interface to the first laterally proximal fretting crown segment is inclusively from 80% to 100% of a distance from the first fingerboard fret to the nut. In some embodiments, a distance from the laterally proximal saddling interface to the first laterally proximal fretting crown segment is inclusively from 80% to 99.5% of a distance from the first fingerboard fret to the nut. In some embodiments, a distance from the laterally proximal saddling interface to the first laterally proximal fretting crown segment is inclusively from 80% to 99% of a distance from the first fingerboard fret to the nut.

A fretting saddling member 60 may include a proximal saddling interface 65a, which may be a first saddling interface, and a distal saddling interface 65b, which may be a second saddling interface. In some embodiments, the first saddling interface is inclusively from .0mm to 50mm farther longitudinally rearward than the second saddling interface. In some embodiments, the first saddling interface is inclusively from .127mm to 50mm farther longitudinally rearward than the second saddling interface. In some embodiments, the first saddling interface is inclusively from .25mm to 50mm farther longitudinally rearward than the second saddling interface. In some embodiments, the longitudinal position of the first saddling interface is inclusively from .375mm to 50mm farther longitudinally rearward than the second saddling interface. In some embodiments, the first saddling interface is inclusively from .5mm to 50mm farther longitudinally rearward than the second saddling interface.

Lateral string spacing may typically be the same for any two consecutive strings; however, if the strings are spaced unevenly, an average may be used. In the case of coursed strings, such as on a twelve string guitar, a course of strings may be considered to be functionally a single string, with respect to this document.

The word “consecutive” may be understood to indicate that two elements are adjacent. However, the word “consecutive” is not intended to indicate which element is sequentially previous or sequentially subsequent to the other.

The phrases “proximal” and “distal” may be understood to indicate spatial relationships. However, these phrases are not intended to indicate whether or not features are consecutive.

The numerals of Greek origin: proto, deutero, trito, tetarto, pempto, and hecto may be sometimes used to indicate repeated elements. They may be understood to function as first, second, third, fourth, fifth, and sixth, as ordinarily used in technical writing. Lateral position is not implied by the numerals of Greek origin, and may be indicated in another manner. The numerals of Greek origin may avoid confusion that might result from the use of “first string,” “second string,” “third string,” and so forth, as these phrases may have traditional meanings which imply lateral positions. Where “first string,” “second string,” “third string” etc. are used, they may be understood to have their traditional meanings. In some embodiments, a plurality of consecutive laterally spaced strings includes a proto string, a deutero string, a trito string, a tetarto string, etc., and the proto string is a laterally outermost proximal string. Described embodiments may be interpreted to include these configurations, while not excluding other possible string configurations. Because the figures show certain instruments, for the convenience of the reader, proto string, deutero string, trito string, tetarto string, pempto string, and hecto string may be associated with specific reference numerals. However, the reader should keep in mind that any embodiment may have a varied number of strings, and that the numerals of Greek origin may be used to describe strings in lateral positions other than those illustrated. For example, a proto string may consistently be illustrated in the figures as a laterally outermost proximal string; however, it may be understood that, in a claim in which relative lateral positions of strings is not indicated, a proto string may have this lateral position or a different lateral position in relation to another string. Relative to one another, two consecutive strings may be a laterally distal string and a laterally proximal string.

In a right handed playing posture, a proximal body side 13 of an instrument 5 may be near the chest, and a distal body side 14 of the instrument may contact the leg. The teachings in this document are applicable to right and left handed instruments. If a right handed six string instrument were tuned to standard guitar tuning, a laterally outermost proximal string might be a “low E” string, and a laterally outermost distal string might be a “high E” string. If a left handed six string instrument were tuned to standard guitar tuning, a laterally outermost proximal string might be a “low E” string, and a laterally outermost distal string might be a “high E” string. An instrument may be illustrated or described with right handed form and function; however, left handed form and function may be substituted for right handed form and function.

A string, a fingerboard fret, a note, a fretting crown segment, another feature, a position of a feature, or a distance from one feature to another may be described as “intonated;” this may be descriptive of a set up with in tune function. “Intonation” and “intonate” may be understood to be a property or process related to in tune function. “To intonate” may be understood to mean locating features such that fingerboard frets and/or a fretting crown segment are in tune relative to a string.

To avoid confusion, what may be conventionally called a “fret” on a fingerboard may be referred to as a “fingerboard fret;” a part of an assembly for use in the opposite direction may be called a “fretting crown.” A note produced at a fingerboard fret may be called a “fretted fingerboard note.” A note produced at a fretting crown may be called a “wrist fretable note” or a “wrist fretted note.”

“Rearward” and “longitudinally rearward” may be used interchangeably. “Forward” and “longitudinally forward” may be used interchangeably. “Distal” and “laterally distal” may be used interchangeably. “Proximal” and “laterally proximal” may be used interchangeably. The words “tilted” and “angled” may be understood contextually and may be used interchangeably.

For brevity, “instrument” and “strings” may be used instead of “stringed musical instrument” and a “plurality of strings.” The words “and” and “or” may be used with a full range of traditional functions including “and/or.” The term “and/or” may be used for clarity or to avoid redundancy. The words to “be,” to “comprise,” to “include,” and to “have” may be understood in a non-limiting manner.

If an illustration of a right handed instrument in a six string guitar form (tuned to standard tuning) were viewed with a forward end of its neck at the top of a page, its rearward bout at the bottom of the page, and with its strings facing the reader, its “low E” string may be the laterally leftmost of its strings, and its “high E” string may be the laterally rightmost of its strings. As understood from this orientation, strings may be indicated as “leftmost,” “second from the left,” etc.

A saddle means may be called a “saddle feature.” A fastener in the form of a screw may be called a “clamping screw.” A fastening opening in the form of a threaded hole may be called a “clamping hole.” A longitudinal slot cooperating with a fastener to lock a position of a fretting saddling member or a fretting appendage may be called a “clamping slot.” An action similar to wrist fretting performed with a finger of the picking hand may be called “pinkie fretting;” both actions and other similar picking hand actions may be called “counter fretting.” An assembly may be called a “wrist fretting assembly” or a “counter fretting assembly.” A central longitudinal recess may be called an “elongated longitudinal depression.” A back of a body may be called a “backside.” A pivot may be called a “pivot feature.” A fretting appendage may be called a “fret appendage;” in some contexts it may be called a “block,” or a “fretting block.” A fretting appendage including two fretting crown segments may be called a “tandem fret appendage.” A fretting saddling member may be called a “block,” an “extended saddle member,” or a “tandem extended saddle member.” Nominal sounding lengths and nominal oddment lengths may be called “standard calculated distances.” “Height adjustment” may be understood to mean vertical adjustment. “Height position” and “height” may be understood to mean vertical position. “Height distance” may be understood to mean vertical distance. A height adjustment hole may be called a “height positioning hole.” A nut may be called a “nut feature.” A soundboard may be called an “acoustic top.” “Longitudinally rearward critical contact point,” “rearward critical contact point,” and "critical saddle contact point" may be used interchangeably. A support may be called a “base.” A guide surface may, in some contexts, be a surface of a “guidance feature.” A body cavity may be called a body “recess.” A pickup including a distal coil and a proximal coil may be called a “divided pickup.” “Laterally adjacent” features may be understood to be laterally consecutive. A sounding length may be called a “vibrating length” or a “vibration length.” A guide surface of a longitudinal slot such as a channel may be called an “interior wall.”

Contextually, a fretting crown segment may be called a “one string fretting segment” or a “wrist-fretting crown segment;” a fretting crown may be called a “wrist fretting crown,” a “one string fret,” a “two string fret,” etc.

A feature, function, or position may be described as “about,” “substantially,” or “approximately.” These may be understood to imply functionality exactly in a described position and/or orientation and within a range of variance from the described position and/or orientation. The description of some features, functions, positions, or orientations as “about,” “substantially,” or “approximately,” is not intended to imply that other features, functions, positions, or orientations not described in this manner may be differently precise. Nor is the use of these descriptions intended to imply a lack of precision; they are intended to teach the reader that a range of variations may work.

Broadly, a feature, function, position, or orientation may be understood to be “about,” “substantially,” or “approximately” as described if an associated string is playable as an open string, and/or a fingerboard fret is usable to play a fingerboard fretted note, and/or a fretting crown is usable to play a wrist fretted note. The terms “about,” “substantially,” or “approximately” refer to less than or equal to +/−1%, +/−2%, +/−3%, +/−4%, +/−5%, +/−6%, +/−7%, +/−8%, +/−9%, +/−10%, +/−11%, +/−12%, +/−14%, +/−15%, +/−20%, +/−25%, or +/−30% variation. As a non-limiting example, substantially parallel represents a range of −1 to 1 degree difference, −10 to 10 degree difference, or −30 degrees to 30 degrees of difference from being parallel, depending on the embodiments.

A first feature, which is aligned with a second feature, may be substantially aligned with the second feature. A first feature, which aligns a second feature with a third feature, may substantially align the second feature with the third feature.

A first feature, which is centered under a second feature, may be substantially centered under the second feature. A first feature which, is centered between a second feature and a third feature, may be substantially centered between the second feature and the third feature. A first feature, which centers a second feature under a third feature, may substantially center the second feature under the third feature. A first feature, which centers a second feature between a third feature and a fourth feature, may substantially center the second feature between the third feature and the fourth feature.

A feature, function, or position described as longitudinal may be understood to be substantially longitudinal. A feature which is longitudinally between two points may be exactly between the two points, or may be vertically higher or lower than and/or laterally proximal or distal to one or both of the points.

A feature, function, or position described as lateral may be understood to be substantially lateral. A feature which is laterally between two points may be exactly between the two points, or may be vertically higher or lower than and/or longitudinally forward or rearward of one or both of the points.

A feature, function, or position described as vertical may be understood to be substantially vertical. A feature which is vertical with respect to two points may be vertical with respect to both points, or may include some overlap in the vertical dimension with one or both points.

Some non-limiting examples are presented here for the convenience of the reader. In an example, a substantially longitudinal slot may run at a slight angle to a centerline of a neck or to a string. In some embodiments, a lateral end of a fretting crown is laterally between two strings; the lateral end of the fretting crown may be vertically lower than both strings and nearer to one string than the other string. In a further example, a vertical height screw or fastener may be substantially vertical and may be tilted or angled as respective features, such as a fretting saddling member, are tilted or angled. In another example, a pickup opening which is longitudinally between a fretting crown and fingerboard may be vertically lower than the fretting crown and the fingerboard. In a further example, a fretting crown which is centered under a string may be substantially centered under the string; it may stick out farther from under one side of the string than the other, but still function for wrist fretting.

Not every feature may be visible in every figure. Some descriptions may describe features which may be distributed among several figures illustrating one or more embodiments. When a feature is described with respect to an embodiment, that description may be used to understand a similar feature in another embodiment. Some embodiments may include repeated elements. A description of a first element may be used to understand the similar nature of a second element. Some descriptions include figure numbers, which are specified for teaching purposes, and other embodiments share features described with respect to the specified figures; repeated descriptions of those features may be shortened or omitted for brevity. Features described as similar may be understood to be similar to or the same as features to which they are compared. Sections organized by topic may be understood to include information on other topics. Some ranges, when comparing locations of features, may overlap and/or have different end points; these ranges are given as examples, to help the reader understand the embodiments; other ranges are both possible and envisioned.

Illustrations and descriptions are detailed and specific for the purpose of teaching; however, they may be understood to illustrate and inform in a non-limiting manner. Dimensions and measurements have been presented by way of example, and are not intended to limit the scope of the inventions disclosed herein. Alternatives and variations have been presented; even so, an illustration or description of every possible combination, alternative, or variation is beyond the scope of this document. Outlining some changeable characteristics is not intended to convey that all possible changes have been covered. Without departing from the teachings of this document, features, structures, devices, parts, components, and elements may be combined, omitted, substituted for one another, rearranged, added to, configured differently, altered, varied, or used independently. Without departing from the teachings of this document, steps, methods, processes, and systems may be combined, omitted, added to, substituted for one another, altered, varied, or performed in other orders. A portion or a part of a step or a feature described or illustrated in an embodiment or in an example may be combined with or used instead of a portion or a part of a step or a feature in a different embodiment or in a different example. Changes may be made to the embodiments while remaining within the scope and spirit of the teachings. The embodiments and examples provided herein are not intended to be discrete and separate from each other. All possible combinations and subcombinations of steps and features are intended to fall within the scope of this disclosure.

I claim:

1. An assembly for a stringed musical instrument, the assembly comprising:
a block comprising a first saddling interface and a fretting crown spaced longitudinally forward of the first saddling interface; and
two height screws,
wherein the block is adjustably positionable on a body of the stringed musical instrument such that a proto string of the stringed musical instrument extends i) from a proto string longitudinally rearward critical contact point on the first saddling interface, ii) at a wrist fretable vertical distance above the fretting crown, iii) above a neck of the stringed musical instrument connected to the body of the stringed musical instrument, iv) to a proto string longitudinally forward critical contact point on a nut of the stringed musical instrument disposed on the neck of the stringed musical instrument,
wherein the block further comprises a longitudinally forward end and a longitudinally rearward end opposite the longitudinally forward end,
wherein a first height screw of the two height screws is configured to adjust a vertical position of the longitudinally forward end of the block relative to the body of the stringed musical instrument, and
wherein a second height screw of the two height screws is configured to adjust a vertical position of the longitudinally rearward end of the block relative to the body of the stringed musical instrument.

2. The assembly of claim 1, wherein the block further comprises a second saddling interface,
wherein the second saddling interface is laterally distal to the first saddling interface,
wherein the block is further adjustably positionable on the body of the stringed musical instrument such that a deutero string of the stringed musical instrument extends i) from a deutero string longitudinally rearward critical contact point on the second saddling interface, ii) above the neck of the stringed musical instrument, iii) to a deutero string longitudinally forward critical contact point on the nut of the stringed musical instrument, and
wherein the deutero string of the stringed musical instrument is laterally distal to and laterally spaced from the proto string of the stringed musical instrument.

3. An assembly for a stringed musical instrument, the assembly comprising:
a block comprising a first saddling interface and a fretting crown spaced longitudinally forward of the first saddling interface;
a laterally proximal height screw; and
a laterally distal height screw,
wherein the fretting crown comprises a proximal lateral end and a distal lateral end opposite the proximal lateral end,
wherein the block is adjustably positionable on a body of the stringed musical instrument such that a proto string of the stringed musical instrument extends i) from a proto string longitudinally rearward critical contact point on the first saddling interface, ii) at a wrist fretable vertical distance above the fretting crown, iii) above a neck of the stringed musical instrument connected to the body of the stringed musical instrument, iv) to a proto string longitudinally forward critical contact point on a nut of the stringed musical instrument disposed on the neck of the stringed musical instrument, and
wherein the laterally proximal height screw and the laterally distal height screw are configured to adjust a vertical position of the proximal lateral end of the fretting crown relative to a vertical position of the distal lateral end of the fretting crown.

4. The assembly of claim 3, further comprising a second saddling interface,
wherein the second saddling interface is laterally distal to the first saddling interface,
wherein the block is further adjustably positionable on the body of the stringed musical instrument such that a deutero string of the stringed musical instrument extends i) from a deutero string longitudinally rearward critical contact point on the second saddling interface, ii) above the neck of the stringed musical instrument, iii) to a deutero string longitudinally forward critical contact point on the nut of the stringed musical instrument,
wherein the deutero string of the stringed musical instrument is laterally distal to and laterally spaced from the proto string of the stringed musical instrument, and
wherein the laterally proximal height screw and the laterally distal height screw are further configured to adjust a vertical position of the first saddling interface relative to a vertical position of the second saddling interface.

5. An assembly for a stringed musical instrument, the assembly comprising:
a block comprising a saddling interface and a first fretting crown spaced longitudinally forward of the saddling interface,
wherein the block is adjustably positionable on a body of the stringed musical instrument such that a proto string of the stringed musical instrument extends i) from a proto string longitudinally rearward critical contact point on the saddling interface, ii) at a wrist fretable vertical distance above the first fretting crown, iii) above a neck of the stringed musical instrument connected to the body of the stringed musical instrument, iv) to a proto string longitudinally forward critical contact point on a nut of the stringed musical instrument disposed on the neck of the stringed musical instrument,
wherein the block further comprises a longitudinally forward end and a longitudinally rearward end opposite the longitudinally forward end, and
wherein a vertical position of the longitudinally forward end of the block is adjustable relative to a vertical position of the longitudinally rearward end of the block.

6. The assembly of claim 5, wherein the block further comprises a second fretting crown spaced longitudinally forward of the first fretting crown, and
wherein a distance from the saddling interface to the second fretting crown is inclusively from 180% to 194.39% of a distance from the saddling interface to the first fretting crown.

7. The assembly of claim 5, wherein the block further comprises a second fretting crown spaced longitudinally forward of the first fretting crown, and
wherein a distance from the saddling interface to the second fretting crown is inclusively from 194.39% to 220% of a distance from the saddling interface to the first fretting crown.

8. The assembly of claim 5, wherein the block further comprises a second fretting crown spaced longitudinally forward of the first fretting crown, and
wherein a distance from the saddling interface to the second fretting crown is inclusively from 194.72% to 220% of a distance from the saddling interface to the first fretting crown.

9. The assembly of claim 5, wherein the block further comprises a second fretting crown spaced longitudinally forward of the first fretting crown, and
wherein a distance from the saddling interface to the second fretting crown is inclusively from 195.04% to 220% of a distance from the saddling interface to the first fretting crown.

10. The assembly of claim 5, wherein the block further comprises a second fretting crown spaced longitudinally forward of the first fretting crown, and
wherein a distance from the saddling interface to the second fretting crown is inclusively from 195.37% to 220% of a distance from the saddling interface to the first fretting crown.

11. The assembly of claim 5, wherein the block further comprises a second fretting crown spaced longitudinally forward of the first fretting crown, and
wherein a distance from the saddling interface to the second fretting crown is inclusively from 138% to 152% of a distance from the saddling interface to the first fretting crown.

12. The assembly of claim 5, wherein the block further comprises a second fretting crown and a third fretting crown,
wherein the second fretting crown is spaced longitudinally forward of the first fretting crown,
wherein the third fretting crown is spaced longitudinally forward of the second fretting crown, and
wherein a distance from the saddling interface to the third fretting crown is inclusively from 283.48% to 325% of a distance from the saddling interface to the first fretting crown.

13. The assembly of claim 5, wherein the block further comprises a second fretting crown and a third fretting crown,
wherein the second fretting crown is spaced longitudinally forward of the first fretting crown,
wherein the third fretting crown is spaced longitudinally forward of the second fretting crown, and
wherein a distance from the saddling interface to the third fretting crown is inclusively from 284.12% to 325% of a distance from the saddling interface to the first fretting crown.

14. The assembly of claim 5, further comprising a shim configured to adjust the vertical position of the longitudinally forward end of the block, the vertical position of the longitudinally rearward end of the block, or both, relative to the body of the stringed musical instrument.

15. The assembly of claim 5, wherein the saddling interface is a first saddling interface,
wherein the block further comprises a second saddling interface laterally distal to the first saddling interface,
wherein the block is further adjustably positionable on the body of the stringed musical instrument such that a deutero string of the stringed musical instrument extends i) from a deutero string longitudinally rearward critical contact point on the second saddling interface, ii) above the neck of the stringed musical instrument, iii) to a deutero string longitudinally forward critical contact point on the nut of the stringed musical instrument, and
wherein the deutero string of the stringed musical instrument is laterally distal to and laterally spaced from the proto string of the stringed musical instrument.

16. The assembly of claim 15, wherein the first saddling interface is inclusively from .0 millimeters (mm) to 50 mm farther longitudinally rearward than the second saddling interface.

17. The assembly of claim 15, wherein the first saddling interface is inclusively from .127 mm to 50 mm farther longitudinally rearward than the second saddling interface.

18. The assembly of claim 15, wherein the first saddling interface is inclusively from .25 mm to 50 mm farther longitudinally rearward than the second saddling interface.

19. The assembly of claim 15, wherein the first saddling interface is inclusively from .375 mm to 50 mm farther longitudinally rearward than the second saddling interface.

20. The assembly of claim 15, wherein the first saddling interface is inclusively from .5 mm to 50 mm farther longitudinally rearward than the second saddling interface.

21. The assembly of claim 15, wherein the assembly further comprises three height screws spaced apart in a triangular arrangement, and
wherein the three height screws are configured to adjust i) the vertical position of the longitudinally forward end of the block relative to the body of the stringed musical instrument, ii) the vertical position of the longitudinally rearward end of the block relative to the body of the stringed musical instrument, and iii) a vertical position of the first saddling interface relative to a vertical position of the second saddling interface.

22. The assembly of claim 15, wherein the block further comprises a first string guide indentation configured to position the proto string of the stringed musical instrument on the first saddling interface.

23. The assembly of claim 15, wherein a vertical position of the first saddling interface and a vertical position of the second saddling interface are adjustable relative to one another.

24. The assembly of claim 5, wherein the first fretting crown comprises a first lateral end and a second lateral end opposite the first lateral end,
wherein the block is configured to couple to the body of the stringed musical instrument such that the first lateral end of the first fretting crown is laterally between the proto string of the stringed musical instrument and a deutero string of the stringed musical instrument,
wherein the deutero string of the stringed musical instrument extends i) from the body of the stringed musical instrument, ii) above the neck of the stringed musical instrument, iii) to the nut of the stringed musical instrument, and
wherein the deutero string of the stringed musical instrument is laterally spaced from the proto string of the stringed musical instrument.

25. The assembly of claim 5, further comprising a height screw configured to adjust a vertical position of the block relative to the body of the stringed musical instrument, and
wherein the vertical position of the longitudinally forward end of the block is adjustable relative to the vertical position of the longitudinally rearward end of the block by pivoting the block on the height screw.

26. The assembly of claim 5, wherein the block further comprises an upward facing face and a forward facing surface, and
wherein the first fretting crown comprises a rounded edge between the upward facing face and the forward facing surface.

27. The assembly of claim 5, wherein the first fretting crown is oriented at a fingerboard matching angle that matches a fingerboard angle of a fingerboard.

28. The assembly of claim 15, wherein the first fretting crown comprises a first lateral end and a second lateral end opposite the first lateral end,
wherein the block is configured to couple to the body of the stringed musical instrument such that the first lateral end of the first fretting crown is laterally between the proto string of the stringed musical instrument and a trito string of the stringed musical instrument,
wherein the trito string of the stringed musical instrument extends i) from the body of the stringed musical instrument, ii) above the neck of the stringed musical instrument, iii) to the nut of the stringed musical instrument, and
wherein the trito string of the stringed musical instrument is laterally spaced i) from the proto string of the stringed musical instrument, and ii) from the deutero string of the stringed musical instrument.

29. The assembly of claim 5, further comprising a positioning screw configured to adjust a longitudinal position of the block relative to the body of the stringed musical instrument.

30. The assembly of claim 5, wherein a longitudinal position of the block is adjustable relative to the body of the stringed musical instrument.
